(19) United States
(12) Patent Application Publication
(10) Pub. No.: US 2025/0092272 A1
(43) Pub. Date: Mar. 20, 2025

(54) UV CROSSLINKABLE INKS AND THE USE THEREOF

(71) Applicant: THE BOARD OF TRUSTEES OF THE UNIVERSITY OF ILLINOIS, URBANA, IL (US)

(72) Inventors: Sanghyun Jeon, Urbana, IL (US); Yash Laxman Kamble, Urbana, IL (US); Haisu Kang, Urbana, IL (US); Jiachun Shi, Urbana, IL (US); Simon Andrew Rogers, Urbana, IL (US); Damien Guironnet, Urbana, IL (US); Charles Sing, Urbana, IL (US); Ying Diao, Urbana, IL (US); Bijal B. Patel, Urbana, IL (US)

(21) Appl. No.: 18/810,678

(22) Filed: Aug. 21, 2024

Related U.S. Application Data
(60) Provisional application No. 63/520,875, filed on Aug. 21, 2023.

(51) Int. Cl. C09D 11/101; C09D 11/03; C09D 11/107

(52) U.S. Cl. CPC C09D 11/101; C09D 11/03; C09D 11/107

(57) ABSTRACT

The present invention relates to crosslinkable ink compositions and the preparation and use thereof.

### CROSS-REFERENCE TO RELATED APPLICATIONS

This application claims the benefit of U.S. Provisional Appl. No. 63/520,875 filed Aug. 21, 2023. The content of the foregoing application is relied upon and is incorporated by reference herein in its entirety.

### STATEMENT OF FEDERALLY SPONSORED RESEARCH AND DEVELOPMENT

This invention was made with government support under NSF Grant No. DMREF Award No. DMR-2119172 awarded by the National Science Foundation. The government has certain rights in the invention.

### FIELD OF THE INVENTION

The field of the invention relates generally to inks and the preparation and use thereof.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

The biological world provides examples of how simultaneous control over molecular composition and long-range macroscopic order gives rise to material properties that seem unique to living organisms. For example, the phenomenon of structural color is found in a variety of animals, including birds, butterflies, fish, insects, and chameleons. This coloration property arises from the periodic ordering of domains with different refractive index on the nanometer length scale. Biological systems have evolved to exhibit dynamic hierarchical structures that confer complex functionality, such as the adaptable, structural color in chameleons that allow them to match their environment. Attaining such dynamic complex structures at the nanoscale have been challenging to achieve in synthetic macromolecular systems.

Synthetic colors used today constitute environmental pollutants that severely impact human and aquatic life. Industrial dyes are chemical-based colorants which either degrade or bleach, thus making them unsustainable. Furthermore, they are toxic and are known water pollutants. Filaments for printing are only one color per filament or wherein a single base filament is dyed before extrusion. Photonic inks can generate only one color per ink. For products with multiple colors, multiple inks and printing nozzles are required.

Printing/coating uses multiple methods. The direct color (multicolor) and color mixing method involves loading colored raw material into the device (colored filaments), wherein simultaneous multi-color printing/coating requires dual or multiple extruders. The color matching method involves mixing color pigments to make an entire cartridge of a custom color. The full color method involves color being added to the base material during the printing/coating process. Another method involves painting or adding graphics to pre-printed parts. However, additive manufacturing capable of controlling and dynamically modulating structures down to the nanoscopic scale remains challenging.

As an alternative to chemical pigments, structure colors/photonic colors are microscopically structured surfaces which interfere with visible light to produce vibrant colors which may also be iridescent. Structure colors typically are also referred to as photonic colors. Structural colors, drawing inspiration from nature, offer sustainable, eco-friendly, and dynamic coloration properties that may be challenging to achieve with traditional synthetic dyes. Structural color It is a compelling alternative to synthetic color because it can be eco-friendly in contrast to the environmentally polluting synthetic dyes. Further, structural color can exhibit high brilliance and dynamic properties that are challenging to attain through synthetic routes. These advantages have motivated extensive efforts to achieve structural color in synthetic materials.

While top-down lithographic approaches have been successful at producing precise periodic structures, they require sophisticated and costly processing steps to achieve nanoscopic feature size, which limits scalability and broad applicability.

Bottom-up self-assembly methods of creating nanostructured materials such as blue-phase or chiral liquid crystals, colloidal nanoparticles, and block copolymers have been explored to address these limitations. Among these materials, block copolymers show great promise in mimicking biological structural color as it can access a wide range of nanoscale morphologies encompassing lamellar, cylindrical, bi-continuous, and spherical morphologies. However, achieving visible-range coloration is non-trivial due to chain entanglement and sluggish assembly kinetics, limiting their ability to access domain sizes large enough to reflect visible light. To overcome this challenge, domain swelling strategies have been developed, but pose challenges in terms of environmental stability.

Bottlebrush block polymers have garnered significant attention for structural color production, which may be due to its rapid assembly characteristics into nanoscopic lamellar structure and vibrant photonic characteristics. Bottlebrush block copolymers (BBCP) comprising densely grafted side chains attached to a common backbone represents a promising choice alternative to linear block copolymers for achieving visible-range structural coloration. The steric repulsion between dense side chains leads to extended cylindrical conformations and suppressed chain entanglement, which facilitate rapid self-assembly into ordered nanostructures with large domain sizes. The facile production of photonic crystals using BBCP opens up a wide range of potential applications, such as in the production of photonic resins, photonic pigments, stress-responsive photonic structures, and 3D printed photonic structures.

Developing printable/coatable dynamic structure color will not only introduce new functionality that the current synthetic color is not capable of, but also help address urgent environmental issues.

### BRIEF DESCRIPTION OF THE FIGURES

FIG. 1A-1E. Synthesis of the Polystyrene-b-Polylactide (PS-b-PLA) c-BBCP. (FIG. 1A) Reaction scheme for the functionalization of homo-PLA bottlebrush polymers with UV active end group using alcohol-isocyanate coupling reaction, (FIG. 1B) UV-GPC traces of the functionalized PLA bottlebrush polymer showing no change in bottlebrush polymer architecture (Internal Standard: 6 kg/mol PS; GPC data is evaluated using conventional calibration with respect to PS standards), (FIG. 1C) Reaction scheme for the functionalization of PS-b-PLA c-BBCP with crosslinkable allyl functionalities, (FIG. 1D) RI-GPC traces of the PS-b-PLA bottlebrush block copolymers before and after functionalization (GPC data is evaluated using conventional calibration with respect to PS standards), (FIG. 1E) Image of dried functionalized bottlebrush block copolymers as-synthesized at gram scales (˜20 g).

FIG. 2A-2B. UV-assisted DIW 3D printer. (FIG. 2A) Illustration of the printer design, featuring a custom-built pneumatic ink dispenser and a UV curing system for post-extrusion photo-crosslinking. (FIG. 2B) Developed PolyChemPrint3_UV (PCP3_UV) software framework that centrally controls and synchronizes the commercial 3D printer motion controller with custom-built UV curing system and ink dispenser.

FIG. 3A-3E. On-the-fly tuning of structural color through UV crosslinking. (FIG. 3A) Schematic of UV-assisted DIW 3D printing process with the c-BBCP ink and the crosslinking reaction scheme. (FIG. 3B) The photograph depicts printed lines under varying levels of UV light irradiance during printing: 0, 22, 62, 101, 188, and 411 μW/cm²; the image was captured using an upright optical microscope with diffusive ring lights. (FIG. 3C) The specular reflection spectra of each printed line under the varying UV irradiance (0, 22, 62, 101, 188, and 411 μW/cm²). (FIG. 3D) Cross-sectional SEM images of printed lines under UV light irradiance of 0, 22, 101, and 411 μW/cm². The inset images are magnified SEM images for each sample, color coded based on the actual structural color of the structure. (FIG. 3E) The estimated domain size based on reflection (d_{R}) and measured by SEM (d_{SEM}) as a function of UV light irradiance.

FIG. 4A-4D. (FIG. 4A) Schematic of evaporation driven assembly pathway. When the polymer concentration increases, the BBCPs adopt more stretched conformation due to increased block-block contact by concentration increase. (FIG. 4B) Structure factor S(q) calculated from molecular dynamics simulation at different concentrations. (FIG. 4C) The low-q peak positions from S(q) in (FIG. 4B) and corresponding correlation lengths indicating d-spacing of lamellar structure with concentration increase. (FIG. 4D) Estimated UV-vis peak wavelength as a function of solution concentration.

FIG. 5A-5E. (FIG. 5A) Schematic depiction of the kinetic trapping mechanism during evaporative assembly: photo-crosslinking, upon completion, arrests lamella domain expansion before the structure reaches equilibrium. (FIG. 5B) The hue and reflection intensity plotted against elapsed time for printed c-BBCP line. Images are snapshots from the time-lapse video numbered corresponding to the time point indicated by black arrows in the plot. The assembly timescale was estimated based on the point when both hue and reflected intensity values plateau. (FIG. 5C) Time-dependent storage modulus (filled symbol) G′ normalized by equilibrium storage modulus G′_{eq} observed at longer time and loss modulus (opened symbol) G″ normalized by equilibrium loss modulus G″_{eq} observed at longer time, before, during, and after UV exposure under UV light irradiance of 187 μW/cm². Gelation time (t_{gel}) was determined from the time when G′ and G″ crossover, which was t_{gel}=13.4 s determined with respect to the time when turning on the UV lamp. The mutation number during the UV curing was determined to be Mu=0.073. (FIG. 5D) Relation between gelation time t_{gel} and light irradiance (60, 104, 187, and 409 W/cm²) at an angular frequency ω>=5.62 rad/s during UV curing. (FIG. 5D) The calculated effective crosslinking density of lines printed under various levels of UV light irradiance (0, 22, 62, 101, 188, and 411 μW/cm²).

FIG. 6A-6C. UV-assisted DIW 3D printing of structural color gradients. (FIG. 6A) The digital input of UV light irradiance during printing, and the resulting lines with structural color gradients. (FIG. 6B-6C) Chameleon and Starry Night printed by on-the-fly UV-assisted DIW 3D printing.

FIG. 7. UV-assisted direct-ink-write 3D printing approach capable of on-the-fly modulation of structural color demonstrated using self-assembling crosslinkable bottlebrush block copolymers. Provides a graphical abstract of UV-assisted DIW 3D printing.

FIG. 8. ¹H NMR spectra taken in CDCl₃ for the PLA macromonomer.

FIG. 9. GPC Trace for PLA Macromonomers (M_{n, GPC}=4,800 g/mol; Mn, _{theory}=3,700 g/mol; Ð=1.07).

FIG. 10. RI-GPC trace for the synthesis of homopolymer PLA BB

FIG. 11. 1H NMR spectra taken in CDCl₃ of the functionalized homopolymer PLA BB polymer.

FIG. 12A-12B. (FIG. 12A) RI-GPC trace of the naphthyl functionalized homopolymer PLA BB, (FIG. 12B) UV-GPC trace of the naphthyl functionalized homopolymer PLA BB.

FIG. 13. RI-GPC trace for the synthesis of PS-b-PLA diblock bottlebrush polymers.

FIG. 14. 1H NMR spectra taken in CDCl₃ of the allyl functionalized PS-b-PLA diblock bottlebrush polymers.

FIG. 15. 1H NMR spectra taken in CDCl₃ highlighting the emergence of corresponding peaks post allyl functionalization of the PS-b-PLA diblock bottlebrush polymers.

FIG. 16. Photos of UV-assisted DIW 3D printer (PCP3_UV) hardware. The new printhead with suspended UV light guide spot UV curing system (Omnicure S2000, Excelitas) was fabricated. This system allows UV light to be directly illuminated at the tip of the pneumatic dispenser (Light off: left, Light on: right, UV irradiance: 411 W/cm²).

FIG. 17A-17B. (FIG. 17A) The established c-BBCP Ink printability window depending on concentration of ink and pneumatic pressure applied to the material (left). The example photos (top-view) of defined regions of “Spread out”, “Printable”, and “Clogged” (right). (FIG. 17B) c-BBCP ink formulation set based on the printability window test. (PETMP: Pentaerythritol tetrakis(3-mercaptopropionate), DMPA: 2,2-Dimethoxy-2-phenylacetophenone).

FIG. 18A-18B. Demonstration of structural color progression from blue to red of c-BBCP ink (FIG. 18A) The photos of the structural color progression of c-BBCP ink during the printing. The images were captured by the mounted camera from various angles. (FIG. 18B) The photos of the structural color progression of c-BBCP ink, which shows a red-shift after a few seconds.

FIG. 19A-19C. Analysis of crosslinking agent contributions in optical properties. (FIG. 19A) top view of drop cast c-BBCP (left), c-BBCP with crosslinking reagents (middle), and c-BBCP with crosslinking reagents under UV irradiation (right). (FIG. 19B) Reflection spectra of each sample. (FIG. 19C) Absorption spectra of crosslinking reagents (DMPA, and PETMP).

FIG. 20A-20D. Schematic of cross-sectional view of bottlebrush polymers in (FIG. 20A) dilute concentrations at c≤c*and (b) semidilute concentrations at c>c*. The circles represent the thermal blobs considered in the scaling analysis, and black lines are simplified side chain trajectories. For better understanding, thermal blobs in dilute condition are filled with dark blue and those in overlap condition are filled with light blue and light grey, where light grey is thermal blobs from neighboring side chain. Those colors are also used in the cylindric side-view schematic at the right bottom of the cross-sectional views, showing that the polymer cylinder at semidilute concentrations is composed of dilute core and overlapping layer. The cross-sectional radius is defined R₀ in dilute concentrations. For semidilute concentrations, the radius of dilute core is first set to r_{c} and the effective dimension of a single bottlebrush polymer is set to R. Each length scale at the cross-sectional view is described in the left bottom of the figure (FIG. 20B), where the multichain of cylindric bottlebrush polymers are overlapping each other. Here, the dotted line indicates the actual radius of bottlebrush polymer R₀ as in dilute concentration and the purple line indicate the effective radius R. (FIG. 20C) Concentration dependent cutoff distance (r_{c}), cylinder radius (R) and radius fraction (r_{c}/R) as functions of c/c*. (FIG. 20D) Concentration dependent effective persistence length of bottlebrush polymer as functions of c/c* by scaling theory and DPD simulation. DPD simulation data is adapted with permission from ref. 14. Copyright 2022 American Chemical Society.

FIG. 21A-21D. Phase angle against time during UV curing at 3.16 rad/s, 5.62 rad/s, 10 rad/s, and 31.6 rad/s under all UV light irradiances (60 μM/cm², 104 μM/cm², 187 μM/cm², and 409 μM/cm²) for c-BBCP ink in toluene at 5° C.

FIG. 22A-22C. UV rheological characterization of c-BBCP ink in toluene at 5° C. under all other tested UV light irradiances (60 μM/cm², 104 μM/cm² and 409 μM/cm²). Normalized time-dependent storage modulus (filled symbol) G′ and loss modulus (opened symbol) G″ before, during, and after UV exposure under UV light irradiance of 60 μM/cm² with Mu=0.063 and t_{gel}=18 s in FIG. 22A, 104 μM/cm² with Mu=0.045 and t_{gel}=15 s in FIG. 22B, and 409 μM/cm² with Mu=0.073 and t_{gel}=12.3 s in FIG. 22C. The deviations of sample before UV curing are due to the loading artifacts.

FIG. 23A-23B. The demonstration that structural color could not be tuned by the high irradiance range (>411 μW/cm²) because of the fast crosslinking rate. (FIG. 23A) The photos of printed lines under the high UV irradiance range (411 μW/cm², 825 μW/cm², and 1254 μW/cm²). (FIG. 23B) The specular reflection spectra of corresponding lines printed under the high UV irradiance range.

FIG. 24. The negative experiment to verify the crosslinking is key for structural color control. Herein, the ink for printing comprises of only concentrated c-BBCP toluene solution (250 mg/mL) without crosslinker, and photoinitiator. Three lines are printed under various UV light irradiance (0, 101, and 411 μW/cm²), and does not show any color differences.

FIG. 25. CIE 1931 color mapping of produced structural color using c-BBCP ink under different UV crosslinking rate.

FIG. 26A-26D. (FIG. 26A) Synthesis of PS-b-PLA BBCPs via sequential ring-opening metathesis polymerization of PS and PLA macromonomers (FIG. 26B) Solubility measurements employing PS (N_{bb}=200, N_{sc}=45) and PLA (N_{bb}=200, N_{sc}=60) homobrush polymers in various solvents (T: toluene, o-X: o-xylene, m-X: m-xylene, M: mesitylene). The solubility of PLA decreased with increasing number of methyl groups in the solvent molecule, whereas that of PS remained constant. (FIG. 26C) Optical microscope camera images depicting distinct photonic colors based on variations in number of backbone (N_{bb}=300, 400, and 500) and solvent. Inset photos showcase the photonic color when employing a broadband absorber on the samples. (FIG. 26D) UV-Vis diffuse reflection spectra exhibiting diverse optical behaviors concerning backbone quantity (black: 300, red: 400, and blue: 500) and solvent variations.

FIG. 27A-27D. Analysis of structural characteristics of drop-casted samples (N_{bb}=400) based on different solvents. (FIG. 27A) Vertical SEM image displaying variations in nanostructures based on solvents (toluene: lamellar; o-xylene: cylindrical; m-xylene: spherical; mesitylene: spherical). PiFM images showcasing: (FIG. 27B) Topology, (FIG. 27C) PiFM signal recorded at an excitation laser wavelength of 1492 cm⁻¹ (representing the absorption band for the aromatic stretching mode of PS), and (FIG. 27D) PiFM signal captured at 1750 cm⁻¹ (corresponding to the absorption band for the carbonyl of the ester group of PLA). The scale remains consistent across all images in the same figure.

FIG. 28A-28E. Solution SAXS data for BBCP (N_{bb}=400) in (FIG. 28A) toluene, (FIG. 28B) o-xylene, (FIG. 28C) m-xylene, and (FIG. 28D) mesitylene at various concentrations (black: 0.1, red: 1, blue: 10, green: 50, purple: 100, ocher: 200, and turquois: 300 mg/mL). Curves are vertically shifted for clarity. S(q) indicates the structure factor peak that arises from the interaction between adjacent BBCP molecules, regardless of their chemical identity. The structure of BBCP in each solvent was determined by analyzing the structure factor in the sample with the highest concentration. (FIG. 28E) Schematic depicting the entire assembly pathway of BBCP in four distinct solvents. Utilized orange lines to denote the PS brush and blue lines for the PLA brush. The domain spacing and d_{NN} were derived from the primary q-value obtained through SAXS analysis.

FIG. 29A-29D. (FIG. 29A) Cryo-TEM images of BBCP in four different solvents (toluene, o-xylene, m-xylene, and mesitylene) at a concentration of 10 mg/mL. (FIG. 29B) SAXS fitting curves of 10 mg/mL solutions with raw data (black dots). For toluene and o-xylene, the flexible cylinder (FC) model was used for fitting (red curve). For m-xylene and mesitylene, a hybrid model comprising the core-shell model (blue curve) and flexible cylinder model (green curve) was employed for fitting. The red curves represent the overall fitting curve. (FIG. 29C) Estimated radius values of BBCP in different solvents (toluene: black, o-xylene: red, m-xylene: blue, and mesitylene: green) using SAXS model fitting at 1 and 10 mg/mL solution concentrations. (FIG. 29D) Schematic depicting the conformation of BBCP in each solvent.

FIG. 30. GPC Trace for PLA and PS Macromonomers.

FIG. 31. RI-GPC traces for BBCP of varying backbone lengths a) PS₁₅₀⁴⁵-b-PLA₁₅₀⁶⁰, b) PS₂₀₀⁴⁵-b-PLA₂₀₀⁶⁰ and c) PS₂₅₀⁴⁵-b-PLA₂₅₀⁶⁰. The GPC contains three main components: the leftover non-norbornene functionalized PS, homopolymer PS BB and the desired diblock PS-b-PLA BBCP.

FIG. 32A-32B. Optical microscope camera images illustrating distinct photonic colors resulting from solvent composition variations: (FIG. 32A) toluene and m-xylene mixture, and (FIG. 32B) toluene and mesitylene mixture. The numerical notation denotes the volume ratio of each solvent (e.g., TmX 73=70 v % toluene with 30 v % m-xylene).

FIG. 33A-33C. (FIG. 33A) UV-Vis absorption spectra of the broadband absorber (PC₇₁BM), and (FIG. 33B) diffuse reflection spectra of the BBCP sample (o-xylene, N_{bb}=400, and 500) incorporating 1 wt % of the broadband absorber (PC₇₁BM). (FIG. 33C) CIE1931 color mapping demonstrating the resultant structural color produced by c-BBCP ink under various conditions of (N_{bb}, solvents): 1 (300, T); 2(400, T); 3(500, T); 4(300, oX); 5(400, oX); 6(500, oX); 7(400, oX+PC₇₁BM); 8(500, oX+PC₇₁BM). The (x, y) coordinates for each sample are as follows: 1(0.13, 0.15), 2(0.35, 0.38), 3(0.33, 0.34), 4(0.18, 0.22), 5(0.26, 0.31), 6(0.30, 0.31), 7(0.28, 0.36), and 8(0.39, 0.37).

FIG. 34A-34C. Analysis of structural characteristics of drop-casted samples based on different solvents and Neb. (FIG. 34A) Vertical SEM image illustrating variations in nanostructures influenced by solvent choice and N_{bb} (300-500). The images demonstrate that increasing N_{bb} affects the size of the domain while preserving the phases. Vertical SEM image illustrating distinct nanostructures resulting from solvent composition variations: (FIG. 34B) toluene and m-xylene mixture, and (FIG. 34C) toluene and mesitylene mixture. The numerical notation denotes the volume ratio of each solvent (e.g., TmX73=70 v % toluene with 30 v % m-xylene). The scale remains consistent across all images.

FIG. 35. The Fourier transform infrared (FTIR) spectra of PLA (N_{bb}=200, N_{sc}=60, black), and PS (N_{bb}=200, N_{sc}=45, red) homobrush block copolymers. It represents both 1750 cm⁻¹ (carbonyl of the ester group in PLA), and 1492 cm⁻¹ (aromatic stretching mode in PS) peaks are mutually exclusive.

FIG. 36A-36D. Film SAXS analysis. In toluene-based films (FIG. 36A), a discernible long-range lamellar stacking is evident with a series of regularly spaced peaks in q-space, showcasing a calculated d-spacing of 201 nm. Contrarily, for selective solvents like xylenes (FIG. 36B, FIG. 36C) and mesitylene (FIG. 36D), two broad peaks emerge, aligned with the close-packing peaks of FCC, supporting observations from imaging analysis. It's essential to note the complexity in distinguishing the precise close-packing system due to the significantly disordered structure. Yet, assuming a close-packing FCC structure and computing distance of nearest neighbor (d_{NN}) based on the primary q-value (451, 476, and 602 Å⁻¹ for o-xylene, m-xylene, and mesitylene, respectively) yields 170, 162, and 122 nm for o-xylene, m-xylene, and mesitylene, respectively, aligning with our imaging analysis observations.

FIG. 37. The Solution SAXS profiles BBCP at 300 mg/mL in (FIG. 37A) o-xylene, (FIG. 37B) m-xylene, and (FIG. 37C) mesitylene, with peak indexing (black: FCC, red: HCP). The table presents both the theoretically calculated q/q* values and the observed q/q* values of the peaks (q*: primary q-value; 391, 356, and 400 Å⁻¹ for o-xylene, m-xylene, and mesitylene, respectively). All selective solvents display disordered close-packing structures. Specifically, o-xylene reveals peaks from a hybrid of FCC and HCP structures, while both m-xylene and mesitylene display peaks from a disordered FCC structure. The coexistence of both FCC and HCP phases is not unexpected, given their similar free energy and the sharing of the HCP (002) plane with the FCC (111) plane. This coexistence is frequently observed, even in block copolymers.

FIG. 38. Analysis of Evaporation-driven domain size change. The y-axis reflects the ratio of domain size to the domain size of the concentrated solution at 300 mg/mL (dₛₒₗ). Domain sizes were computed utilizing the primary q-value from the SAXS profile (FIG. 36, 37).

FIG. 39A-39B. (FIG. 39A) TEM images of BBCP in four distinct solvents at a larger scale. There are no aggregation features visible in toluene and o-xylene. However, in m-xylene, aggregated particles are observed. Additionally, BBCP in mesitylene clearly showcases micelle formation. (FIG. 39B) TEM images focusing on BBCP single chains in each solvent. The scale remains consistent across all images.

FIG. 40A-40 H. SAXS fitting curves and data of 1 (FIGS. 40A, 40B, 40C, and 40D) and 10 mg/mL (FIGS. 40E, 40F, 40G, and 40H) solutions are depicted with raw data (black dots). For (FIG. 40A, 40E) toluene and (FIG. 40B, 40F) o-xylene, the flexible cylinder model was used for fitting (red curve). In the case of (FIG. 40C, 40G) m-xylene and (FIG. 40D, 40H) mesitylene, a hybrid model incorporating the core-shell model (blue curve) alongside the flexible cylinder model (green curve) was utilized for fitting. The red curves indicate the overall fitting curve. The tabulated values below represent the fitting results along with their respective errors. All the fitting curves closely match the data curves, and the estimated core-shell values align well with our observations in TEM.

FIG. 41A-41I. SAXS fitting curves (red curve) and data for both 1 (FIGS. 41A, 41B, 41C, and 41D) and 10 mg/mL (41E, 41F, 41G, and 41H) solutions are displayed with raw data indicated by black dots: (41A, 41E) toluene, (41B, 41F) o-xylene, (41C, 41G) m-xylene, and (41D, 41H) mesitylene. The curves were fitted within the range of the Guinier knee region (0.01-0.1 Å-1 range) using the Guinier-Porod model for each curve. The tabulated values below represent the fitting results along with their respective errors. (41I) Estimated radius of gyration values of BBCP in different solvents (toluene: black, o-xylene: red, m-xylene: blue, and mesitylene: green) using SAXS model fitting at 1 and 10 mg/mL solution concentrations.

FIG. 42. The measured z-average size of PLA (N_{bb}=200, N_{sc}=60, shown in black) and PS (N_{bb}=200, N_{sc}=45, shown in red) homobrush block copolymer with different solvents in DLS experiments. To isolate single bottlebrush block copolymer chains, a mild centrifugation step was performed before measurement, and the supernatant was utilized for the analysis.

### DESCRIPTION

All publications mentioned herein are incorporated by reference to the extent they support the present invention.

### 1.0 Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

As used herein, the term “crosslinkable ink composition” refers to an ink composition that is capable of undergoing crosslinking under light (e.g., UV light, IR light, visible light, etc.) and that can change color over the entire visible spectrum by changing one or parameters during the printing process. For example, the crosslinkable ink composition may change color over the entire visible spectrum by using kinetic trapping mechanism during the printing process. In such as instance, the kinetic trapping can be effected by changing one or more parameters (e.g. UV crosslinking rate, pressure, temperature, printing speed) during the printing process.

In some embodiments, UV crosslinking rate is determined by the amount of crosslinker and UV light irradiance.

As used herein, the term “2D article” refers to an article prepared via a method involving 2D printing using a crosslinkable ink composition disclosed herein. For example, an article prepared by printing onto a planar surface using a crosslinkable ink composition disclosed herein. In some embodiments, said article is a curved surface prepared by 2D printing using a crosslinkable ink composition disclosed herein.

As used herein, the term “2.5D article” refers to an article prepared via a method involving 2.5D printing using a crosslinkable ink composition disclosed herein. For example, an article prepared by printing onto a curved surface using a crosslinkable ink composition disclosed herein. In some embodiments, said article is a curved surface prepared by 2.5D printing using a crosslinkable ink composition disclosed herein.

As used herein, the term “photo crosslinkable” refers to a material that is capable of undergoing crosslinking under light (e.g., UV light, IR light, visible light, etc.).

It is to be understood that both the foregoing descriptions are exemplary, and thus do not restrict the scope of the invention.

One aspect of the invention pertains to a crosslinkable ink composition comprising:
a. a material (e.g., linear block copolymer, bottlebrush block copolymer (such as polystyrene-b-polylactic acid bottlebrush block copolymer, poly(dimethylsiloxane) polylactic acid bottlebrush block copolymer, poly(methyl methacrylate) polylactic acid bottlebrush block copolymer), nanocellulose (such hydroxypropyl cellulose), silicon based nanomaterials (such as nanocrystals, nanorods, nanosheets) polystyrene-based nanomaterials (such as nanocrystals, nanorods, nanosheets, etc.);
b. a solvent (e.g., an aprotic solvent such as benzene, toluene, xylenes (ortho-, para-, and meta-), mesitylene, chloroform, chlorobenzene (mono, di, tri), tetrahydrofuran, acetonitrile, ethyl acetate, etc, or a protic solvent such as water, etc.);
c. a photo initiator (e.g., a UV initiator, such as 2,2-dimethoxy-2-phenlyacetophenone (DMPA), AIBN (Azobisisobutyronitrile), Benzoyl peroxide, PEGDA (polyethylene glycol diacrylate), TPT (trimethylolpropane triacrylate), etc.); and
d. a linker molecule (e.g., pentaerythritol tetra (mercaptopropionate) (PETMP), dithiol groups (e.g. 1,6-hexanedithiol, 1,9 nonanedithiol, etc), trimethylolpropane tris(3-mercaptopropionate) (TMPMP), tris[2-(3-mercaptopropionyloxy) ethyl]isocyanurate (TMI), pentaerythritol tetrakis (3-mercaptopropionate) (PE-1), triallyl-1,3,5-triazine-2,4,6 (1H,3H,5H)-trione (TTT), etc.)
   wherein the material is photo crosslinkable (e.g. UV crosslinkable) and is capable of forming domain spacings of at least about 50 nm (and interacts with visible light on the electromagnetic spectrum), under irradiation in light conditions in the presence of a solvent, a photo initiator, and a linker molecule.

Another aspect of the invention pertains to a crosslinkable ink composition comprising:
a. a material (e.g., linear block copolymer, bottlebrush block copolymer (such as polystyrene-b-polylactic acid bottlebrush block copolymer, poly(dimethylsiloxane) polylactic acid bottlebrush block copolymer, poly(methyl methacrylate) polylactic acid bottlebrush block copolymer), nanocellulose (such hydroxypropyl cellulose), silicon based nanomaterials (such as nanocrystals, nanorods, nanosheets) polystyrene-based nanomaterials (such as nanocrystals, nanorods, nanosheets, etc.);
b. a solvent (e.g., an aprotic solvent such as benzene, toluene, xylenes (ortho-, para-, and meta-), mesitylene, chloroform, chlorobenzene (mono, di, tri), tetrahydrofuran, acetonitrile, ethyl acetate, etc, or a protic solvent such as water, etc.);
c. a UV initiator, such as 2,2-dimethoxy-2-phenlyacetophenone (DMPA), AIBN (Azobisisobutyronitrile), Benzoyl peroxide, PEGDA(polyethylene glycol diacrylate), TPT (trimethylolpropane triacrylate), etc.); and
d. a linker molecule (e.g., pentaerythritol tetra (mercaptopropionate) (PETMP), dithiol groups (e.g. 1,6-hexanedithiol, 1,9 nonanedithiol, etc), trimethylolpropane tris(3-mercaptopropionate) (TMPMP), tris[2-(3-mercaptopropionyloxy) ethyl]isocyanurate (TMI), pentaerythritol tetrakis (3-mercaptopropionate) (PE-1), triallyl-1,3,5-triazine-2,4,6 (1H,3H,5H)-trione (TTT), etc.)
wherein said material is UV crosslinkable and is capable of forming domain spacings of at least about 50 nm (and interacts with visible light on the electromagnetic spectrum), under UV irradiance in the presence of a solvent, a UV initiator, and a linker molecule.

One further aspect of the invention pertains to a crosslinkable ink composition comprising an aprotic (such as toluene) cc-BBCP solution (e.g., about 50-500 mg/mL, or about 150-350 mg/mL, or about 250 mg/mL), a pentaerythritol tetrakis (3,5-di-tert-butyl-4-hydroxyhydrocinnamate) crosslinker and 2,2-dimethoxy-2-phenyl acetophenone photo-initiator.

One aspect of the invention pertains to a method of preparing UV crosslinkable bottlebrush block copolymers, said method comprising
a. adding one or more crosslinkable moieties (e.g. allyl moieties) to one or more sidechains of said polymer;
b. crosslinking said polymer via a UV light-initiated thiolene reaction.

A further aspect of the invention pertains to an additive manufacturing with BBCP self-assembly to attain control of printed/coated structures/articles down to the nanoscopic scale. Click or tap here to enter text. For example, a single BBCP containing ink composition can produce multicolored prints by modulating simple printing/coating parameters such as the print speed and substrate temperature (e.g., of a 3D printer) Click or tap here to enter text. Without wishing to be bound by a particular theory, it is believed that this leverages a kinetic trapping mechanism whereby evaporation-driven assembly was arrested before reaching the equilibrium structure through rapid solvent evaporation Click or tap here to enter text. This approach presents an effective strategy to modulate structural color of a single ink composition. But is limited in achieving “on-the-fly” control of color during printing. This is because temperature and printing speed are not ideal “knobs” for tuning assembly—temperature cannot be changed rapidly and is difficult to localize, while printing speed is coupled with line profiles and thus structural color cannot be adjusted independently.

A further aspect of the invention pertains to a method of “on-the-fly”/dynamic modulating structural color during the printing/coating process, said method comprising combining a UV-assisted DIW 3D printer with an ink composition comprising c-BBCP chemistry. Without wishing to be bound by a particular theory, it is believed that dynamic control of assembly kinetics may be realized through programming the rate of photo-crosslinking, which may serve to kinetically arrest assembly and lock in desired structural color “on-the-fly”, or via dynamic modulation during the printing/coating process.

Combined coarse-grained simulations, rheological characterizations, and experimental structural analysis were further done for validation. An ‘implicit side-chain’ (ISC) model was developed to elucidate an evaporation-driven assembly pathway whereby the structural color evolves from blue to red due to backbone extension. Scanning electron microscopy (SEM) and ultra-violet visible (UV-Vis) spectroscopy was used to affirm the inference. Using rheology and in situ imaging, the crosslinking timescale was matched with the evaporation-driven assembly timescale. Without wishing to be bound by a particular theory, it is believed that assembly is arrested by crosslinking during evaporation-driven structural evolution. Furthermore, it is believed that programming the temporal profile of UV irradiance may lead to demonstration of modulation of structural color “on the fly” as to access much of the visible spectrum and to creation of color gradients using a single ink composition.

A further aspect of the invention pertains to a method of printing, said method comprising a UV-assisted direct-ink-write (DIW) 3D printing approach capable of on-the-fly modulation of structural color using self-assembling PS-b-PLA crosslinkable bottlebrush block copolymers (c-BBCP). This technique enables access to multiple colors during a single printing process using a single ink material, through UV-crosslinking-induced kinetic trapping of evaporative assembly. This approach is enabled by two advances. First, by designing and synthesizing a new allyl-functionalized BBCP which utilizes thiolene chemistry for UV crosslinking. Second, by developing a hardware and software framework for UV-assisted DIW 3D printing capable of on-the-fly modulation of crosslinking kinetics by programming UV light irradiance. This approach grants access to structural colors in the visible wavelength spectrum from deep blue (392 nm) to orange (582 nm) by reducing UV light irradiance from 411 to 0 μW/cm².

Combining coarse-grained simulation with rheology and in situ structural characterizations, a crosslinking-induced kinetic trapping mechanism during evaporation assembly is unveiled. The elements of this assembly mechanism include the following:

Solvent evaporation evolves the structural color of self-assembled lamella from blue to red as the domain spacing increases driven by more block-to-block contact. This insight is enabled by adapting a computationally-efficient implicit side chain (ISC) simulation to model this system. Second, crosslinking is capable of tuning assembly kinetics and structural color only when the crosslinking timescale is comparable to the assembly timescale. Under this condition, increasing crosslinking rate locks in bluer states as the assembly is arrested further from the equilibrium to result in smaller domain spacing. The matching timescale requirement is unveiled by UV rheology combined with in situ imaging and validated by negative control experiments. Printing of color gradients is demonstrated by modulating UV light irradiance on the fly. Two examples are presented: chameleon and Starry Night with colors spanning blue to green to orange, both produced in a single print using a single ink. This approach showcases the power of combining additive manufacturing and non-equilibrium assembly to achieve spatial and temporal control over nanoscale structures and photonic properties.

### LIST OF EMBODIMENTS

The following is non-limiting list of embodiments encompassed by the invention:
1. A crosslinkable ink composition comprising:
   a. A material (e.g., linear block copolymer, bottlebrush block copolymer (such as polystyrene-b-polylactic acid bottlebrush block copolymer, poly(dimethylsiloxane) polylactic acid bottlebrush block copolymer, poly(methyl methacrylate) polylactic acid bottlebrush block copolymer), nanocellulose (such as hydroxypropyl cellulose), silicon based nanomaterials (such as nanocrystals, nanorods, nanosheets) polystyrene-based nanomaterials (such as nanocrystals, nanorods, nanosheets, etc.). In some embodiments, said material is a polymeric material (e.g., linear block copolymer and bottlebrush block copolymer);
   b. a solvent (e.g., an aprotic solvent such as benzene, toluene, xylenes (ortho-, para-, and meta-), mesitylene, chloroform, chlorobenzene (mono, di, tri), tetrahydrofuran, acetonitrile, ethyl acetate, etc, or a protic solvent such as water, etc.);
   c. a photo initiator (e.g., a UV initiator, such as 2,2-dimethoxy-2-phenlyacetophenone (DMPA), AIBN (Azobisisobutyronitrile), Benzoyl peroxide, PEGDA(polyethylene glycol diacrylate), TPT (trimethylolpropane triacrylate), etc.); and
   d. a linker molecule (e.g., pentaerythritol tetra (mercaptopropionate) (PETMP), dithiol groups (e.g. 1,6-hexanedithiol, 1,9 nonanedithiol, etc), trimethylolpropane tris(3-mercaptopropionate) (TMPMP), tris[2-(3-mercaptopropionyloxy) ethyl]isocyanurate (TMI), pentaerythritol tetrakis (3-mercaptopropionate) (PE-1), triallyl-1,3,5-triazine-2,4,6 (1H,3H,5H)-trione (TTT), etc.)
      wherein said material is photo crosslinkable (e.g. UV crosslinkable, visible crosslinkable, IR crosslinkable, etc) and is capable of forming domain spacings of at least about 50 nm (and interacts with visible light on the electromagnetic spectrum), under irradiation in light conditions (UR, IR or visible) in the presence of a solvent, a photo initiator, and a linker molecule.
2. A crosslinkable ink composition comprising:
   a. a material (e.g., linear block copolymer, bottlebrush block copolymer (such as polystyrene-b-polylactic acid bottlebrush block copolymer, poly(dimethylsiloxane) polylactic acid bottlebrush block copolymer, poly(methyl methacrylate) polylactic acid bottlebrush block copolymer), nanocellulose (such hydroxypropyl cellulose), silicon based nanomaterials (such as nanocrystals, nanorods, nanosheets) polystyrene-based nanomaterials (such as nanocrystals, nanorods, nanosheets, etc.). In some embodiments, said material is a polymeric material (e.g., linear block copolymer and bottlebrush block copolymer);
   b. a solvent (e.g., an aprotic solvent such as benzene, toluene, xylenes (ortho-, para-, and meta-), mesitylene, chloroform, chlorobenzene (mono, di, tri), tetrahydrofuran, acetonitrile, ethyl acetate, etc, or a protic solvent such as water, etc.);
   c. a UV initiator, such as 2,2-dimethoxy-2-phenlyacetophenone (DMPA), AIBN (Azobisisobutyronitrile), Benzoyl peroxide, PEGDA(polyethylene glycol diacrylate), TPT (trimethylolpropane triacrylate), etc.); and
   d. a linker molecule (e.g., pentaerythritol tetra (mercaptopropionate) (PETMP), dithiol groups (e.g. 1,6-hexanedithiol, 1,9 nonanedithiol, etc), trimethylolpropane tris(3-mercaptopropionate) (TMPMP), tris[2-(3-mercaptopropionyloxy) ethyl]isocyanurate (TMI), pentaerythritol tetrakis (3-mercaptopropionate) (PE-1), triallyl-1,3,5-triazine-2,4,6 (1H,3H,5H)-trione (TTT), etc.)
      wherein said material is UV crosslinkable and is capable of forming domain spacings of at least about 50 nm (and interacts with visible light on the electromagnetic spectrum), under UV irradiance in the presence of a solvent, a UV initiator, and a linker molecule.
3. The composition of embodiment 1, wherein said domain spacings are in the range of about 50 nm to about 500 nm, or about 70 nm to about 250 nm, or about 100 nm to about 250 nm, or about 100 nm to about 400 nm.
4. The composition of embodiment 1, wherein said material is a bottlebrush block copolymer.
5. The composition of embodiment 1, wherein said material is a bottlebrush block copolymer that can self-assemble in the presence of a solvent (such as an aprotic solvent), a UV initiator, and a linker molecule under UV irradiance.
6. The composition of embodiment 1, wherein said material is a polystyrene-b-polylactic acid bottlebrush block copolymer.
7. The composition of embodiment 1, wherein said polystyrene-b-polylactic acid bottlebrush block copolymer comprises one or more moieties that exhibit photo crosslinking behavior under UV irradiation conditions (e.g., allyl, vinyl, acrylate, maleimide, Silane, etc.)
8. The composition of embodiment 1, wherein said solvent and said material (wt %) are present in a ratio in the range of about 2:1 to about 20:1 (preferably, about 4:1).
9. A crosslinkable ink composition comprising an aprotic (such as toluene) cc-BBCP solution (e.g., about 50-500 mg/mL, or about 150-350 mg/mL, or about 250 mg/mL), a pentaerythritol tetrakis (3,5-di-tert-butyl-4-hydroxyhydrocinnamate) crosslinker and 2,2-dimethoxy-2-phenyl acetophenone photo-initiator.
10. A method adding crosslinkable ink composition to a surface, said method comprising contacting said composition of embodiment 1 with a planar surface or a curved surface in the presence of UV light having irradiance in the range of 0 to 3 μW/cm², or 2 mW/cm² to 200 mW/cm², or 0 to 411 μW/cm², 0 to 450 μW/cm².
11. The method of embodiment 10, wherein said contacting comprises coating said surface at a printing speed in the range of about 5 mm/min to about 1000 mm/min, or about 5 mm/min to about 500 mm/min, or about 100 mm/min to about 200 mm/min.
12. The method of embodiment 10, wherein said contacting comprises coating said surface at a temperature in the range of about 0° C. to about 100° C., or about 0° C. to about 90° C., about 60° C.
13. A method of preparing UV crosslinkable bottlebrush block copolymers, said method comprising
   a. adding one or more crosslinkable moieties (e.g. allyl moieties) to one or more sidechains of said polymer;
   b. crosslinking said polymer via a UV light-initiated thiolene reaction.
14. The method of embodiment 13, wherein polymer is a polystyrene-b-polylactic acid bottlebrush block copolymer.
15. The method of embodiment 13, wherein one or more allyl moieties is added to one or more PLA sidechains of said polymer.
16. A 2D article, said article comprising one or more layers of said ink of any of the preceding embodiments on a surface of said article.
17. A 2.5D article, said article comprising one or more layers of said ink of any of the preceding embodiments on a surface of said article.

### EXAMPLES

The following examples are provided solely to illustrate the present invention and are not intended to limit the scope of the invention, described herein.

More details for the examples below can be found in the manuscript, entitled, Direct-Ink-Write Crosslinkable Bottlebrush Block Polymers for On-the-fly Control of Structural color, submitted for publication to PNAS in 2023, which is incorporated by reference.

### Example 1. Synthesis of Crosslinkable Bottlebrush Block Copolymers

A post-polymerization modification technique was developed to introduce crosslinking groups at the tips of the PLA brushes of PS-b-PLA c-BBCP. Post-polymerization modification is a well-established methodology for the introduction of functionalized groups in linear polymers. However, the post-polymerization modification of bottlebrush polymers present additional complexity because of the risk of alteration of the original bottlebrush architecture, with PLA being especially susceptible to transesterification and thus broadening of the molecular weight distribution. Furthermore, it was demonstrated that GPC, the workhorse characterization technique for polymers, is not effective at assessing the alteration of PLA segments along the bottlebrush polymer since the molecular weight distribution (MWD) of the bottlebrush polymer is primarily impacted by the MWD of the backbone and not of the side chains. Therefore, identification of a post-polymerization functionalization reaction to address these limitations and with the scope of employing thiolene click chemistry to achieve the UV-assisted crosslinking of c-BBCP was done.

An alcohol-isocyanate reaction catalyzed by tin-dibutyl diacetate (TDBDA) was identified as a simple reaction to introduce allyl group at the tips of PLA brushes. Methodology with a UV-active 1-naphthyl isocyanate and homo-PLA bottlebrush polymers was developed to demonstrate the success of the post-polymerization reaction and the absence of degradation of the original bottlebrush architecture. A wavelength of (266 nm) was selected for which the naphthyl group has a strong absorption and the PLA is mostly transparent, thus enabling monitoring of the extent of functionalization of the bottlebrush polymers using a combination of the UV detector of the GPC and ¹H NMR spectroscopy. By monitoring the gain in intensity of the bottlebrush signal as a function of time in the UV-GPC traces (using PS as an internal standard) and assessing the mole fraction of naphthyl groups present in the polymer by NMR, a reaction condition was identified that resulted in >95% of the PLA tips of the BB being functionalized in absence of any degradation of the architecture was identified by monitoring the gain in intensity of the bottlebrush signal as a function of time in the UV-GPC traces (using PS as an internal standard) assessing the mole fraction of naphthyl groups present in the polymer by NMR. The absence of degradation was evident from the MWD signal retaining the same shape throughout the reaction along with the absence of low molecular weight fractions in the GPC traces.

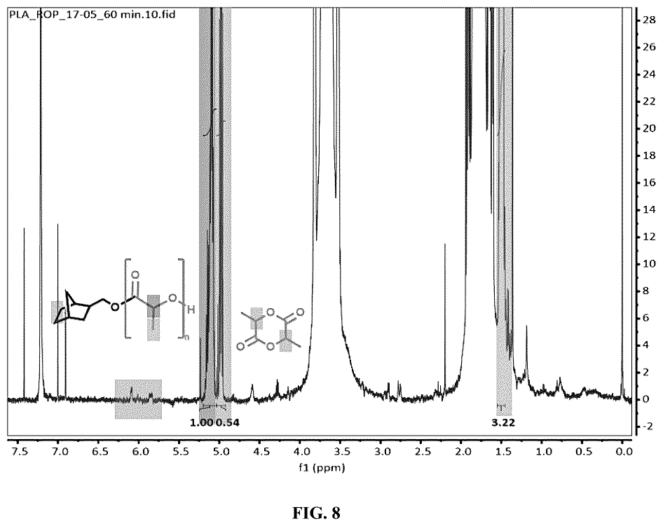

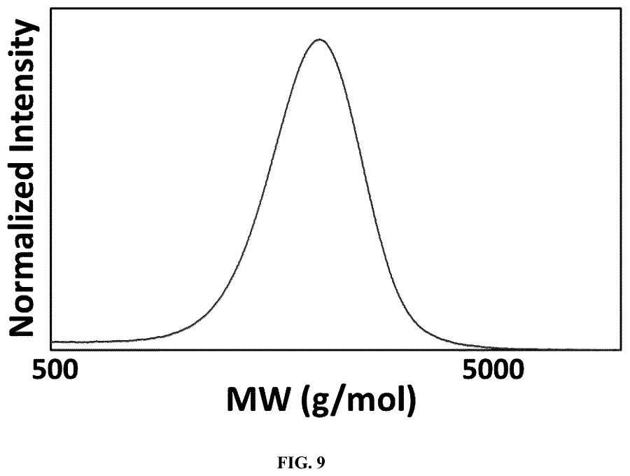

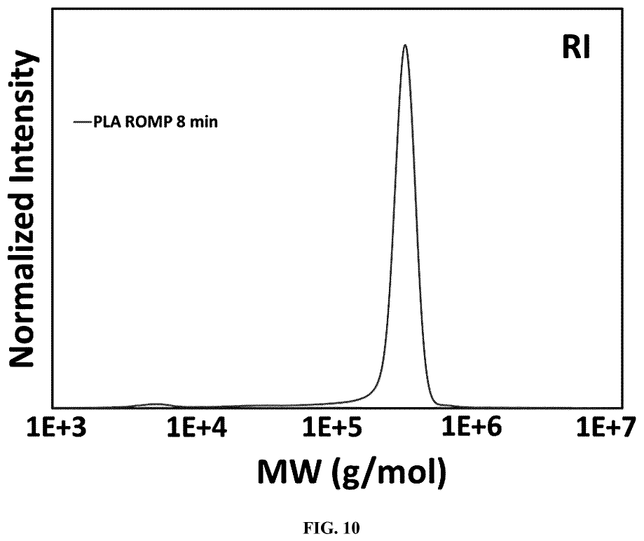

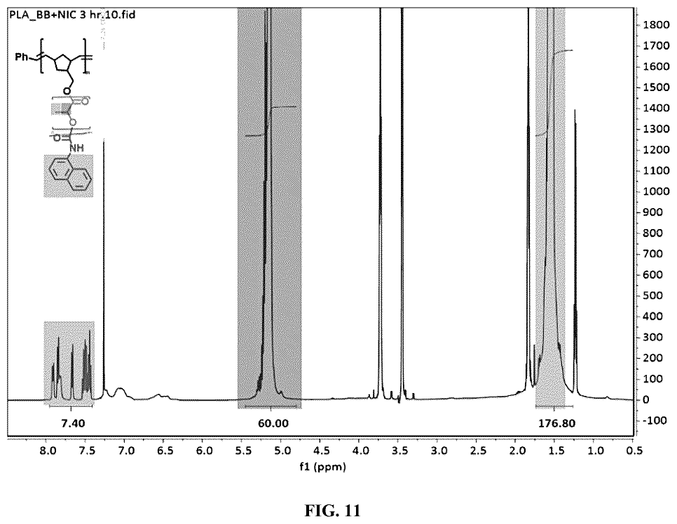

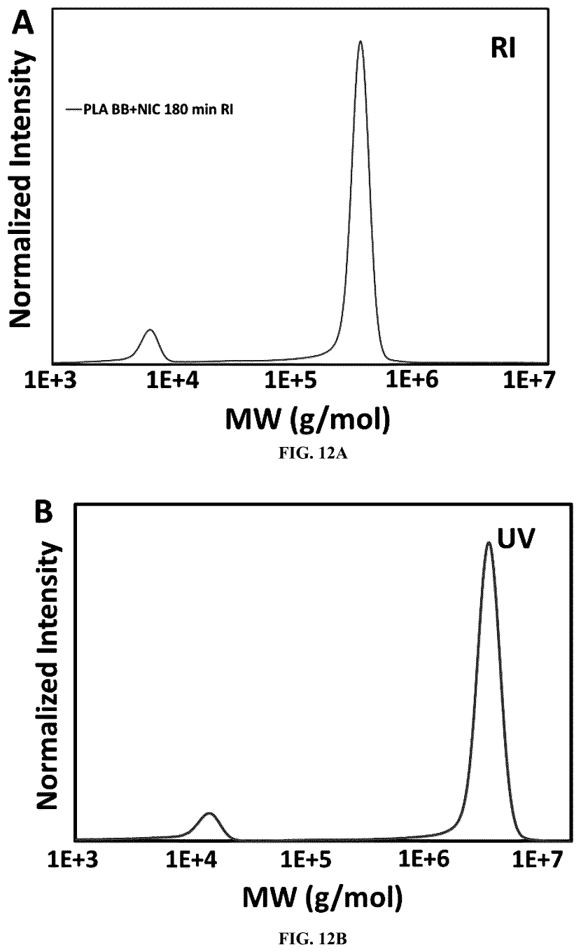

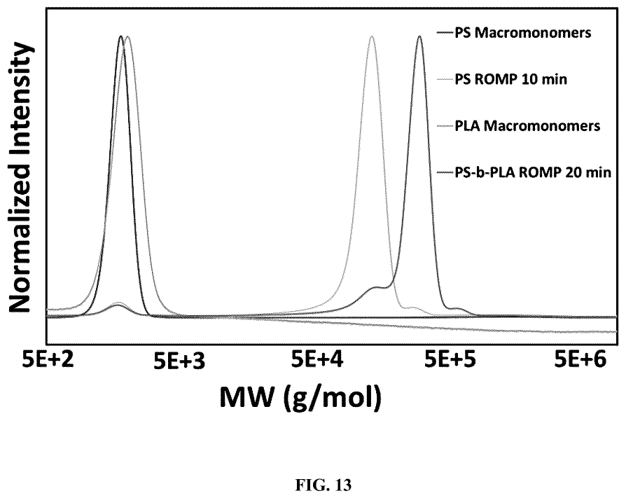

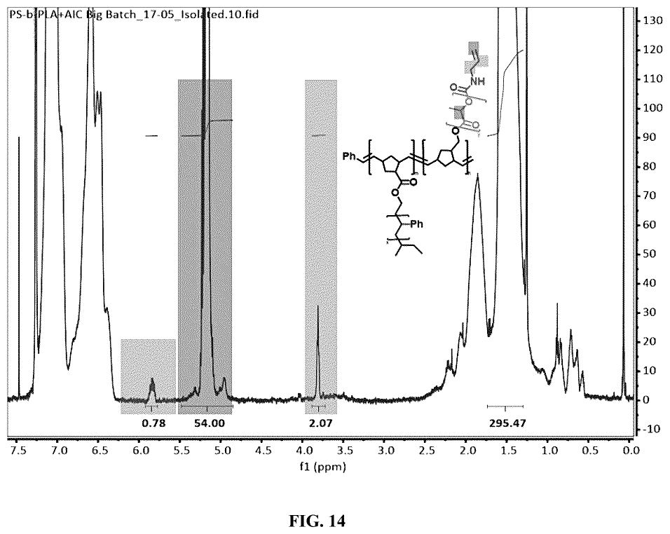

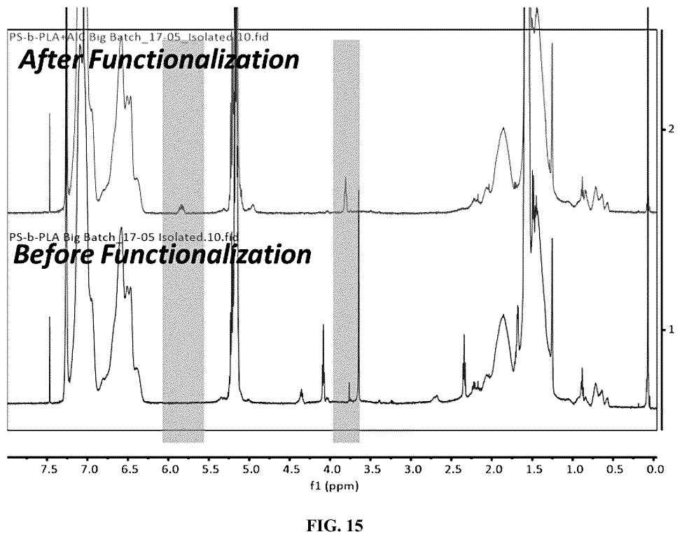

The post polymerization modification methodology to introduce allyl functionalities on the PLA side chain ends in the c-BBCP PS₂₀₀^{4.5k}-b-PLA₂₃₆^{4.8k} was implemented. The MWD of the c-BBCP remained unchanged through the post-polymerization reaction and the integration of the allyl protons in the NMR spectrum suggested that >75% of the PLA brushes were functionalized. The reaction yielded ˜20 g of functionalized polymers. The allyl end-capped PLA side chains of the c-BBCP will undergo UV-triggered thiolene reaction in the presence of a thiol-functionalized crosslinker and a photo initiator as discussed in the later sections. Further synthetic details and characterization can be found in FIG. 8-15, and discussion in-Example 7.

### Example 2. Establishing a Platform for UV-Assisted DIW 3D Printing

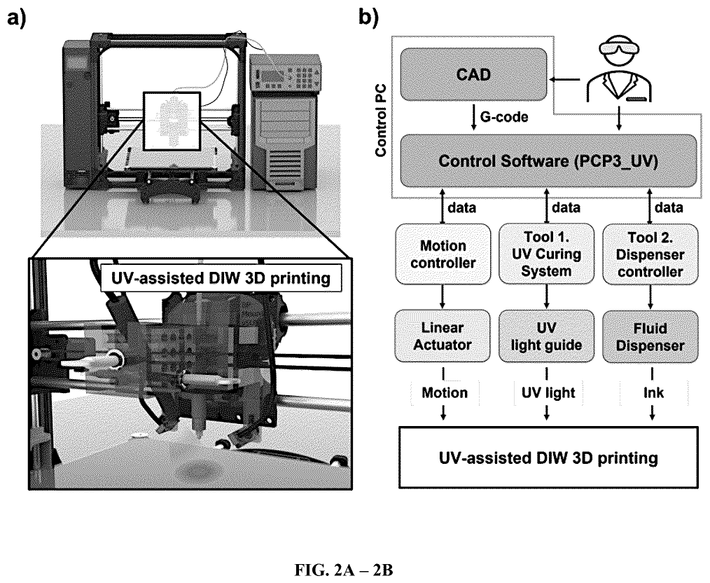

In parallel with designing crosslinking chemistries, an additive manufacturing approach was developed to achieve spatiotemporal control of photonic structure via modulating UV-triggered crosslinking during printing. To achieve this goal, two technical challenges needed to be overcome. First, the material dispensing, motion control, and UV light irradiation systems should be synchronized. Second, the crosslinking rate should be tunable by varying the UV light irradiance to match with the evaporation-driven assembly timescale (this criterion is discussed in depth later). To this end, a UV-assisted DIW 3D printer was custom designed based on the previously reported soft- and hardware framework PolyChemPrini. A new printhead with suspended UV light guide Spot UV Curing system (OmniCure S2000, Excelitas) to directly illuminate UV light at the tip of a pneumatic dispenser (FIG. 2a) was fabricated. PolyChemPrint software was further modified to develop PolyChemPrint3_UV that allows for programmable on-the-fly control of UV light on/off and irradiance during material dispensing. The UV lamp system offers the capability to adjust the UV light irradiance from 2 mW/cm² to 200 mW/cm². Additionally, by incorporating the UV light attenuator head, the range can be further tuned down to as low as 22 μW/cm², allowing for wide tune crosslinking rates over orders of magnitude. The hardware and software framework thus offers on-the-fly modification of printing speed, applied pressure, and irradiated UV light at the same time, enabling precise crosslinking control over self-assembling BBCP solutions (FIG. 2b). An actual photo of the hardware is available in FIG. 16.

### Example 3. On the Fly Tuning of c-BBCP Structural Color Using UV-Assisted DIW 3D Printing

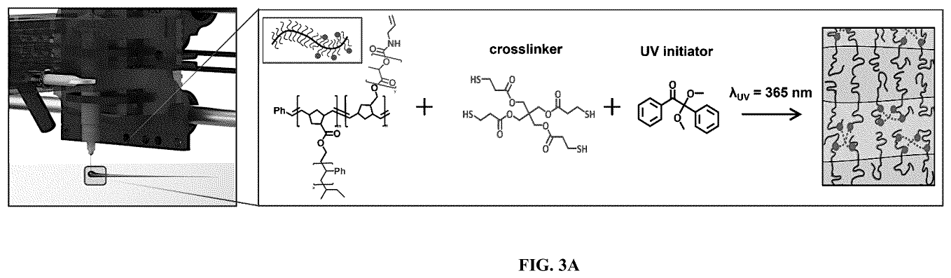

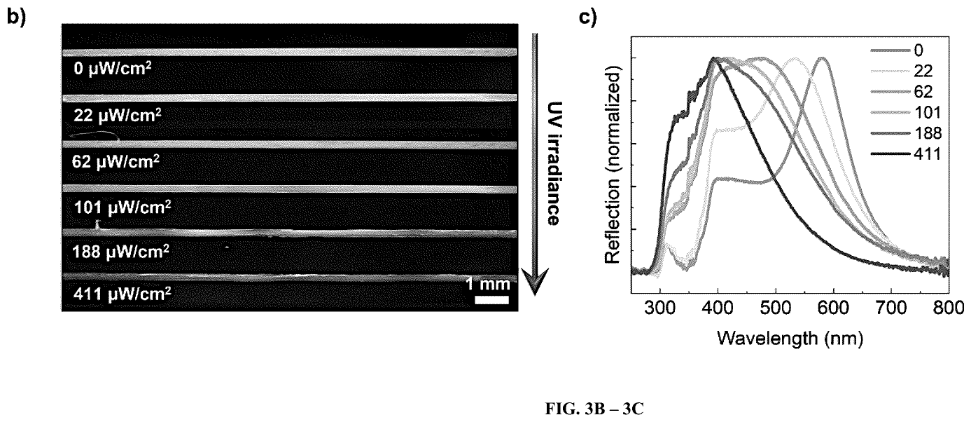

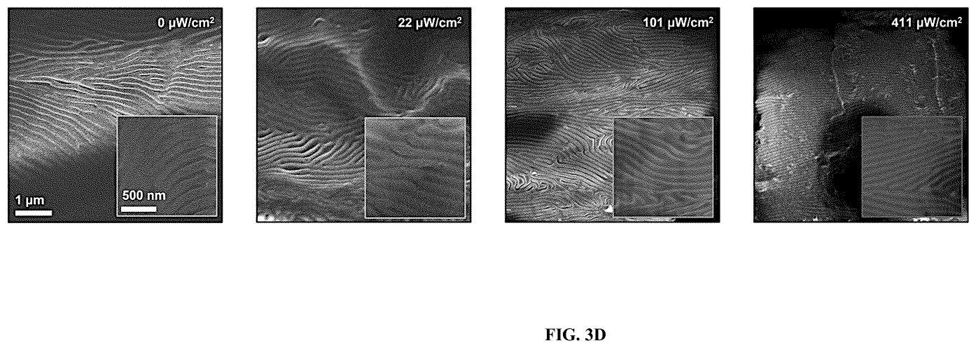

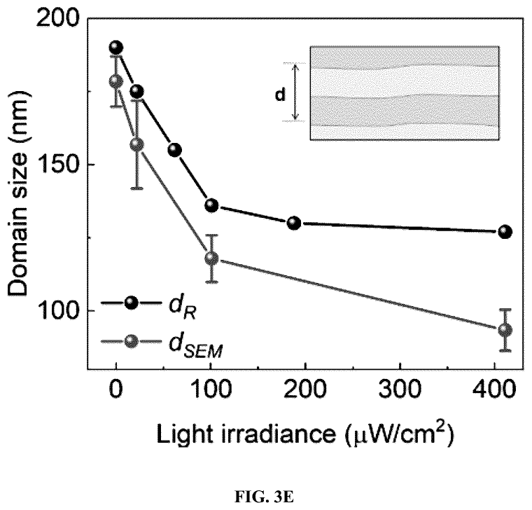

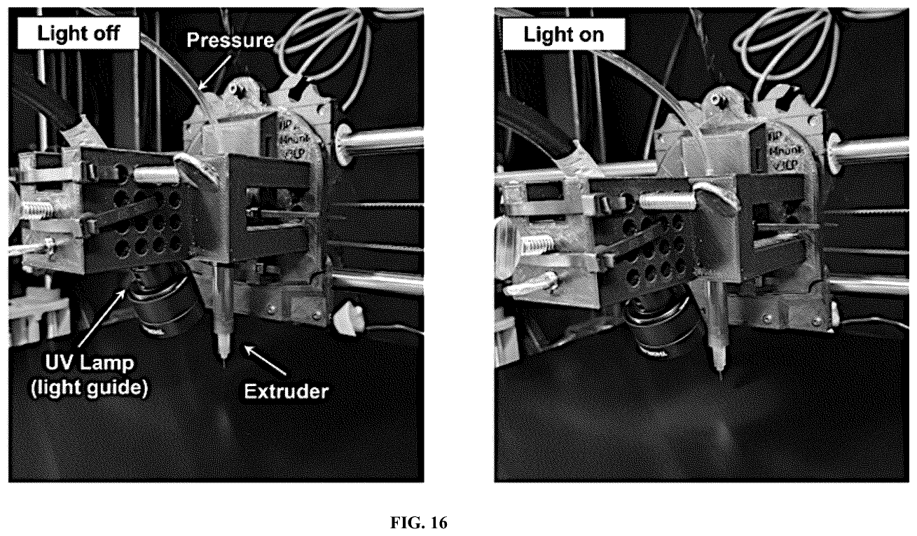

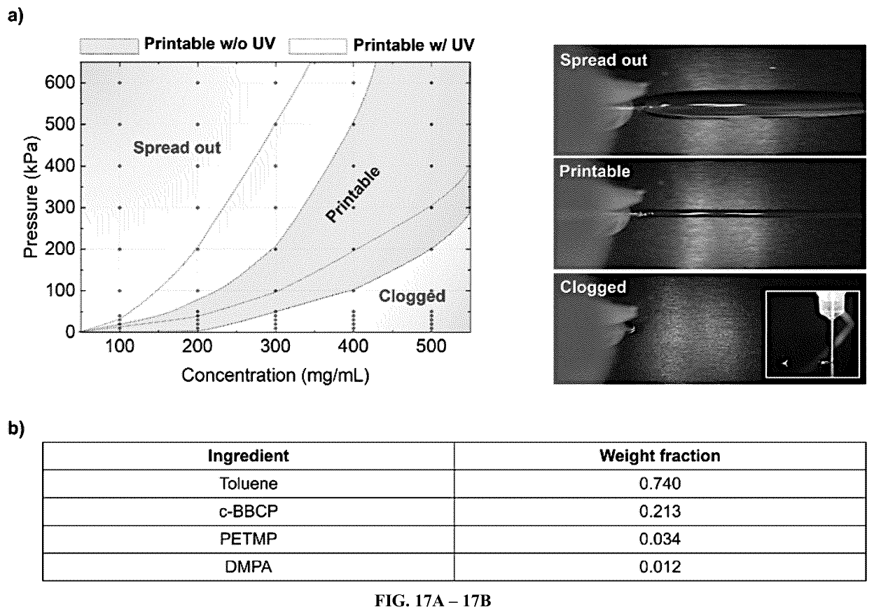

The crosslinkable ink for UV-assisted DIW 3D printing comprises of a concentrated c-BBCP toluene solution (250 mg/mL), a Pentaerythritol tetrakis (3,5-di-tert-butyl-4-hydroxyhydrocinnamate) crosslinker and 2,2-dimethoxy-2-phenyl acetophenone photo-initiator (FIG. 3a). The solution concentration and printing conditions such as pressure and printing speed were optimized to ensure print fidelity and to prevent clogging or excessive ink spreading on the substrate (details shown in FIG. 17). During the printing process, a rapid visible color progression from blue to orange induced by the evaporation driven self-assembly of BBCP was observed, which was captured by two cameras mounted at normal and 450 angles (FIG. 18). Using intense UV light having irradiance in the range of 2 mW/cm² to 200 mW/cm² as produced by the OmniCure S2000 UV-curing system led to either rapid clogging of the printing tip or printing of a single blue color that was insensitive to the UV light irradiance. However, by substantially attenuating the irradiance of UV to a lower range (0-411 μW/cm²), the structural color from orange to deep blue when the UV irradiance was increased from 0 to 411 μW/cm² (FIG. 3b) was fine tuned. As shown later, without attenuating the UV light, the crosslinking timescale is too short compared to the assembly timescale, preventing us from tuning structural color during printing.

The structural color shift was quantified by measuring the specular reflection spectra using UV-Visible spectroscopy with an integrating sphere (FIG. 3c). For sample with 0 μW/cm², the peak reflected wavelength was centered at 582 nm; as the UV irradiance increased to 411 μW/cm², a continuous blueshift by as much as 190 nm to 392 nm was observed. Cross-sectional SEM demonstrated that the underlying lamellar structural change was consistent with the observed optical property variations (FIG. 3d, 3e). Specifically, the average domain spacing (d_{SEM}) decreased from 178.4 to 93.4 nm with increasing UV light irradiance, shifting by as much as 85 nm representing a very wide structural tunability. To examine the consistency between UV-Vis and SEM, the domain spacing from peak reflected wavelength was calculated using a combination of Bragg's and Snell's law.

λ=2(n₁d₁+n₂d₂)

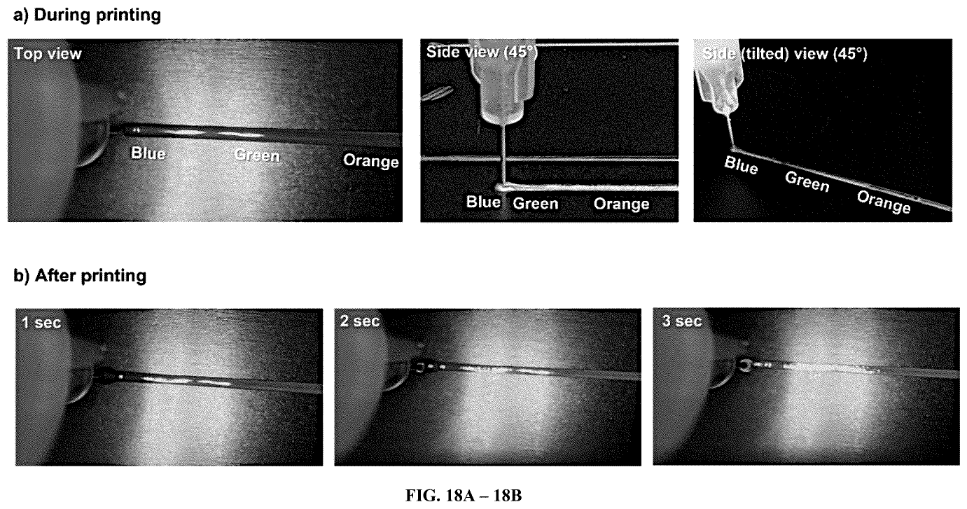

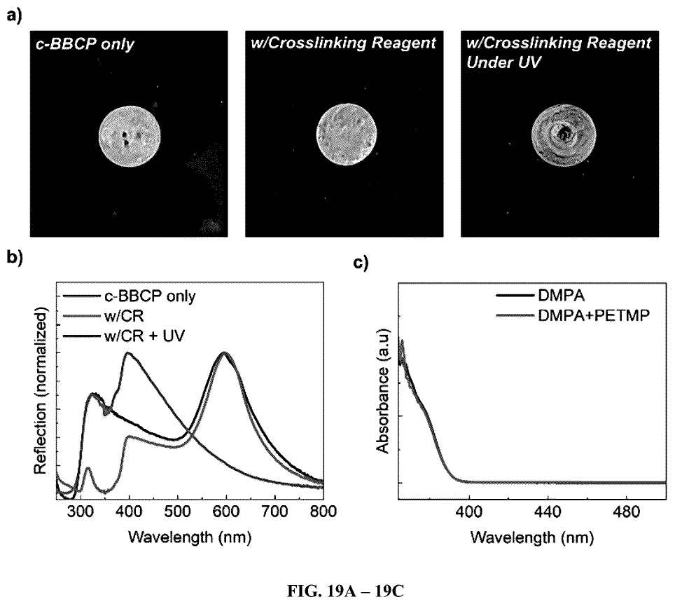

Here, λ represents the peak reflected wavelength, n₁, n₂ represent the refractive indices of each layer of lamellar, and d₁, d₂ represent the thickness of each layer. In this calculation, the bulk refractive indices of PS (1.586), and PLA (1.465) were used to approximate, and d₁, d₂ were calculated from the total domain size by assuming a volume fraction of ϕ_{PS}=0.56 in BBCP (detailed calculation shown in Example 9). Thus, estimated domain spacing from peak reflected wavelength of each line spans 190 to 127 nm as the UV light irradiance increases from 0 to 411 μW/cm², consistent with the observed domain spacing from SEM (FIG. 3e). In addition to the reflection peak shift caused by structural variation, increasing reflection <400 nm at higher irradiance was observed, which was attributed to increased photo initiator consumption which absorbs below 400 nm (see FIG. 19 and discussion in Example 10).

### Example 4. The Molecular Origin of the Evaporation-Driven Assembly and Structural Color

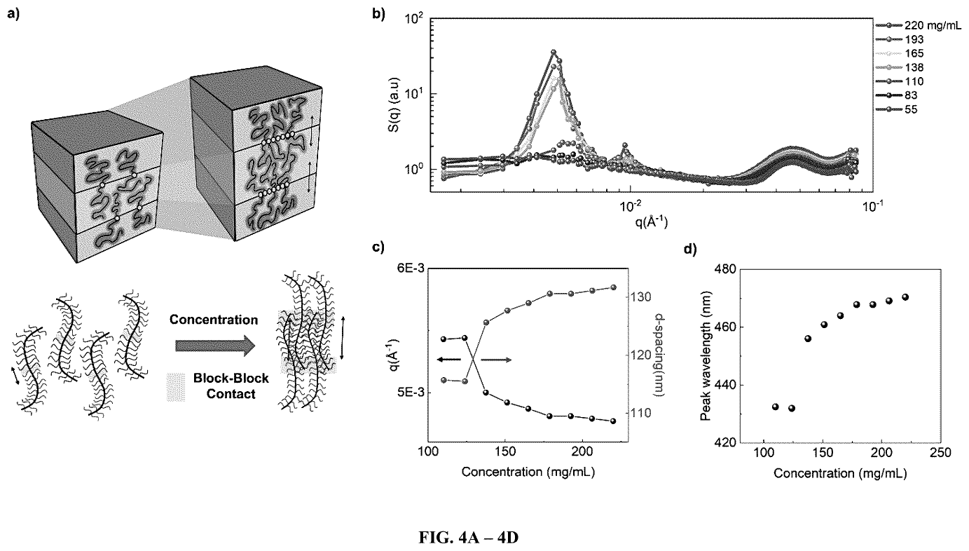

It was hypothesized that changes in structural color can be attributed to UV light-induced kinetic trapping during evaporative self-assembly. It was anticipated that crosslinking ‘freezes-in’ the domain size as it increases with concentration during evaporation; BBCPs adopt a more stretched conformation in their self-assembly structure because the removal of solvent induces more block-block contacts, and the polymers tend to minimize these stronger block-block repulsions. This enhanced segregation increases the size of BBCPs self-assembly domain so that the structural color undergoes a red-shift, which was observed in the experiments (FIG. 4a, 18). This general phenomenon has been demonstrated in several experimental situations, including recent works demonstrating that length scales of BBCPs self-assembly increase with polymer concentration. Coarse-grained simulation to demonstrates that, at the molecular level, this predicted self-assembly phenomenon is indeed consistent with the structural color changes that occur in the evaporation-induced process.

It was demonstrated that the order-disorder transition for lamellar BBCP can be modeled using coarse-grained molecular dynamics simulations with a computationally-efficient ISC model, where the coarse-grained beads represent the discretized segments of a BBCP worm-like cylinder model. This ISC representation is parameterized directly from bead-spring models at a higher resolution, retaining a minimal description of bottlebrush conformation. This model also accounts for inter-chain interactions through a scaling argument. The ISC model was modified to account for a concentration-dependent stiffness of the bottlebrush chain, due to increased excluded volume screening between overlapping side chain monomers that renders the bottlebrush more flexible.

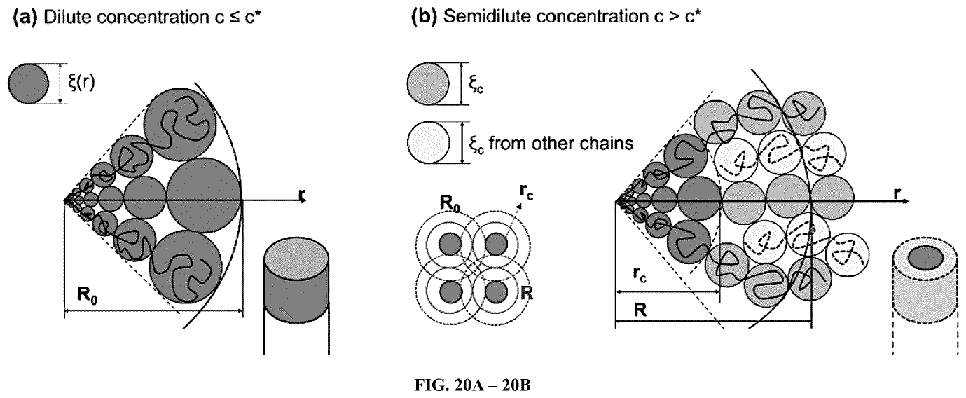

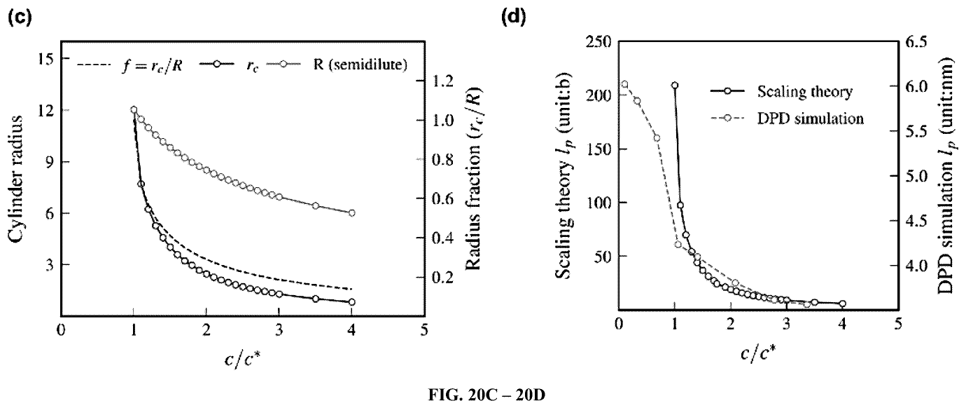

The modified ISC model considers a concentration-dependent extent of overlap, invoking scaling concepts similar to those used to describe semidilute polymer solutions for linear chains and related to other bottlebrush polymer solution scaling theories. This gives rise to a concentration-dependent persistent length for the ISC model that is due to the non-overlapping bottlebrush ‘core’ near the backbone. This theory is detailed in the FIG. 20 and discussion in Example 11, and it is shown that it predicts a rapid decrease in the BBCP persistent length with concentration that is consistent with simulations in the literature. The concentration-dependent persistent length is integrated into the coarse-grained ISC model, using an overlap concentration c*=55 mg mL-1. This modification helps observe the concentration dependence of self-assembled domains, as increased bottlebrush flexibility increases the conformational space available to the chains, and thus their ability to significantly vary their extension.

ISC model simulations spanning concentrations from c=55-220 mg mL⁻¹ were run to observe and compare the concentration-driven self-assembled structure to the experiment, which was quantified using the equilibrium structure factor S(q) (FIG. 4b) described in detail in the supporting information. Upon increasing over the overlap concentration (c*˜55 mg mL⁻¹), a low-q peak first emerges at 83 mg mL⁻¹ between 0.003 and 0.005 A1 that was attributed to the presence of strong concentration fluctuations. A subsequent ordered peak emerges above 124 mg mL⁻¹ at integer factors of low-q peak, which is indicative of an order-disorder transition that is consistent with both experiment data in previous work as well as with the dilute ISC model. Unlike previous work, however, the semidilute (i.e., concentration-dependent stiffness) ISC model exhibits a shift of the low-q peak position with increasing concentration (FIG. 4c). The shift of this peak agrees well with experimental trends.

This shift in the low-q peak position q* can be related to the real-space lamellar spacing and the material photonic properties. In FIG. 4c the lamellar domain spacing d* as a function of concentration was plotted, using the relationship d*=2π/q*, demonstrating that the lamellar spacing indeed increases with concentration. This is consistent with the experimentally observed change in structural color during evaporation (FIG. 18). The reflected wavelengths at each d-spacing is further estimated by matching domain size from SEM to the corresponding UV-vis wavelength in experiment (FIG. 4d). In FIG. 4d, it is predicted that the reflected wavelength transitions from 432 nm to 470 nm at concentrations relevant for the experimental data. This qualitatively captures the experimentally observed trend in solid-state samples, where reflected wavelengths varied from 392 nm to 592 nm, arrested at various stages of the structure evolution by UV crosslinking; the quantitative differences to approximations made in the coarse-graining scheme is attributed, in particular the discretization of the bottlebrush wormlike cylinder structure.

### Example 5. Validating Kinetic Trapping Hypothesis by Characterizing Competing Time Scales

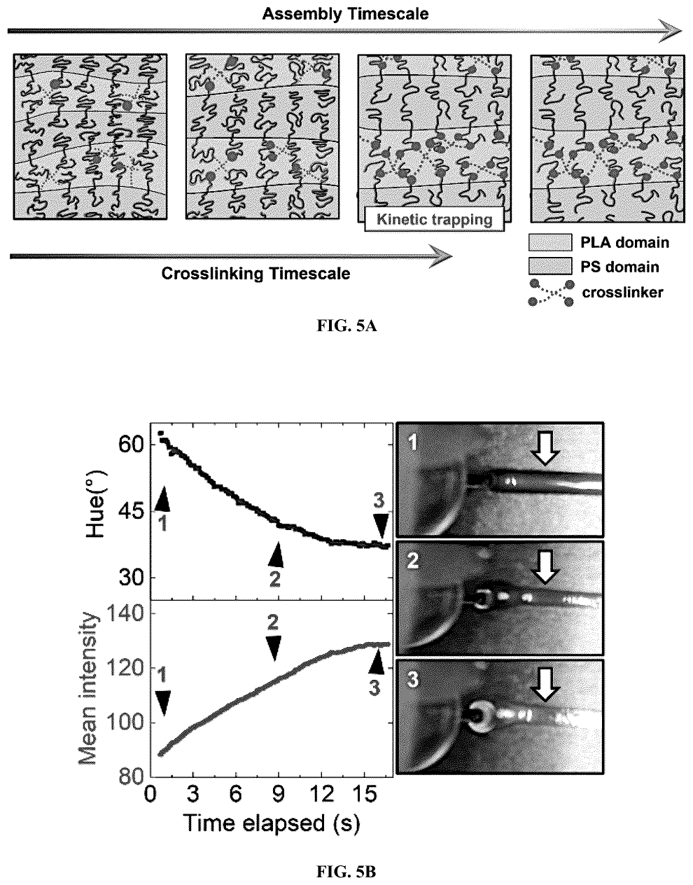

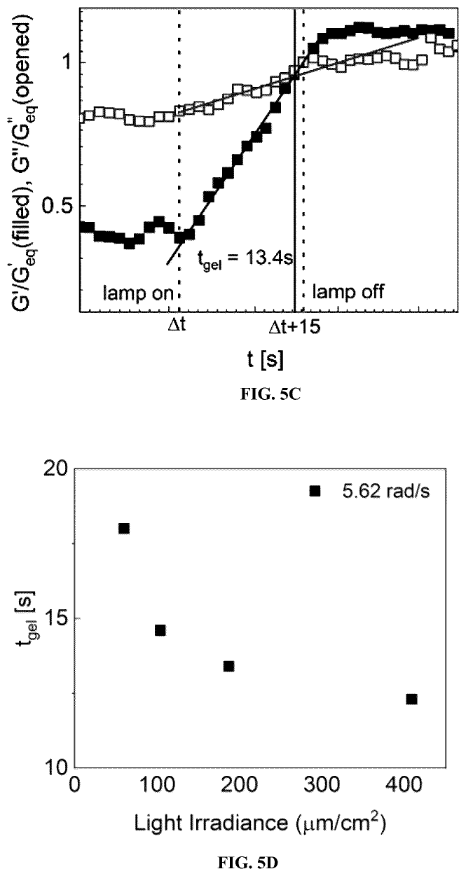

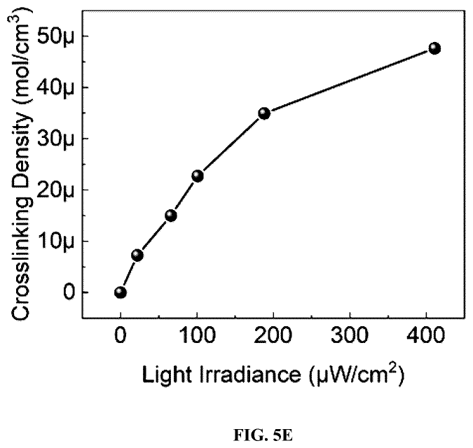

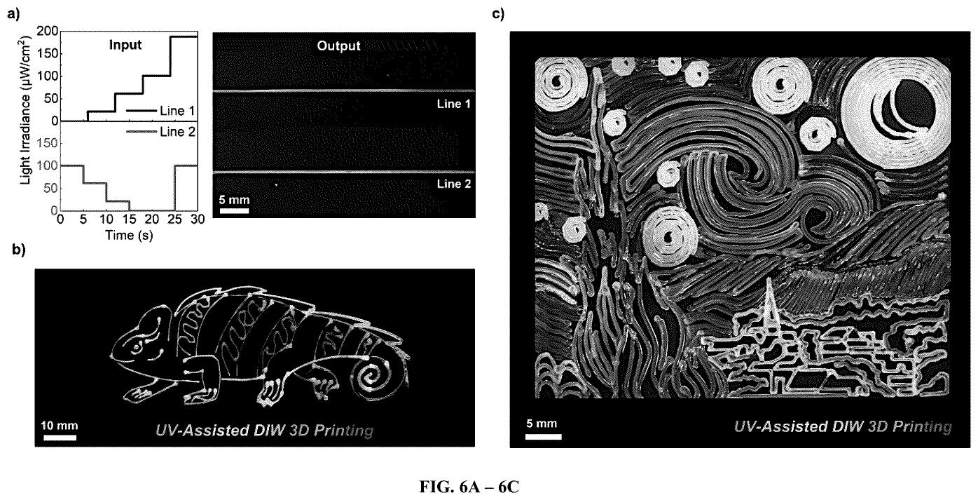

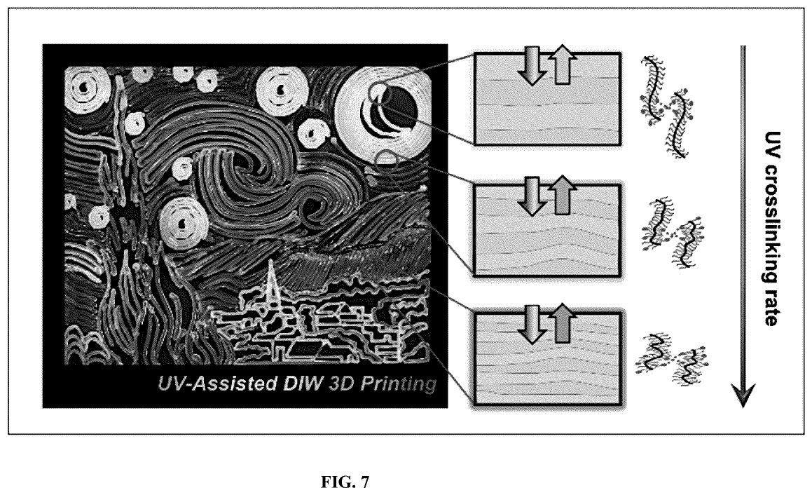

Whether photo-crosslinking entraps assembly before the structure reaches equilibrium or not was tested. This mechanism requires the timescale for the UV-crosslinking to form a gel to be comparable to the timescale for evaporation-driven assembly (i.e., t_{assembly}˜t_{gel}). (Figure Sa). The parameter, t_{assembly} was estimated by quantifying the time evolution of hue and intensity for the printed lines through in situ imaging (FIG. 5b). Both values underwent substantial changes after the ink exited the nozzle, with the mean intensity increasing and the hue decreasing, until both values plateaued at approximately 16 seconds. t_{assembly}≈16 s was determined as the time it takes for the color to saturate, given that the color evolution is a manifestation of the lamella domain evolution during evaporative assembly, as established in the previous section.

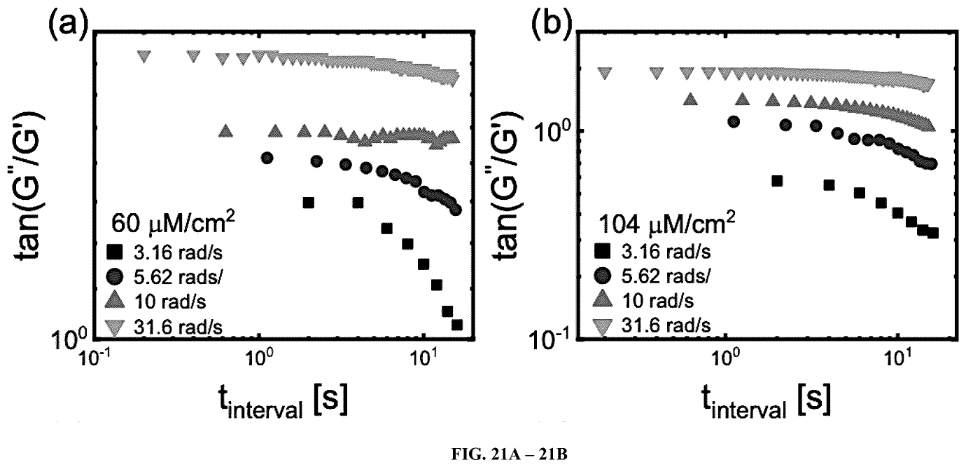

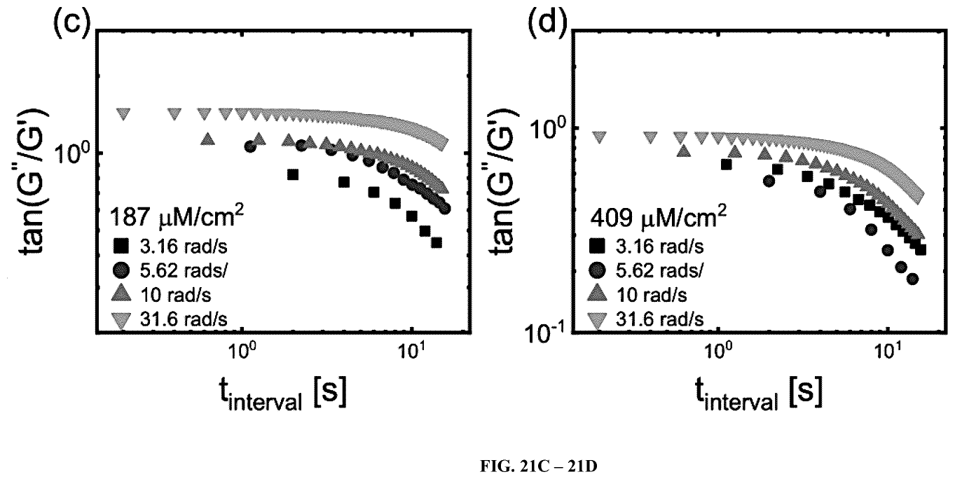

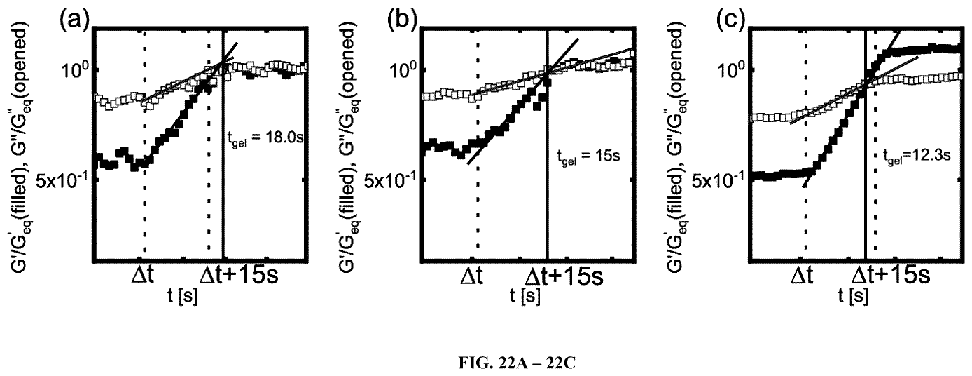

The crosslinking timescale was taken as the time taken to form a gel (t_{gel}), which was estimated based on UV rheological analysis. FIG. 5c shows the evolution of the dynamic moduli as a function of time before, during, and after UV light exposure at an irradiance of 187 μW/cm² at an angular frequency ω of 5.62 rad/s to illustrate the procedure of determining the crosslinking time t_{gel}. The moduli have been normalized by their equilibrium values, G′_{eq} and G″_{eq}, at times long after UV curing. The accessible range of UV light irradiance was limited, and four different irradiance levels were selected. Experiments were conducted between 60 and 409 μW/cm², closely resembling the estimated irradiance applied by the UV-assisted DIW 3D printer. UV exposure time was set to 15 s, following the estimated assembly time due to evaporation. While there are several ways to define the gel time t_{gel}, the time was defined since the lamp was first turned on at which the dynamic moduli crossover to be the gel time, t_{gel}. Alternative metrics and other rheological details are discussed in Example 12 (FIG. 21). The gel time was found to be a little more than t_{gel}≈13 s under the UV light irradiance of 187 μW/cm². The same procedure was carried out for the rest of the tested UV light irradiances. For the lower UV light irradiances which do not show the crossover point within 15 s, linear extrapolation was performed (FIG. 22). The relation between the t_{gel} and UV light irradiance is represented in FIG. 5d at ω=5.62 rad/s, exhibiting comparable values with the assembly timescale (t_{assembly}≈16 s), consistent with the proposed kinetic trapping mechanism. Further, with increasing UV light irradiance, decreasing t_{gel} was observed, suggesting faster crosslink kinetics. To corroborate the UV-rheology, the effective crosslink density was estimated by equilibrium swelling measurements and Flory-Rehner analysis on printed samples (see detail in the discussion in-Example 7). With increasing UV light irradiance, the crosslinking density of the printed line was found to increase, consistent with faster crosslinking kinetic from rheology measurements (FIG. 5e). Taken together, these measurements clearly validate the kinetic trapping hypothesis that when the UV crosslinking time is comparable to the assembly timescale, varying light irradiance effectively tunes assembly timescales and entraps the assembled structure further from equilibrium (bluer color) at higher light irradiance due to shorter crosslinking timescale.

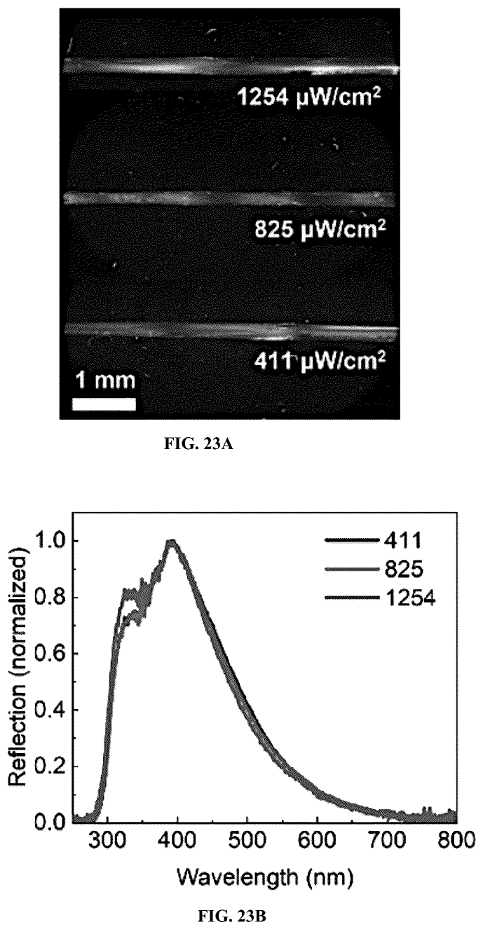

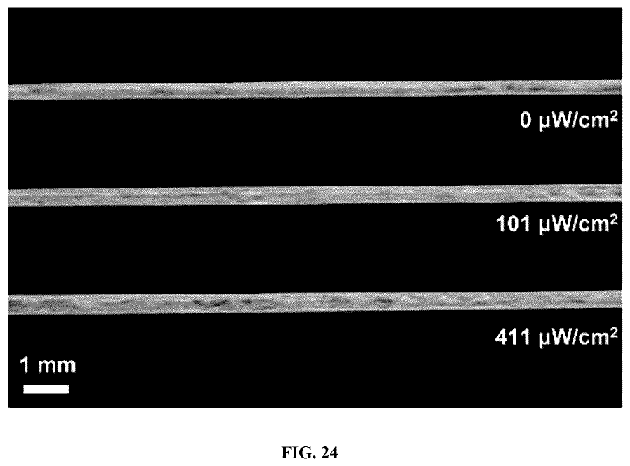

The proposed UV-crosslinking-induced kinetic trapping mechanism was further validated by two negative control experiments (Example 13). First, the UV light irradiance was increased to the range of 411 to 1254 μW/cm² and it was found that the structural color could not be tuned by the irradiance level within this range (FIG. 23). This shows that if the crosslinking timescale is too short compared to the assembly timescale, assembly was almost instantly frozen and the ability to modulate assembly timescale and therefore structural color is completely lost. Second, printing was performed under otherwise identical conditions but in absence of crosslinking agents (FIG. 24). Three lines were printed under UV light irradiance of 0, 101 and 411 W/cm², whose structural colors did not show any difference. These negative control experiments further affirmed that crosslinking at assembly relevant timescales is critical to structural color modulation.

### Example 6. Gradient Structural Color Printing

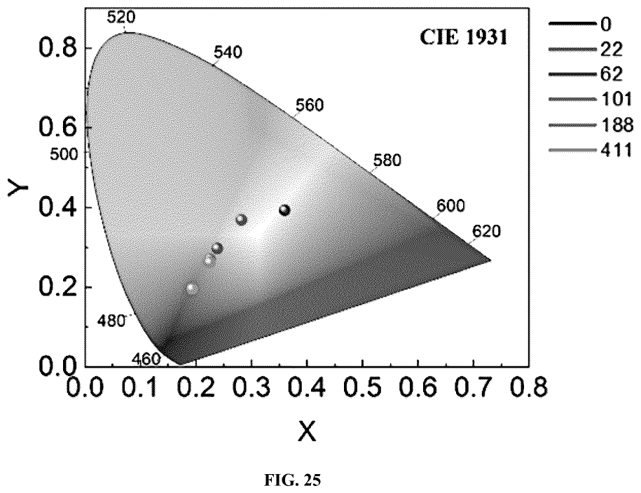

The interplay of crosslinking kinetics and self-assembly dynamics was leveraged to attain structural color modulation on the fly. Specifically, the temporal profile of UV light irradiance was programmed to produce prints with color gradients using a single ink material. Shown in FIG. 6a, line 1 was printed by increasing the UV light irradiance from 0 to 188 μW/cm² to result in orange-to-blue color gradient. Line 2 was produced by reducing UV light irradiance from 101 to 0 μW/cm², and then increasing back to 101 μW/cm², to yield a line with a gradient of blue to yellow to blue. To determine the precise color at each irradiance level, the color coordinate was calculated in Commission International de I'Eclairage (CIE) 1931 space using measured spectral reflection data (FIG. 3c). Detailed calculation is described in the FIG. 25 and discussion in Example 14. Enabled by this new functionality, more complex patterns were printed—a chameleon whose color gradually evolved from yellow to blue from head to tail (FIG. 6b), and a mimic of Van Gogh's “The Starry Night” with yellow-to-green moonlight, blue-to-green night sky, and yellow-to-green-to-blue village (FIG. 6c).

### Example 7. Synthesis

Material Synthesis and Characterization. All reactions were performed in an argon-filled glovebox (O₂<0.5 ppm, H₂O<0.5 ppm) at room temperature using oven-dried glassware. THF was dried using a commercial solvent purification system. rac-Lactide (Aldrich), sec-butyllithium solution (sec-BuLi, 1.3 mol/L in cyclohexane/hexane (92/8), ACROS Organics), ethylene oxide solution (2.5-3.3 mol/L in THF, Aldrich), allyl isocyanate (AIC)(Aldrich), naphthyl isocyanate (NIC)(Aldrich) and tin dibutyl diacetate (TDBDA, Aldrich) was used as received. 1,8-diazabicyclo [5.4.0]undec-7-ene (DBU) (Aldrich) was distilled over CaH₂ and storage under argon at −20° C. Styrene was passed through a basic alumina plug and stored under argon at −20° C. [(H₂IMes)(3-Brpy)₂(Cl)₂Ru=CHPh], G3 was synthesized according to literature. exo-5-Norbornene-2-carboxylic acid, endo-/exo-5-Norbornene-2-methanol (M30H) and exo-5-Norbornene-2-carbonyl chloride was synthesized according to literature. Click or tap here to enter text.

Nuclear Magnetic Resonance (NMR) spectra were recorded on a Carver B500 Bruker Avance III HD NMR Spectrometer. Spectra are reported in ppm and referenced to the residual solvent signal: CDCl₃ (¹H 7.26 ppm, ¹³C 77.16 ppm).

Gel Permeation Chromatography (GPC) was performed using a Tosoh ECOSEC HLC-8320GPC at 40° C. fitted with a guard column (6.0 mm ID×4.0 cm) and two analytical columns (TSKgel GMH_{HR}-H,7.8 mm ID×30 cm×5 m). A flow rate of 1 mL-min⁻¹ was used for both the analytical columns and the reference flow. THF (HPLC grade) was used as the eluent, and polystyrene standards (15 points ranging from 500 MW to 8.42 million MW) were used as the general calibration. UV detector was recorded at 266 nm.

### Procedure for the Synthesis of Polystyrene (PS) Macromonomers

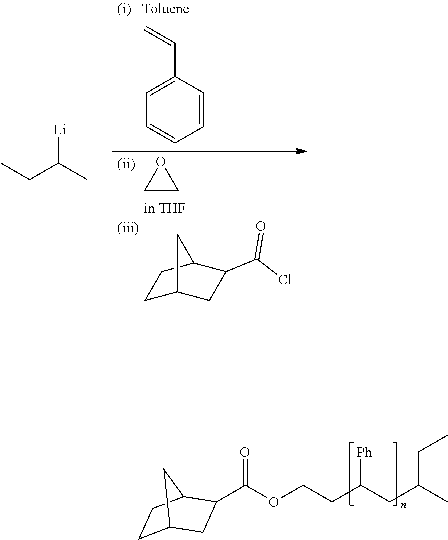

An oven-dried 500 mL round bottom flask was filled with 220 ml of dried toluene. Styrene (18.3 g, 176 mmol) was added next, followed by the sec-BuLi (3 ml, 3.9 mmol) solution to initiate the polymerization. The reaction mixture immediately turned deep orange. After 30 min, ethylene oxide solution (1.95 ml, 5.85 mmol) was added, which immediately resulted in the solution going colorless. After 30 min, exo-5-norobornene-2-acid chloride (794 mg, 5.07 mmol) was added. The reaction was allowed to stir overnight, in which a small amount of white solid formed. The polymer was isolated by precipitation in methanol and dried under vacuum.

M_{n,GPC}4,500 g/mol; ⊗=1.03

### Procedure for the Synthesis of Poly Lactide (PLA) Macromonomers³

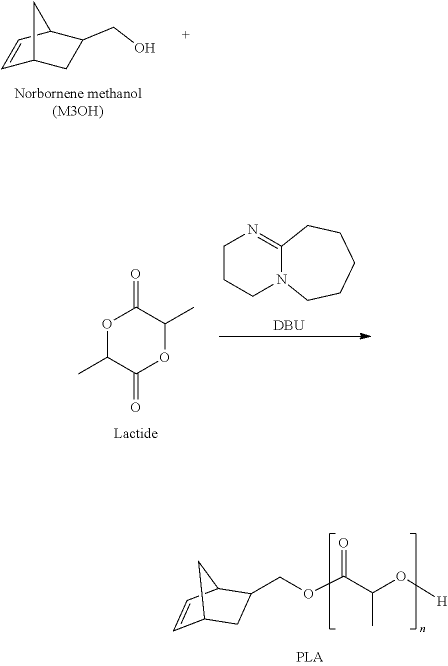

To an oven-dried 250 mL round bottom flask, lactide (9628 g, 66.86 mmol, 8 ml) and M30H (208.6 mg, 1.68 mmol) dissolved in 64.8 mL of THF. The polymerization was initiated by adding DBU (46.9 mg, 0.31 mmol) dissolved in 2 mL of THF. This reaction was mixed till the desired arm length was reached (60 min) at which time B(OH)₃ (135 mg, 2.18 mmol) in 13.5 ml of THF was added to the reaction mixture to quench the reaction. Aliquots were removed for GPC and NMR analysis.

M_{n,GPC}=4,800 g/mol; Mn,_{theory}=3,700 g/mol; Ð=1.07

Note: To get B(OH)₃ to dissolve into THF, the solution was heated to 90° C. till all the B(OH)₃ dissolved and allowed to cool back to room temperature before use. Avoid rapid cooling of the solution, as it will cause B(OH)₃ to drop out of solution.

### Procedure for the Synthesis of Homo PLA Bottlebrush Polymers⁴

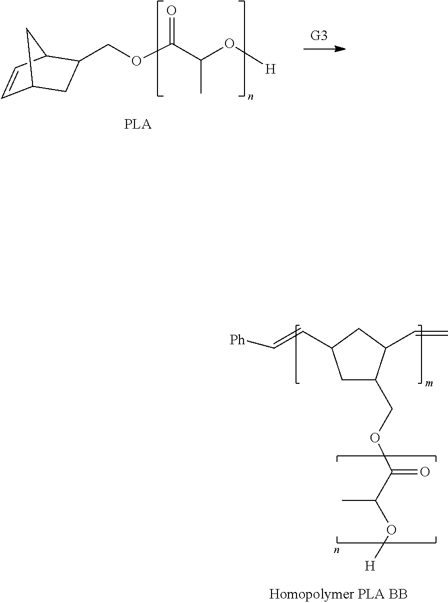

In an oven-dried 20 mL glass vial, the polymerization of PLA macromonomers (synthesized as mentioned previously in (II); M_{n, theory}=4,400 g/mol and Ð=1.07) was initiated by adding G3 via a stock solution (0.51 ml add of: 6.3 mg G3 in 3.1 ml THF stock solution; 1.04 mg, 0.0012 mmol resulting in a backbone length 217). After 8 mins, an aliquot was taken and injected into 1 ml of THF with a large excess of ethyl vinyl ether. The polymer was obtained by precipitating into methanol and dried under vacuum. Amount of polymer isolated=947 g (82% yield)

M_{n,GPC}=293 kg/mol; Mn,_{theory}=982 kg/mol; Ð=1.07

### Procedure for the Functionalization of Homo PLA Bottlebrush Polymers Using Naphthyl Isocyanate

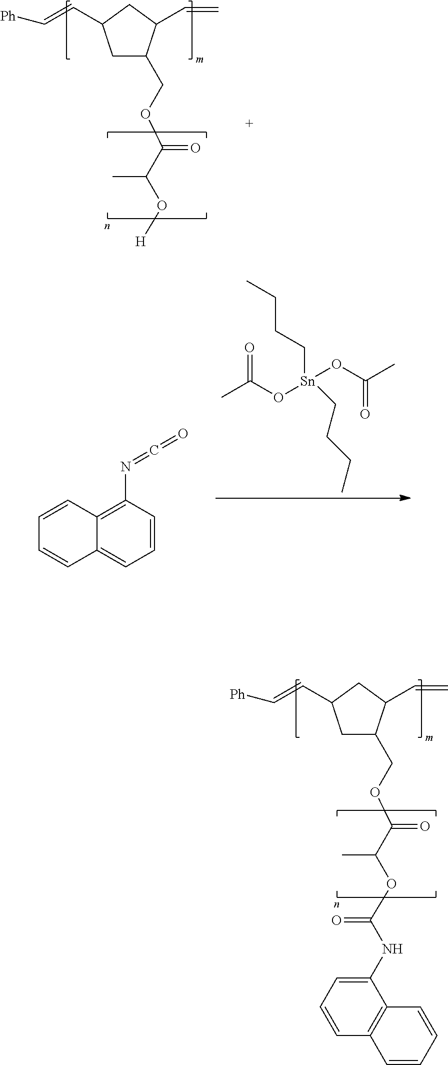

In an oven-dried 20 mL glass vial, NB-g-PLA (884 mg, 0.9 μmol) and naphthyl isocyanate (75.2 mg, 0.44 mmol) dissolved in 10 mL of THF. PS macromonomers (17.2 mg, 0.003 mmol; synthesized as mentioned previously in (I); M_{n, GPC}=6,000 g/mol and Ð=1.03) was utilized as an internal standard for the functionalization reaction. The reaction was initiated by adding TDBDA (8.1 mg, 0.023 mmol). This reaction was carried out for 3 h, with 100 μL of reaction volume taken as aliquots in excess THF (2 mL) at specific time points to monitor the reaction progress using GPC. The functionalization was followed by precipitation in methanol and drying under vacuum. Amount of polymer isolated=800 mg (82% yield). The isolated polymer was further analyzed by ¹H NMR to yield overall functionalization of the bottlebrush polymer to >95% functionalization.

M_{n,GPC}=285 kg mol; Ð=1.05

### Procedure for the Graft-Through ROMP for the Synthesis of PS-b-PLA Bottlebrush Polymers

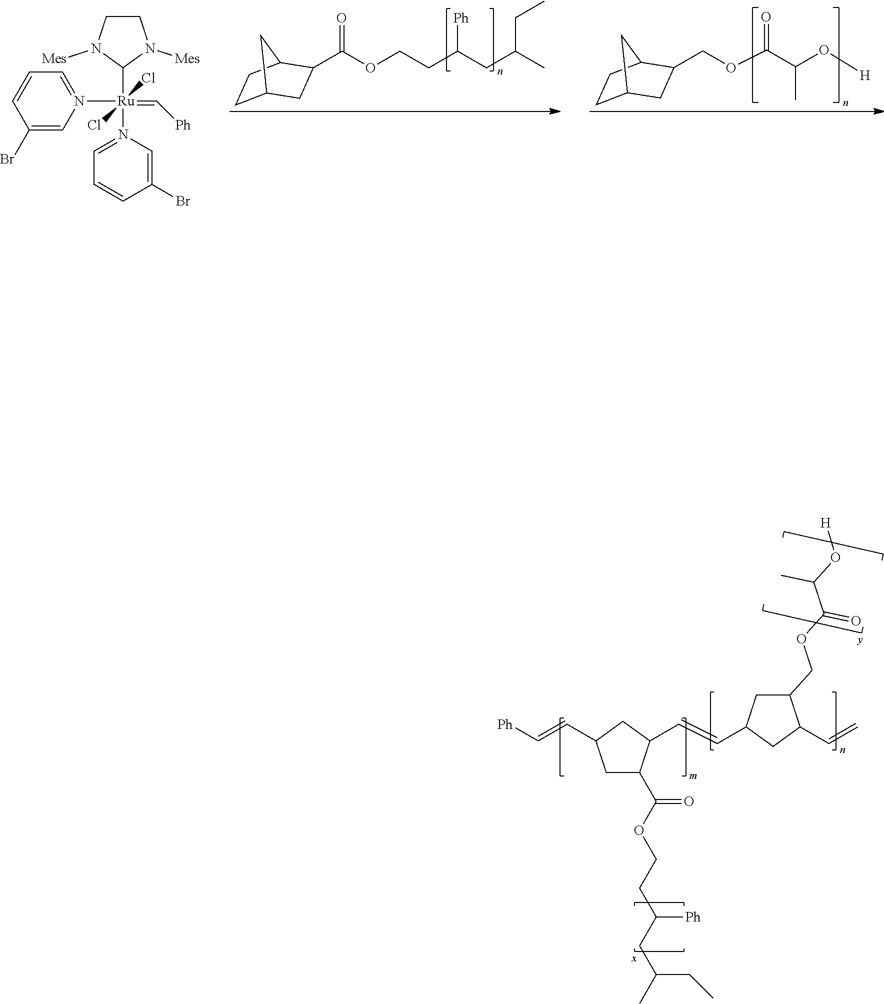

In an oven-dried 500 mL round bottom flask, PS macromonomer (7823 mg, 1.74 mmol) was dissolved into 46.9 mL THF. The polymerization is initiated by adding G3 via a stock solution (3.7 ml add of: 8 mg G3 in 4 ml THF stock solution; 7.4 mg, 0.0084 mmol resulting in a total backbone length 400). After 10 mins, an aliquot was taken and injected into 1 ml of THF with a large excess of ethyl vinyl ether for GPC analysis of the first block. Then, the crude PLA macromonomer from above was added and allow to react for 10 min before a large excess of vinyl ether was added. The polymer was obtained by precipitating into methanol and dried under vacuum. Amount of polymer isolated=13.8 g (96% yield)

M_{n,GPC}=522 kg/mol;Mn,_{theory}=1773 kg/mol; Ð=1.15

### Procedure for the Functionalization of PS-b-PLA Bottlebrush Polymers Using Allyl Isocyanate

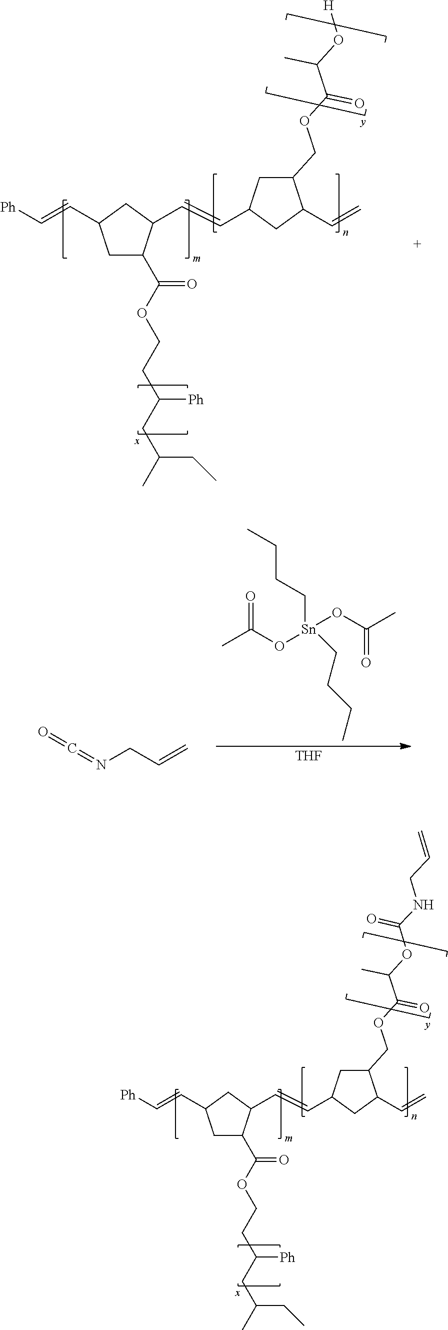

In a 250 mL round bottom flask, [NB-g-PS]-b-[NB-g-PLA](4 g, 0.0023 mmol) and allyl isocyanate (87.9 mg, 1.06 mmol) dissolved in 50 mL of THF. The reaction was initiated by adding TDBDA (8.1 mg, 0.023 mmol). This reaction was carried out for 3 hr, followed by precipitation in methanol and drying under vacuum. Amount of polymer isolated=3.9 g (96% yield). The isolated polymer was further analyzed by ¹H NMR to yield overall functionalization of the bottlebrush polymer to >75% functionalization.

M_{n,GPC}=522 kg/mol; Mn,_{theory}=1773 kg/mol; Ð=1.15

TABLE 1
Characterization data for PS-PLA diblock bottlebrush
(PS: 4.5 kg/mol; PLA: 3.7 kg/mol, 45 wt % PS).

| | | | | wt %^{c} | | | | Block |
|---|---|---|---|---|---|---|---|---|
| | Mₙ^{a} | | Macromonomer | Diblock | Triblock | Block | PS | length |
| N_{bb} | (kg/mol) | M_{w}/Mₙ^{a} | conversion^{b} | BB | BB | 1 | Brush | PS:PLA |
| 436 | 522 | 1.15 | ~97% | 84 | 7 | 8 | <1 | 200:236 |

^{a}Calculated with respect to PS standards;
^{b}Determined from GPC (includes both PS and PLA);
^{c}Based on deconvolution of UV-GPC trace as discussed in previous literature³

### Example 8. UV-Assisted DIW 3D Printing

### UV-Assisted DIW 3D Printing Ink Preparation

The crosslinkable photonic ink for UV-assisted DIW 3D printing was prepared by dissolving 250 mg of c-BBCP, 40 mg of crosslinker (Pentaerythritol tetrakis(3-mercaptopropionate), Sigma), and 20 mg of photo-initiator (2,2-Dimethoxy-2-phenylacetophenone, Sigma) into 1 mL of toluene (anhydrous, 99.8%, Sigma). The c-BBCP ink was capped with aluminum foil to block the light and stirred at room temperature for up to 24 hours. Afterward, it was allowed to rest for another 24 hours at room temperature without stirring to ensure full recovery. Fabricated ink was loaded into the disposable light block 3 mL amber syringe barrel (Nordson) and capped with a polyethylene piston to avoid evaporation loss during the printing process. The air was removed from the syringe by sealing the end and applying pressure to the piston back before installing the 27-gauge precision stainless steel tip (Nordson).

### UV-Assisted DIW 3D Printer and Printing Process

The UV-assisted DIW 3D printer (PCP3_UV) depicted in FIG. 2, and FIG. 16 constructed based on the modification of the previous PolyChemPrint3. First, the UV lamp (OmniCure S2000, Excelitas) and light guide were added to directly illuminate the nozzle tip. Second, the previous PCP3 software was modified to control multiple tools for simultaneous control. Specifically, the Omnicure UV lamp driver was connected with the main program, thus it can be operated by the main program with other functions (movement, and extrusion). The entire code for the software for PCP3_UV can be found on Github. The printing of c-BBCP ink was conducted onto the bare silicon wafer or a glass slide that had been cleaned by sonication for 5 min sequentially in toluene, acetone, and isopropanol. The printing z-height was set to 200 m, and the printing speed and applied pressure were fixed at 100 mm/min, and 100 kPa, respectively. To perform line printing, an approach was adopted using G-code for linear movement. For complex “chameleon”, and “starry night” patterns, motion paths were generated using the Gcodetools plugin for the free vector image software “Inkscape” to make G-code files for drawing. To carry out the structural color printing (simultaneous control of UV light and 3D printing), the UV operation commands were added to the file.

### Optical and Structural Characterization

The printed lines or patterns were taken by industrial cameras (PL-D725CU, pixelink) with an apochromatic zoom system (Z16 APO, Leica). All optical measurements were conducted under the diffusive ring lights, and at low magnification (1×). The specular reflection spectra were measured using an integrating sphere attachment for a UV-Vis spectroscopy (Varian Cary 5G) located at the Illinois Materials Research Laboratory (MRL). The sample was prepared onto the cleaned glass slide, and corners of prints were cut and delaminated to ensure getting reflection spectra from steady-state regions. The references were taken with respect to a Spectralon standard (100% reflection), and an empty glass slide (0% reflection). The structural properties of the sample were analyzed using cross-sectional scanning electron microscopy (SEM) with a Hitachi S4800 instrument at the Illinois MRL. The sample was prepared onto cleaned silicon substrates. To investigate the vertical direction of the sample, the prints on the silicon substrate were cut perpendicular to the printing direction by inducing controlled crack propagation (a diamond glass scriber was used to create the initial crack). Afterward, the sample was mounted onto a 90-degree angled SEM pin stub, and micrographs were captured using a low accelerating voltage (3-5 kV). The obtained images were subsequently processed using the ImageJ software package.

### Assembly Time Characterization

The estimation of assembly time was conducted by calculating the changes in hue and reflection intensity using a method that has been previously published. The color progression after printing was captured by using in-situ optical microscopy, and the obtained video was analyzed frame-by-frame using an image analysis technique in MATLAB and extracted the hue and intensity changes as a function of time. Related MATLAB code for the calculation can be found in the reference.

### Effective Crosslinking Density Characterization

The effective density of crosslinking was calculated using the Flory-Rehner equation,

$${X}_{c} = - \frac{ln ( 1 - {v}_{2} ) + {v}_{2} + χ {v}_{2}^{2}}{{V}_{1} ( {v}_{2}^{\frac{1}{3}} - \frac{{v}_{2}}{2} )}$$

Here, X_{c} is the effective crosslinking density, V₁ is the molar volume of the solvent at room temperature, X is Flory-Huggins polymer-solvent interaction parameter, and v₂ is the volume fraction of polymer in swollen sample. The v₂ can be calculated as

$${v}_{2} = \frac{{w}_{r}}{{ρ}_{r}} / ( \frac{{w}_{r}}{{ρ}_{r}} + \frac{{w}_{sol}}{{ρ}_{sol}} )$$

where wᵣ is a weight of unswollen polymer, wₛₒₗ is a weight of swollen polymer, ρᵣ is a density of polymer, and ρₛₒₗ is a density of solvent. The density of the BBCP (ρᵣ=1.13 g/cm³) was estimated based on the calculated volume fraction and the reported density of the bulk hompolymers (PS, and PLA,—Example 9). χ was estimated from the reported interaction parameter of PS-toluene (χ=0.44), noting that PS and PLA have similarly good solubility in toluene. The calculated effective crosslinking density of each film printed under the UV light having irradiance of 22, 66, 101, 188, and 411 μW/cm² are 7.25, 15.0, 22.7, 34.9, and 47.7 mol/cm³, respectively.

### UV Rheology Characterization

UV rheology characterization on the ink was performed using an Anton Paar Modular Compact Rheometer (MCR) 702 in a single-drive model, equipped with a UV curing device OmniCure S2000 accessory (365 nm wavelength). All experiments use a disposable parallel plate geometry with a diameter of 20 mm at a temperature of 5° C. to reduce solvent evaporation. An evaporation hood was used as well to minimize solvent evaporation. Photocrosslinkable c-BBCP formulations were cured by exposure to UV light for 15 s through a UV-transparent quartz-bottom plate at different light irradiance levels. Before UV curing, the material history related to loading was erased by a pre-shear protocol (\dot{γ}=25 l/s) and linear viscoelastic (LVE) spectra are determined by oscillatory shearing at a small strain amplitude (γ₀=0.08%), which was within the moduli-independent regime determined from strain amplitude sweeps. During UV curing, time sweep at a constant oscillatory frequency (ω=5.62 rad/s) and small strain amplitude (γ₀=0.08%) were applied to monitor the evolution of the dynamic moduli. After the completion of UV curing, as indicated by the plateau in the dynamic moduli, an oscillatory frequency sweep was performed to compare the differences between LVE spectra before and after the curing. All rheological properties were collected via Anton Paar's RheoCompass software.

### Safety Statement

No unexpected or unusually high safety hazards were encountered.

### Example 9. Volume Fraction Approximation for PS-b-PLA BBCP

The volume fraction of PS was estimated by substituting the molecular data

| Species | Mn(g/mol) | ρ (g/cm 3) | DP |
|---|---|---|---|
| PS | 4500 | 1.04 | 200 |
| PLA | 4200 | 1.25 | 200 |

into the following equation.

$${Φ}_{PS} = \frac{{M}_{n , PS} * \frac{{DP}_{PS}}{{ρ}_{PS}}}{{M}_{n , PS} * \frac{{DP}_{PS}}{{ρ}_{PS}} + {M}_{n , PLA} * \frac{{DP}_{PLA}}{{ρ}_{PLA}}} = 0.56$$

Here, the density of the polymacromonomer was approximately the same as reported value for the bulk amorphous arm species.

### Example 10. Discussion of Unreacted Photo Initiator

It was hypothesized that this phenomenon was more related to the light absorption of unreacted photo-initiator (DMPA) than the structural factors. To test this hypothesis, a comparative experiment was performed by comparing the reflection of normal crosslinkable ink containing c-BBCP and crosslinking reagents (PETMP and DMPA) and non-crosslinkable ink containing only c-BBCP (FIG. 19a, 19b). When the crosslinkable ink and non-crosslinkable ink were drop-casted under the same ambient light conditions, the crosslinkable ink shows relatively smaller reflection in the sub-400 nm region. Furthermore, when the crosslinking reagents are consumed under high UV light, the amount of reflection in the sub-400 nm region recovers and becomes similar to that of the non-crosslinkable ink, supporting the hypothesis that the presence of unreacted crosslinking reagent affects the sub-400 nm region reflection. Since the absorption below 400 nm is mainly contributed by the photo initiator (FIG. 19c), it can be concluded that the increase in reflection around 350 nm wavelength under high UV light is likely due to the consumption of the photo initiator, which acts as an absorber in the sub-400 nm region.

In FIG. 3C, increasing tendency in the reflection around 350 nm wavelength was observed as the UV irradiance increased, contributing to the blue color expression. See FIG. 19, which shows results of analysis of crosslinking agent contributions in optical properties.

### Example 11. Supplementary Coarse-Grained Molecular Simulation

### Scaling Argument for Semidilute ISC Model

In previous work, the conformation of a bottlebrush polymer can be described as a wormlike cylinder model with contour length L, Kuhn length λ⁻¹, diameter d, and excluded volume parameter B was demonstrated. This wormlike cylinder model was then discretized so that it is represented by a set of L/d beads with diameter d. The side chains are no longer treated explicitly in this implicit side-chain (ISC) model. The ISC model was used to described the self-assembled structure of bottlebrush block copolymers, using an interaction potential derived from theory and consistent with explicit side-chain simulations. The theoretical interaction potentials are derived using a scaling argument under dilute conditions; however, the underlying assumptions are expected to be affected in semidilute concentrations (i.e. where the bottlebrush polymers begin to overlap). In this study, an improved ISC model that can describe concentration-dependent behavior of semidilute solutions was used.

Bottlebrush polymers have several characteristic concentrations distinguished by the overlap length scales due to their unique hierarchical architecture. The major overlap concentration this study is concerned with is associated with the overlap of side chains, c*, and occurs when the properties of the bottlebrush polymer that are governed by the side-chains become dependent on its neighbors. Here, the bottlebrush polymer can be described as wormlike cylinder and the pervaded volume for a single polymer is the cylindrical volume, which is

$${c}^{*} ∼ \frac{{pm}_{s c} {N}_{s c}}{{R}_{0}^{2} h} \qquad ( 1 )$$

Where m_{sc} is the molecular weight of a monomer in a side chain, N_{SC} is the number of monomers in a side chain, p is the number of grafted side chains, R₀ is the cylinder radius of bottlebrush polymer at overlap concentration and h is the length of the cylindrical bottlebrush polymer. Above c*, the bottlebrush polymers are now in a situation where the repulsive excluded volume interactions between side-chains are screened as the side chains of neighboring bottlebrushes interpenetrate. This leads to increased flexibility with decreased effective persistence length and plays an important role in the concentration-dependent structure. A scaling argument was devised to obtain concentration-dependent conformational parameters that can be used in the current ISC model.

The scaling argument for bottlebrush polymers in dilute solution is based on the classical Daoud-Cotton model and is schematically illustrated in FIG. 20a. Side chains of bottlebrush polymer are accounted for with space-filling thermal blobs of size ξ extending radially from the backbone, with the length scale ξ(r) increasing with r to reflect the cylindrical geometry. By equating the cylindrical surface area along the backbone, A˜πhr, and the area of all thermal blobs in the side chains, pξ²˜hr, the size of the thermal blobs has an expression of ξ(r)˜l_{G}^{1/2}r^{1/2}, where l_{G} is the average distance between grafted side chains l_{G}=h/p. In good solvent conditions, side chains exhibit a self-avoiding random walk within the length scale ξ(r), thus ξ(r)˜g^{v}b, and v is the Flory exponent of ⅗ for good solvent, g(r) is the number of monomers in a thermal blob and b is the monomer size. Therefore, the corresponding number density of monomers is ρ(r)˜g(r)/ξ³(r)˜ξ⁻4/3(r)b^{-5/3}˜l_{G}^{-2/3}b^{-5/3}r^{-2/3}. This approach is useful for dilute solutions, but when the concentration increases, the overlap of side chains needs to be considered. Side chains from neighboring bottlebrush polymers will interpenetrate until a certain radial distance r_{c} from the backbone as FIG. 20b. The side chains within the distance r_{c} follow the behavior of the dilute solution, and the size of the thermal blobs and local density are ξ_{c}(r)˜l_{G}^{1/2}r^{1/2} and ρ_{c}(r)˜l_{G}^{-2/3}b^{-5/3}r^{-2/3} for r<r_{c}. For r>r_{c}, side chain overlap are modeled as a solution of linear chains with the thermal blob size ξₛ=ξ(r_{c})˜l_{G}^{1/2}r_{c}^{1/2} that is the same as the blob size as ξ_{c}(r_{c}). This ‘overlapped shell’ at the radial distance r_{c}<r<R, where R<R₀ is the effective radius of the space-filling region around the backbone, has a local density that is ρₛ=ρ(r_{c})˜l_{G}^{-2/3}b^{-5/3}r_{c}^{-2/3}. Note that r_{c} and R are functions of concentration, thus the local length scales and densities are also dependent on concentration. In order to determine the distances r and R, the average number density of the solution (ρ) can be described as

$$〈 ρ 〉 = \frac{〈 {ρ}_{c} 〉 {V}_{c} + {ρ}_{s} ( V - {V}_{c} )}{V} \qquad ( 2 )$$

where [symbol] ρ_{c} [symbol] is the average density of the dilute core, which is

$$〈 {ρ}_{c} 〉 ∼ \frac{{\int }_{0}^{{r}_{c}} r ρ ( r ) dr}{{\int }_{0}^{{r}_{c}} rdr} ∼ \frac{3}{2} {l}_{G}^{- 2 / 3} {b}^{- 5 / 3} {r}_{c}^{- 2 / 3} \qquad ( 3 )$$

V_{c} is the volume of the core region, which is ˜r_{c}²l_{G} and V is the total volume of the cylinder which is ˜R²l_{G}. Then Eq 4 is

$$〈 ρ 〉 ∼ {l}_{G}^{- 2 / 3} {b}^{- 5 / 3} {R}^{- 2 / 3} {f}^{- 2 / 3} \{ 1 + \frac{1}{2} {f}^{2} \} \qquad ( 4 )$$

by defining f=R/r_{c}. When f=1, the solution is at overlap concentration c* with the overlap number density [symbol] ρ [symbol] *. This overlap number density can be written as

$${〈 ρ 〉}^{*} ∼ \frac{3}{2} {l}_{G}^{- 2 / 3} {b}^{- 5 / 3} {R}_{0}^{- 2 / 3} \qquad ( 5 )$$

[symbol]

ρ [symbol] * has the same scaling relation with [symbol] ρ_{c} [symbol] because both are in dilute condition. Normalizing Eq 6 by its overlap number density yields a final equation for concentration-dependent distances:

$$\frac{〈 ρ 〉}{{〈 ρ 〉}^{*}} = {\{ \frac{2}{3} {f}^{- 2 / 3} ( 1 + \frac{1}{2} {f}^{2} ) \}}^{3 / 2} \qquad ( 6 )$$

Here, (R/R₀)⁻²˜ [symbol] ρ [symbol] / [symbol] ρ [symbol] * assumes that the effective cylindrical bottlebrushes are space-filling. Eq (6) is plotted in FIG. 20c by converting [symbol] ρ [symbol] / [symbol] ρ [symbol] * to concentration ratio c/c* for better comparison with experiment. The size of the dilute core r_{c} rapidly decreases by concentration. While the effective radius of a single bottlebrush polymer R also decreases, note that the actual radius of a single bottlebrush is related to N_{SC}, and does not change much by concentration as observed in previous studies. The decrease in the radius fraction f=r_{c}/R is the dominant trend of r_{c}, such that the dilute core essentially disappears by even modest concentrations c/c*˜2 or 3. This allows us to characterize the concentration-dependent dimension r_{c} within the dilute core of a single bottlebrush polymer, which determines the effective persistent length.

The concentration-dependent dilute core radius r_{c} was fit to the relation between Kuhn length λ⁻¹ and cylinder diameter determined by Dutta et al., to obtain the concentration-dependent effective persistent length lₚ plotted in FIG. 20d. As the dilute core rapidly decreases by concentration, the effective persistent length also decreases rapidly by concentration and converges to ˜0 which means that the chain becomes highly flexible. Notably, the trend of effective persistent length based on the scaling argument is in a good agreement with the DPD simulation results of Kang et al.

### Simulation Details

The ISC model is adopted for BBCP self-assembly with concentration-dependent parameters based on the scaling arguments. The same structure of PS-b-PLA BBCPs was adopted in the experiment where the linear diblock copolymer chain consisted of Nₐ A-beads (PS block) and N_{b} B-beads (PLA block). Details of developing ISC model were described in earlier works. MD simulations were performed with the LAMMPS package, with all simulations using the canonical (NVT) ensemble and a Langevin thermostat with implicit solvent. Particle motions are governed by a total potential U given by:

$$\tilde{U} = {\tilde{U}}_{b} + {\tilde{U}}_{θ} + {\tilde{U}}_{P M F} \qquad ( 1 )$$

This includes contributions due to a bonding potential Ũ_{b}, a bending potential Ũ_{θ}, and a pairwise potential of mean force Ũ_{PMF}. All the parameters for potential energies are normalized by k_{B} T, length scales are normalized by the bead size d, and time scales are normalized by (ε₀/mσ²)^{1/2} where each parameter for time unit will be described in the following part. These dimensionless values are denoted with a tilde in the notation. The bonding potential connects two beads with Hookean springs:

$${\tilde{U}}_{b} = \frac{{\tilde{κ}}_{s}}{2} {\sum }_{i , j} {( {\tilde{r}}_{i j} - 1 )}^{2} \qquad ( 2 )$$

Here \tilde{κ}ₛ=200 was set to constrain the bond between the beads i and j, \tilde{r}ᵢⱼ, to the distance which is the sum of the radius of beads i and j. The bending potential affects the angle between three connected beads:

$${\tilde{U}}_{θ} = \frac{{\tilde{κ}}_{θ}}{2} {\sum }_{i , j , k} ( 1 - cos {θ}_{i j k} ) \qquad ( 3 )$$

This potential accounts for the stiffness of bottlebrush polymer, with a bending constant \tilde{κ}_{θ}=(2λd)⁻¹ that sets the Kuhn length λ⁻¹ of the bottlebrush polymer. θᵢⱼₖ represents the angle among the three connected beads i, j and k, which is θᵢⱼₖ=cos⁻¹(\tilde{r}ᵢⱼ·\tilde{r}ⱼₖ). The potential of mean force for pairwise interaction is taken from prior work, using a form that is developed by scaling theory. This potential is the sum of all pairwise interactions between two beads i and j on different chains k′ and l′:

$${\tilde{U}}_{P M F} = {\sum }_{i , j} {\sum }_{{k}^{′} \neq {l}^{′}} {\tilde{u}}_{PMF} ( {\tilde{r}}_{i j , {k}^{′} {l}^{′}} ) \qquad ( 4 )$$

$${\tilde{u}}_{P M F} ( {\tilde{r}}_{i j , {k}^{′} {l}^{′}} ) = \{ \begin{matrix}{\tilde{ε}}_{α , β} [ {( {\tilde{r}}_{i j , {k}^{′} {l}^{′}} )}^{m} − 1 ] , & if {\tilde{r}}_{i j , {k}^{′} {l}^{′}} < 1 \\ 0 , & if {\tilde{r}}_{i j , {k}^{′} {l}^{′}} > 1\end{matrix} \qquad ( 5 )$$

where α and β indicate the types of beads. (AA, BB, and AB). The exponent is

$$m = \frac{13 ln 2}{8 ln ( b / d )}$$

and the constant \tilde{ε}_{α,β} reflects the magnitude of repulsion. \tilde{ε}_{α,β} includes the information of N_{SC} and grafting density with scaling exponents based on scaling theory. In prior work, the constants \tilde{ε}=\tilde{ε}_{A,A}=\tilde{ε}_{B,B} and γ=\tilde{ε}₀/\tilde{ε}_{A,B} are set to 0.5 and 0.6 for BBCPs solution by systemically and empirically mapping the parameters to be consistent with experiments. The same values were adopted for this model as well.

The simulation model at c=c* was built with the same model parameters of prior work. (Table 2) DP_{bb} and DP_{sc} represent the degree of polymerization of backbone and sidechain in experiments, N_{bb} and N_{sc} represent the coarse-grained repeating units in explicit side chain model. da is the diameter of ISC coarse-grained beads in the unit of monomer size is b=0.67 nm and unit length σ=8.08 nm. L is the contour length of the block and N_{α} is the repeating unit of ISC beads for each block. m is the exponent of pair interaction potential and \tilde{ε}_{θ} is the bending potential constant.

TABLE 2
Simulation model detail at c = c*

| | α | DP_{bb} | DP_{sc} | N_{bb} | N_{sc} | d_{α}/b | d_{α}/σ | L/b | N_{α} | m | \tilde{κ}_{θ} |
|---|---|---|---|---|---|---|---|---|---|---|---|
| PS | A | 200 | 45 | 182.82 | 22 | 24.06 | 2.0 | 206.59 | 8 | −0.36 | 3.84 |
| PLA | B | 200 | 60 | 182.82 | 29 | 28.63 | 2.38 | 206.59 | 7 | −0.34 | 4.27 |

When the concentration c>c*, this model was modified based on the scaling arguments. To fit the arguments to current ISC model as simply as possible, the model was modified in a few important ways. First, when the concentration increases above c>c*, the bead diameter does not change. While the effective cylinder diameter and dilute core diameter decrease by concentration, Ũ_{PMF} reflects the overlap within the fixed bead diameter. First the Ũ_{PMF} and bead diameter was kept the same to avoid additional modification of parameters and complexity of the model. The effective contour length also changes when c>c*. To include the effect of non-overlap dilute core region on the structure, the relationship derived by Dutta et al. between contour length disparity m_{L}=L(N_{bb}−1) and cylinder diameter d was used. This diameter-dependent effective contour length with regards to the diameter of the dilute core by interpolation was adopted. The number of backbone beads N_{bb} was changed for each block based on the effective contour length, while the block ratio was kept the same. Modifying contour length, however, cause the unexpected increased repulsion between chains due to added beads, thus \tilde{ε}₀=\tilde{ε}_{A,A}=\tilde{ε}_{B,B} is reduced with regards to the modified contour length with the scale of \tilde{ε}₀˜1/L˜1/(N_{A}+N_{B}). Finally, the bending constant \tilde{κ}_{θ}=(2λd)⁻¹ is modified by concentration dependent persistent length in FIG. 20d. The final simulation model is set based on the default setting at c=c* and modified by increasing concentration to c/c*=4, with an interval of 0.25.

50σ×50σ×50σ size boxes was used for all concentration ranges. The overlap concentration c* is estimated ˜55 mg mL⁻¹ by Eq 1:

$${c}^{*} ∼ \frac{{pm}_{s c} {N}_{s c}}{{R}_{0}^{2} h}$$

and the number of chains was able to be determined by converting simulation length to real units. In prior works, equilibrium structures were obtained at a reduced temperature T*=k_{B}T/\tilde{ε}=1.0 after at least 8×10⁶ time steps, which is justified as sufficient time steps for equilibrium by the evolution of the degree of mixing. Each time step corresponds to Δ\tilde{t}=0.005. The data is collected for additional 1×10⁶ time steps.

### Simulation Analysis

Morphological features of BBCPs self-assembly by concentration are characterized and compared with the experiment by calculating structure factor S(q). The formula is given herein:

$$S ( q ) = \frac{1}{N} 〈 {\sum }_{j = 1}^{n} {\sum }_{i = 1}^{{N}_{A}} exp ( - i q \cdot {r}_{i , j} ) {\sum }_{j = 1}^{n} {\sum }_{i = 1}^{{N}_{A}} exp ( - i q \cdot {r}_{i , j} ) 〉 = \frac{1}{N} 〈 {\vert {\sum }_{j = 1}^{n} {\sum }_{i = 1}^{{N}_{A}} cos ( q \cdot {r}_{i , j} ) \vert}^{2} + {\vert {\sum }_{j = 1}^{n} {\sum }_{i = 1}^{{N}_{A}} sin ( q \cdot {r}_{i , j} ) \vert}^{2} 〉 \qquad ( 12 )$$

Here, r_{i,j} represents the coordinates of monomer i on chain j in real space. S(q) was calculated for only A blocks assuming complete contrast between the two species. S(q) was averaged over similar q-vectors to get smooth plots and used magnitude |q|=q for plotting. q-vectors are chosen as integer multiplies of 2π/L_{box} on all three dimensions to account for periodic boundary conditions.

### Example 12. Supplementary Rheology Characterization

### Winter-Chambon Discussion

Three other frequencies, ω=3.16, 10, 31.6 rad/s, were applied under each irradiance level to validate the applicability of the Winter-Chambon criterion, in which the gel point is determined by plotting the tangent of the phase angle, tan δ=G″/G′, as a function of time at different angular frequencies. Due to non-uniform chemical crosslinking (i.e., only in the PLA domain), c-BBCP does not have a self-similar structure at the gel point. It is therefore expected that this system will not follow the Winter-Chambon criterion that is based in a self-similar structure across a range of length scales. The non-uniformity of the structure results in no crossover between tan S at different angular frequencies (FIG. 21), and the Winter-Chambon criterion is not applicable. The mutation number, Mu, is defined as, Mu=Δt/λₘᵤ, in which Δt=2π/ω, and mutation time

$${λ}_{mu} = 1 / {( 1 / {G}^{′} \cdot \frac{\partial {G}^{′}}{\partial t} )}^{- 1} .$$

The mutation number is found to be 0.073, which is well within the proposed range of acceptability of Mu<0.1 for reliable measurements. See FIGS. 21 and 22.

### Example 13. Negative Control Experiment

Various negative control experiments were carried out. The results are illustrated in FIGS. 23 and 24. It was found that structural color could not be tuned by the high irradiance range (>411 μW/cm²) because of the fast crosslinking rate (FIG. 23). It was also found that crosslinking is key for structural color control (see FIG. 24).

### Example 14. CIE1931 Color Mapping of Produced Structural Color

The points of each printed ink were mapped in the Commission International de I'Eclairage (CIE) 1931 color diagram. Based on the CIE's XYZ coordinate space and the reflectance of the samples, the sample colors could be predicted. The chromaticity is specified by the tristimulus values X, Y, and Z, derived using:

X=∫M(λ)x̅(λ)dλ,

Y=∫M(λ)y̅(λ)dλ,

Z=∫M(λ)z̅(λ)dλ,

where ∫M(λ) is the reflectance of an object, and x̅(λ), y̅(λ), and z̅(λ) are the functions of the color, which are the numerical descriptions of the observer chromatic response. The CIE 1931 standard observer function and the measured reflectance of each sample were used. In the CIE color coordinate space, the chromaticity of a color was pointed by the two derived parameters, x, y and z, which are calculated as:

$$x = \frac{X}{X + Y + Z} , y = \frac{Y}{X + Y + Z} , z = \frac{Z}{X + Y + Z} .$$

The calculation and plotting were conducted by using the Origin Pro 2022.

The CIE x-y coordinates of each sample are as following: 0 μW/cm² (0.3783, 0.3945), 22 μW/cm² (0.2986, 0.3720), 62 μW/cm² (0.2526, 0.3016), 101 μW/cm² (0.2385, 0.2745), 188 μW/cm² (0.2377, 0.2658), and 411 μW/cm² (0.2012, 0.1974). As the irradiance increases, the position indicating the color in the diagram gradually moves from orange to green, then to blue, proving that it can provide vivid and wide range of colors that are well suited for a wide variety of applications. See FIG. 25 which shows CIE 1931 color mapping of produced structural color using c-BBCP ink under different UV crosslinking rate.

### Example 15. The Influence of Solvent Selectivity on the Optical Properties of BBCP

In this study, a novel method for creating diverse phases of PS-b-PLA BBCP, resulting in a range of structural colors is presented. This approach leverages the distinct solubility of the two blocks (PLA and PS) in selective solvents like toluene, xylenes, and mesitylene. Initially, the fabrication of a broad color palette achieved by modulating both the solvent and polymer length was showcased. Subsequently, a detailed quantitative analysis of the optical properties using UV-Vis reflection spectra was conducted. Experimental evidence, including scanning electron microscopy (SEM), photo-induced force microscopy (PiFM), and film small angle x-ray scattering (SAXS) analyses, clarified that increased solvent selectivity transitioned the phases from lamellar to cylindrical and spherical phases due to variations in volume fraction, and explained the optical properties variation based on scattering theories. Furthermore, the study unveiled the assembly pathway of BBCP, and underlying mechanism of distinct assembly pathways influenced by solvent selectivity, demonstrated by examining the BBCP conformation in solution states using solution SAXS, dynamic light scattering (DLS), and cryo-transmission electron microscopy (TEM).

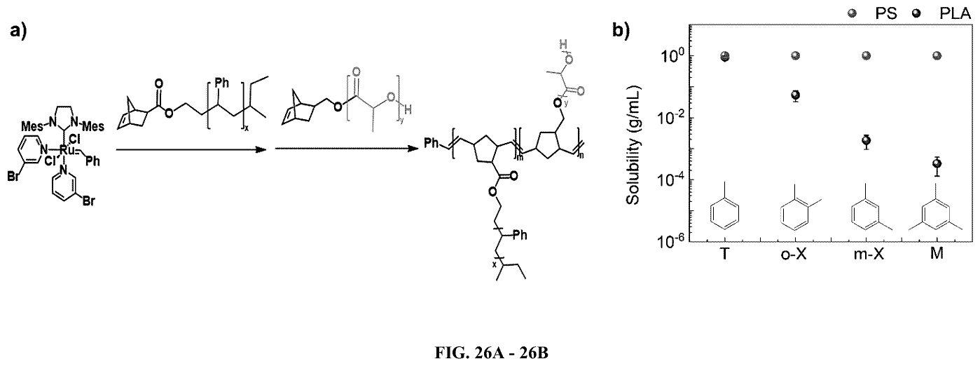

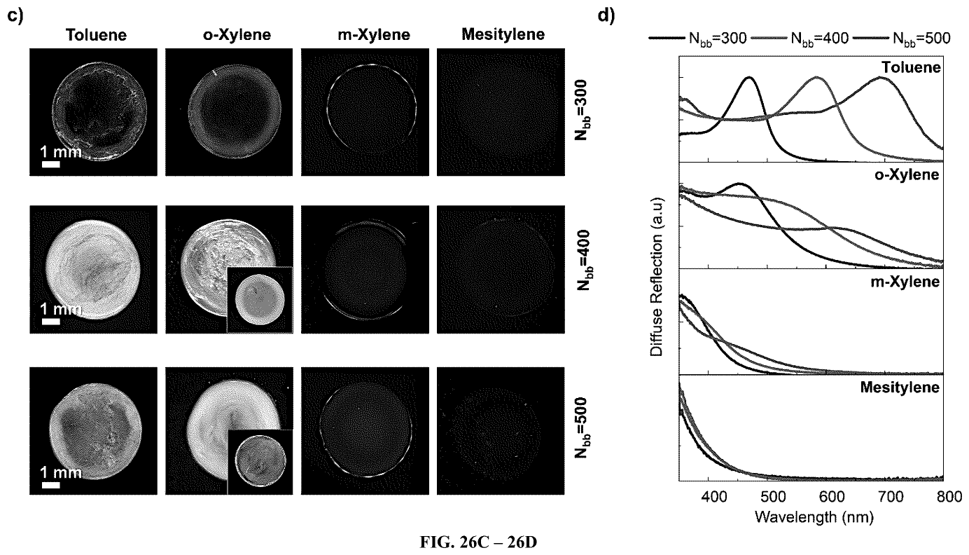

In this section, the impact of selective solvents, each possessing distinct solubility for the two blocks (PS and PLA), on the optical properties of the PS-b-PLA BBCP film is explored. A series of PS-b-PLA BBCP (N_{bb}=300, 400, and 500) were synthesized by sequential graft-through polymerization of macromonomers as shown in FIG. 26A. PS-b-PLA BBCPs with varying backbone lengths were targeted as described in Table 3.

TABLE 3
Characterization of the various PS-b-PLA synthesized.

| N_{bb, PS}:N_{bb, PLA}^{a} | Mₙ^{b} (kg/mol) | M_{w}/Mₙ^{b} |
|---|---|---|
| 150:150 | 385 | 1.2 |
| 200:200 | 513 | 1.2 |
| 250:250 | 635 | 1.2 |

^{a}Targeted backbone degree of polymerization.
^{b}Calculated with respect to PS standards.

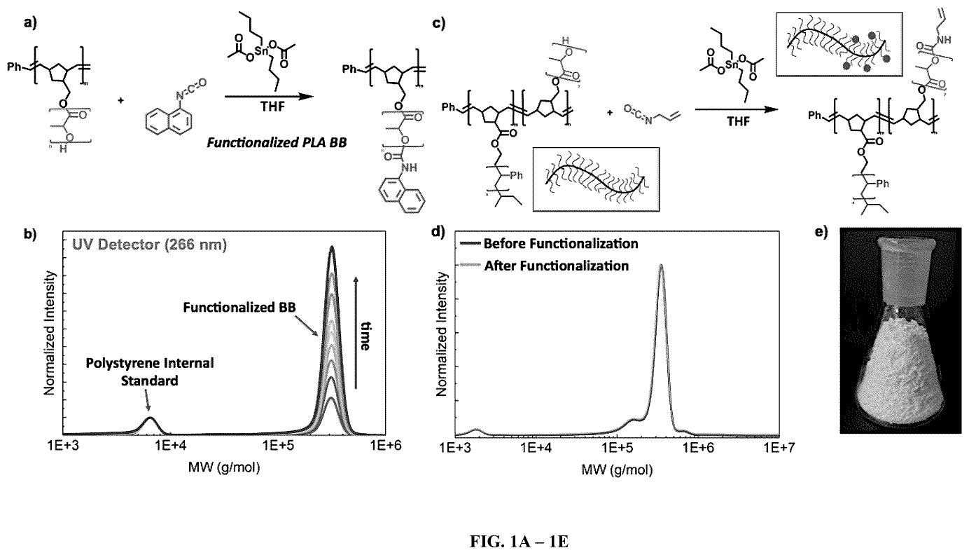

Four solvents (toluene, o-xylene, m-xylene, and mesitylene) were carefully selected based on their varying solubility with respect to PS and PLA blocks. Gravimetric solubility measurements using PS (N_{bb}=²00, N_{sc}=45), and PLA (N_{bb}=²00, N_{sc}=60) homobrush polymers revealed that all four solvents exhibited good solubility (>1 g/mL) for PS, while these solvents exhibited markedly different solubility levels for PLA (FIG. 1b). Specifically, the solubility of PLA dramatically decreased with an increase in the number of methyl groups in the benzene ring and variations in their positions (toluene: 0.91±0.09, o-xylene: 0.054±0.021, m-xylene: 1.85×10⁻³±9.1×10⁻⁴, M: 3.3×10⁻⁴±2.0×10⁻⁴ g/mL).

In order to investigate the effect of selective solvent on optical properties of fabricated photonic crystal, PS-b-PLA BBCP film samples (N_{bb}=300, 400, and 500) were prepared with four different selective solvents and captured the optical images in the normal direction using optical microscopy equipped with diffuse O-Ring light (FIG. 26C). For example, in a non-selective solvent like toluene, the photonic crystal displayed structural colors ranging from red (N_{bb}=500) to blue (N_{bb}=300), correlating with the length of the BBCP as expected. It is well established that higher numbers of backbones lead to a red-shift in color due to larger domain sizes. A particularly intriguing observation pertains to the solvents themselves. Regardless of the BBCP length, higher solvent selectivity consistently resulted in a shift towards bluer hues. For instance, with N_{bb}=400, a non-selective toluene solution produced a green-yellow colored photonic crystal, while a slightly more selective o-xylene solution yielded a photonic crystal with green-blue hues. Highly selective solvents such as m-xylene and mesitylene produced even bluer and faint-blue colors, respectively.

To quantitatively assess the diverse structural colors, diffuse reflection spectra were analyzed using UV-Vis spectroscopy and an integrating sphere (FIG. 26D). In the same solvents, the reflection spectra displayed a red-shift as the backbone length increased as expected. Intriguingly, this shift didn't alter the reflection configuration across diverse backbone lengths, suggesting that the phase did not alter as the backbone length increased. However, employing different solvents led to significant variations in the reflection spectra configurations. In reflection spectra of toluene-based film, predominant reflection peaks were discerned in the higher wavelength range (470, 585, and 693 nm, respectively, for N_{bb}=300, 400, and 500), accompanied by a plateau of reflection in the lower wavelength range. In o-xylene, peaks were observed at 456 nm, 529 nm, and 633 nm for N_{bb}=300, 400, and 500, respectively, with the reflection intensifying as the wavelength decreased. m-xylene displayed a comparable pattern to o-xylene, albeit with reflection peaks shifting towards the blue region (460, 395, and 361 nm, respectively, for N_{bb}=300, 400, and 500). Lastly, in mesitylene, the peaks were further blue shifted, with no discernible peaks in the visible range (350-800 nm). Generally, the length of BBCP affects the peak wavelength of the reflection spectra but does not alter the configuration of the spectra. In contrast, solvents influence both the configuration and the peaks of the spectra. This optical behavior, influenced by solvent selectivity, arises from distinct light scattering events dependent on their distinct nanostructures.

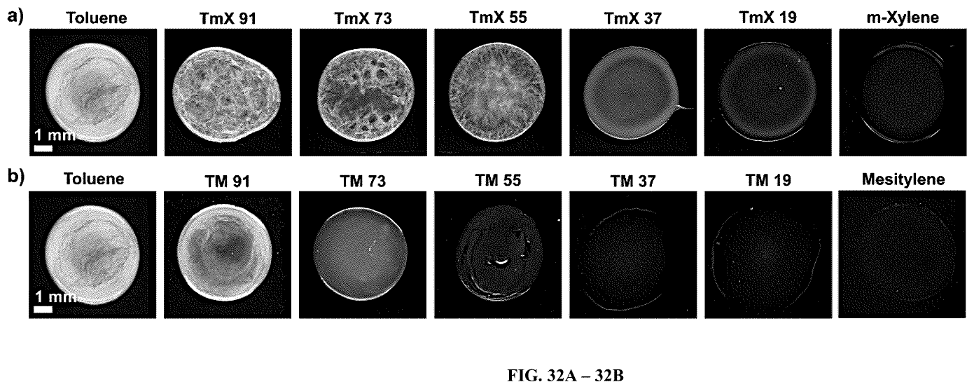

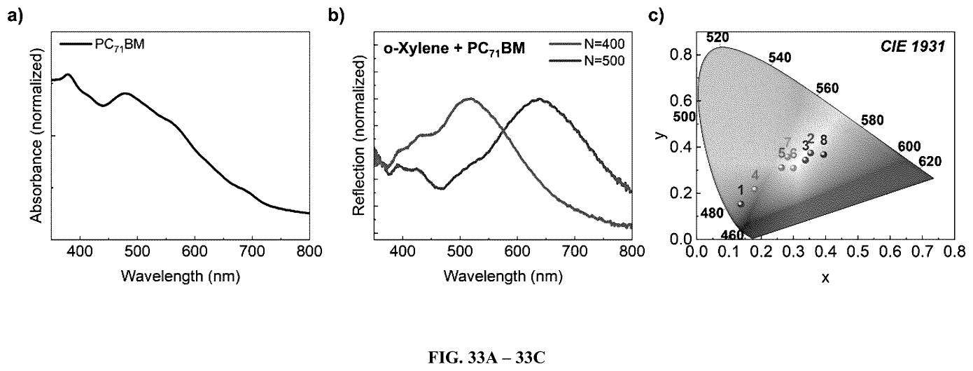

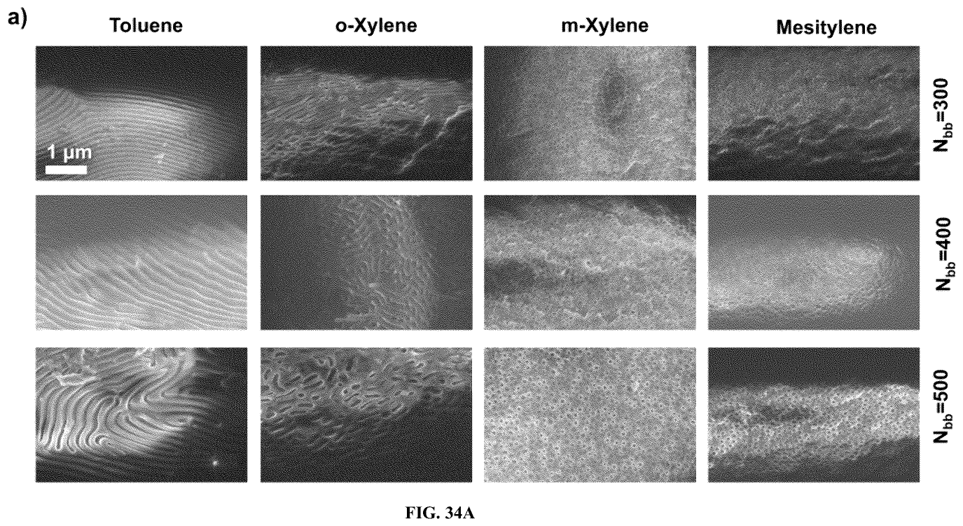

Expanding on this discovery, further modifications in structural color can be achieved by blending solvents (FIG. 32). For instance, blending toluene with m-xylene or mesitylene resulted in intermediate hues, demonstrating a gradual shift in the optical properties of the film from those of toluene-based films towards those of m-xylene or mesitylene films. Also, it was demonstrated that the color palette can be further broadened, and color purity can be enhanced by mitigating broadband reflection in samples exhibiting high reflectance in the low-energy regime. For example, o-xylene exhibits peak positions in the RGB scale (456-633 nm) but shows an indistinct color due to strong overall blue reflection. It was shown that this strong blue reflection can be mitigated by incorporating a broadband absorber (FIG. 33A), resulting in clear red and green colors (FIG. 26C insets, FIG. 33B). The structural colors obtained were quantified in the CIExy color space (FIG. 33C).

### Example 16. The Influence of Solvent Selectivity on the Structural Properties of BBCP

The following is discussed in this section, the structural properties of BBCP films (N_{bb}=400) exhibiting varied optical characteristics based on the solvent utilized, aiming to unravel the underlying reasons for the diverse optical properties. Initially, the nanostructure of BBCP films created through various solvents using cross-sectional SEM was investigated. The study continues to proceed to compositional properties analysis of these nanostructure domains by employing PiFM and compare the structural traits with the optical properties of each photonic crystal by using scattering theories.

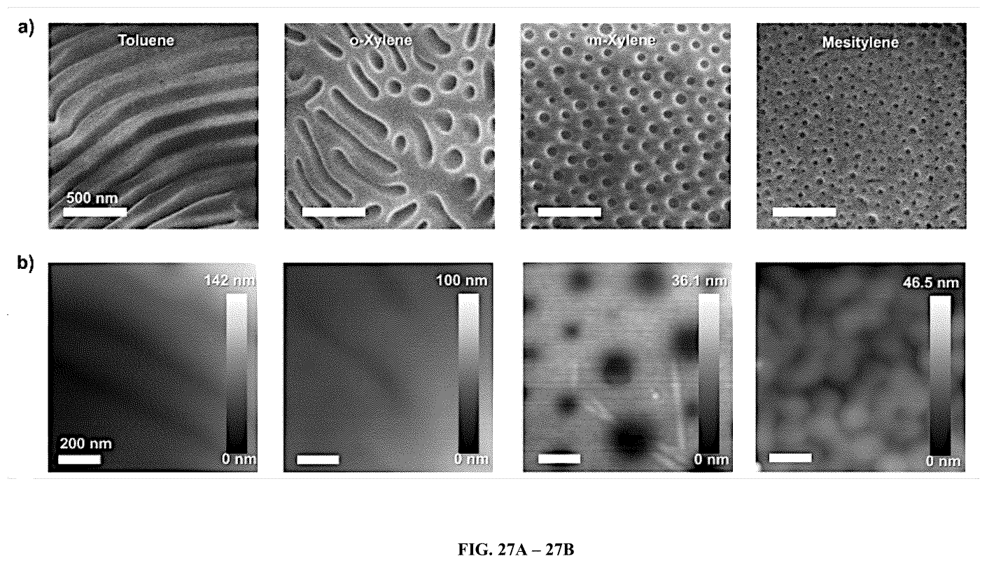

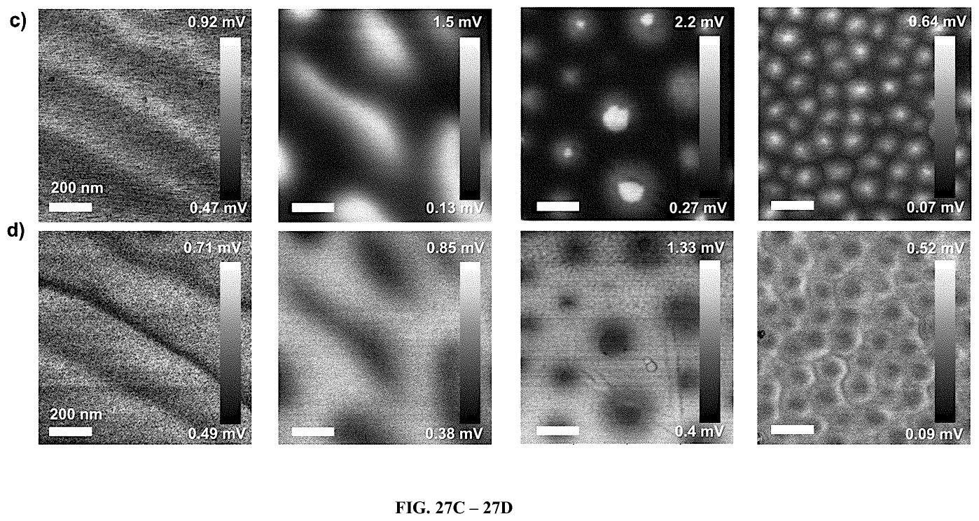

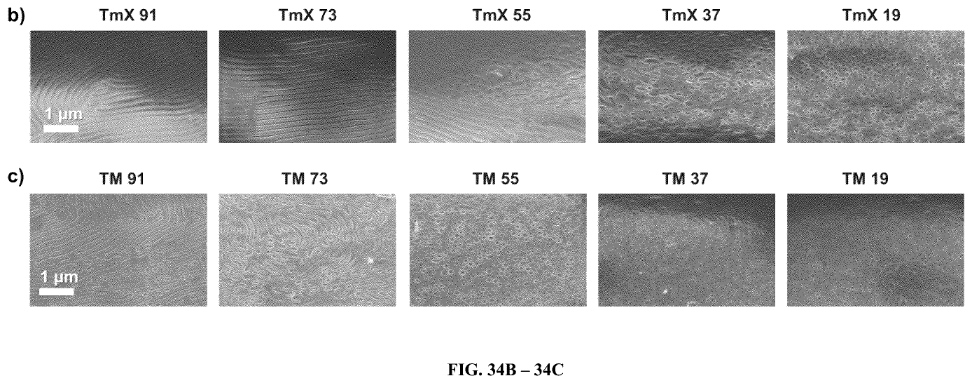

In the series of cross-sectional SEM images, noticeably, different microstructures were revealed depending on the solvent used (FIG. 27A). Toluene showed well-defined lamellar structures with a d-spacing of 187.8±10.7 nm, while o-xylene exhibited short-cylinder formation, with an approximate distance of nearest neighbor (d_{NN}) of 172.6±22.9 nm. The m-xylene and mesitylene both displayed spherical structures with sphere radius of 52.4±8.7, and 30.5±7.1 nm, and d_{NN} of 165.0±10.2, and 128.0±9.5 nm. The morphological differences depending on the solvent persist regardless of the length of the polymer backbone (N_{bb}=300, and 500), as indicated by the morphologies observed in SEM images (FIG. 34A). Furthermore, samples prepared with solvent mixtures (toluene and m-xylene, toluene and mesitylene) displayed a gradual transition from lamellar to spherical structures depending on the ratio, supporting the effects of solvents on structural properties (FIG. 34B).

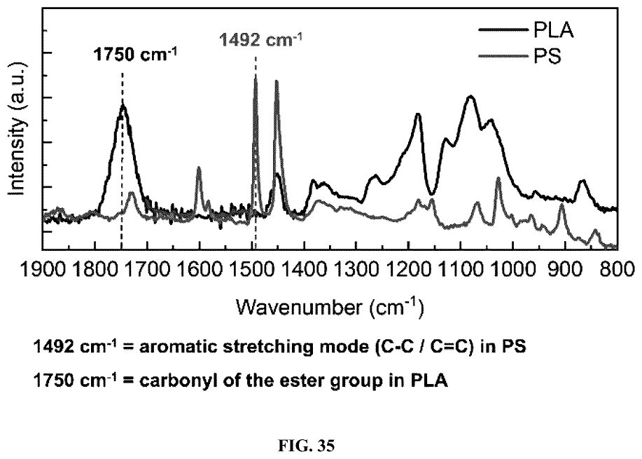

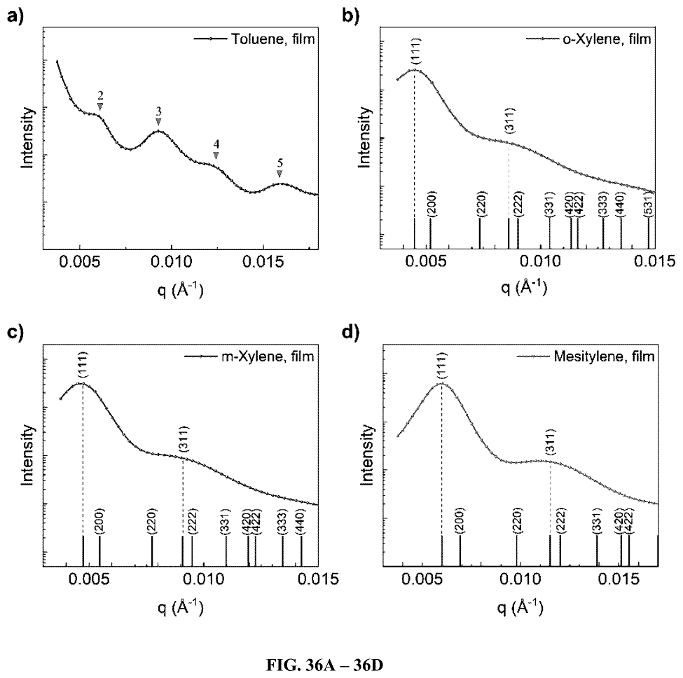

A detailed analysis was conducted of the film composition utilizing PiFM to discern the composition of the domains. Topology (FIG. 27B) and PiFM images of PS (FIG. 27C) and PLA (FIG. 27D) were acquired at 1 line/s over a 1×1 μm area with 256×256 pixels. Distinct signals from each domain (PS and PLA) were obtained by tuning the excitation laser to specific absorption bands (mutually exclusive infrared signals) at 1492 cm⁻¹ (aromatic stretching mode) for PS and 1750 cm⁻¹ for PLA (carbonyl of the ester group), as identified through Fourier-transform infrared spectroscopy (FIG. 35). PiFM signal selectively imaged the distinct PS and PLA domains, aligning with the microstructures observed in SEM analysis (lamellar for toluene, short cylindrical for o-xylene, large spherical for m-xylene, small spherical for mesitylene). Furthermore, it was observed that cylinders and spheres exhibited strong PLA signals in xylenes and mesitylene, whereas the remaining regions showed strong PS peaks. This clearly indicates a distinct phase separation phenomenon, where the PLA brushes are aggregated to cylinders and spheres in selective solvents. The film SAXS supported the result by showing lamellar structure for toluene and disordered close-packing structures for other solvents. Details about film SAXS analysis are discussed in FIG. 36.

Through a comprehensive analysis of the solvent effect, it can be deduced that a selective solvent, good for PS but bad for PLA, results in morphologies distinct from lamellar structures. As selectivity increases, the morphology transitions to cylindrical, large spherical, and small spherical structures, aligning with the expected phase behavior of block copolymers following the volume fraction changes. Notably, the observation that PLA forms cylinders and spheres suggests a reduction in PLA volume fraction as selectivity rises. Furthermore, it can establish a link between the optical properties of each film by considering the microstructures. For instance, in lamellar structures (toluene), as per Bragg's and Snell's laws, a strong reflection peak is usually observed due to lamellae alignment along the normal direction to light. Additionally, there may be a plateau of reflection at lower wavelengths, attributed to misoriented lamellae as it was observed. On the other hand, in disordered (randomly oriented) cylindrical or spherical phases (xylenes, mesitylene), optical behavior can be elucidated through the scattering properties of photonic glasses. The color of these morphologies results from both single particles scattering (form factor) and the interference of scattered waves from particle assemblies (structure factor). These scattering phenomena are defined by the form factor, which describes particle scattering according to Mie theory, and the structure factor, accounting for the constructive interference of waves scattered by different particles, employing Percus-Yevick equation. Previous theoretical calculations and experiments of scattering behavior in direct photonic glass have indicated a dominant scattering peak, followed by a rising trend in the lower wavelength region, which aligns well with these observations in UV-Vis data (FIG. 26D).

### Example 17. Investigating the Assembly Pathway of BBCP in Selective Solvents

In this section, assembly pathway of BBCP in specific solvents (toluene, xylenes, and mesitylene) is explored and comprehending the underlying mechanisms driving these distinct pathways. A qualitative analysis of the comprehensive BBCP assembly behavior relative to its concentration in various solvents was conducted. Specifically, solution-state SAXS was analyzed using four different solvents, spanning a spectrum of BBCP concentrations from low (0.1 mg/mL) to high (300 mg/mL), and elucidated the molecular assembly pathway. Cryo-TEM was conducted, and a quantitative analysis of the scattering data was performed. Based on that a more precise understanding about conformation of BBCP in molecular level was explored. Ultimately, the mechanism of different assemblies was validated by analyzing the molecular conformation.

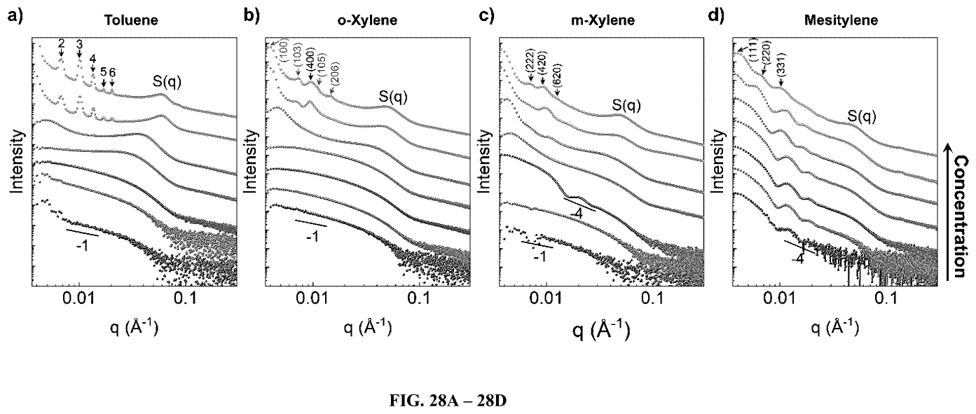

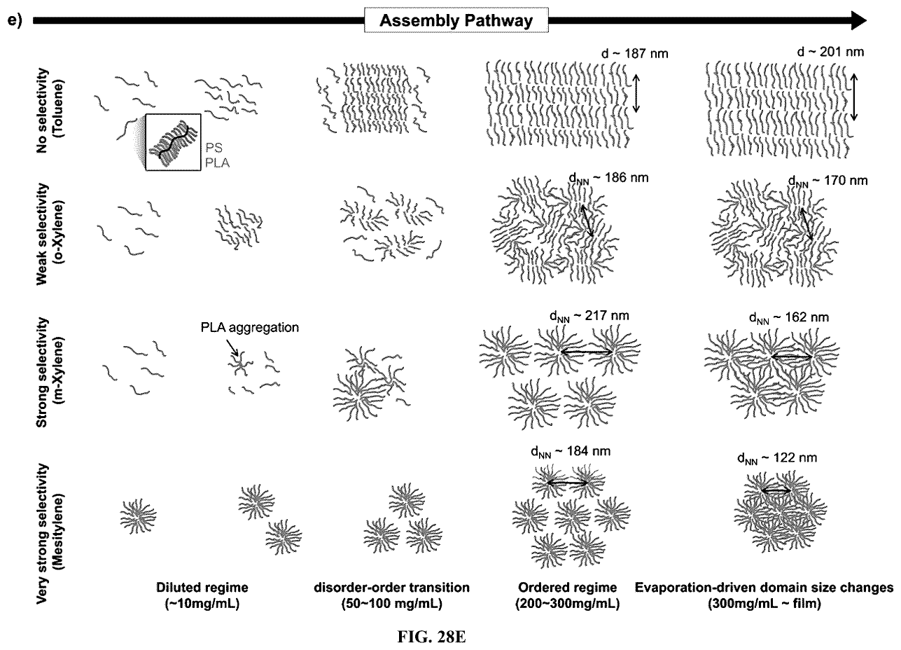

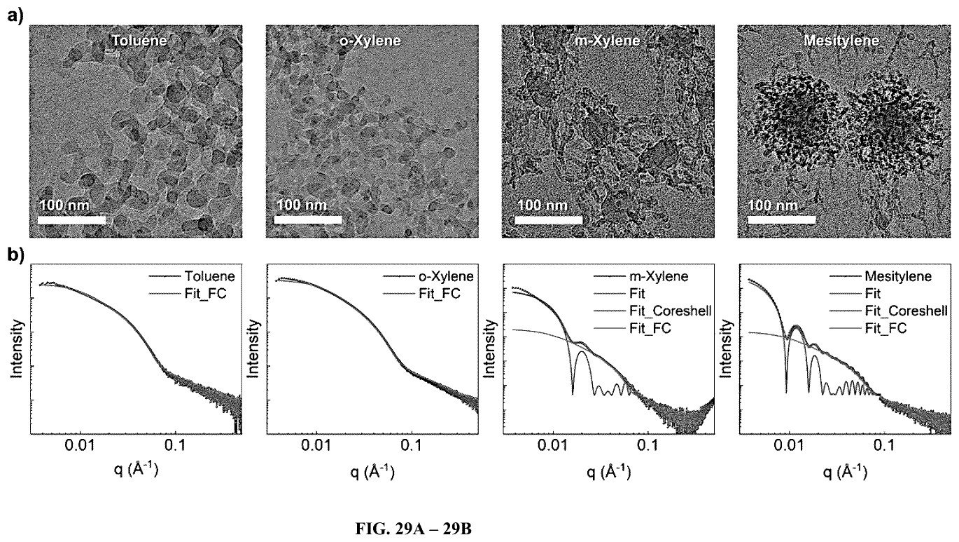

Throughout the concentration-dependent series (0.1˜300 mg/mL) in four different solvents, as the concentration increased, substantial changes in each curve was noted, coinciding with the emergence of strong structure factor peaks (FIG. 28). These findings strongly suggest that BBCP molecules assemble in solution states, although the pathway of molecular assembly varies depending on the solvent used. To better comprehend the molecular assembly pathway, the assembly regimes were categorized into three regimes (diluted, disorder-order transition, and ordered regimes) as previously published. In the dilute regime (0.1˜10 mg/mL), BBCP primarily existed as single molecules, and x-rays dominantly scattered due to the molecule, showing form factor of BBCP. In the disorder-order transition regime (50˜100 mg/mL), two strong structure factor peaks (low- and mid-q) emerged, obscuring the molecular form factor, representing the beginning of the assembly of BBCP from molecule to specific structures. In the ordered regime (>200 mg/mL), scattering dominantly occurs by the structure, exhibiting strong structural factor peaks in low-q stemming from the ordered structure, and a broad peak at the mid-q region (S(q)) reflecting increased chain crowding in the solution as concentration rose. This analysis only focused on the large (q<0.02 Å⁻¹), and intermediate (0.08 Å⁻¹>q>0.02 Å⁻¹) length scales, where the scattering is dominated by cross-sectional size and stiffness of the molecules, and overall molecular size, respectively. Attention was not placed on the small length scales (q>0.08 Å⁻¹) because most of the scattering at these scales are primarily dominated by internal density fluctuations of the side chains (blob-scattering), offering limited information about the structure.

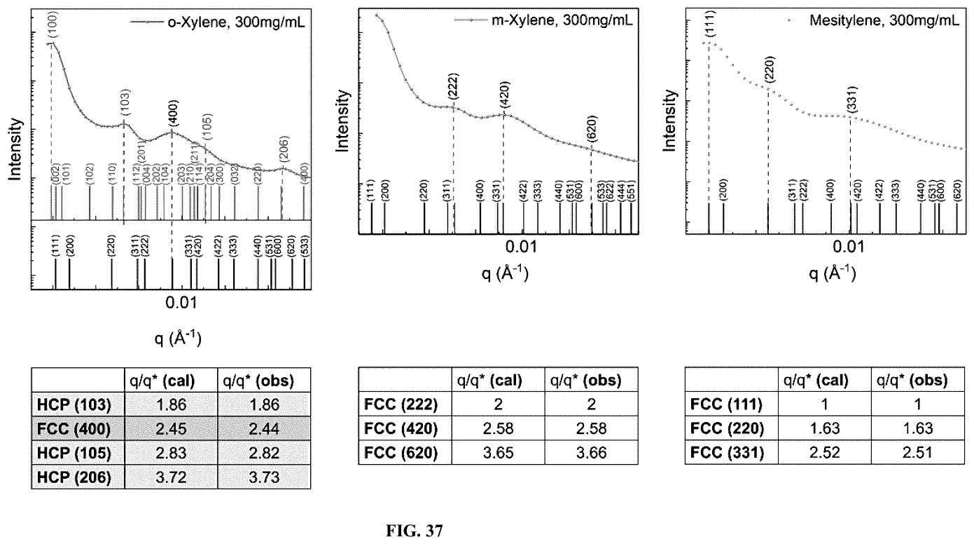

The scattering curves vary notably based on the solvent employed. In toluene, for instance, the scattering curve exhibited a slope of q⁻¹ in the diluted regime, indicating the presence of cylindrical structures. As the concentration increases, there was a discernible ordering towards a lamellar structure, indicated by the emergence of lamellar structural peaks in the ordered regime (FIG. 28A). Similarly, the scattering curve for o-xylene also displayed a cylindrical form factor in a diluted regime. However, it exhibited transitioning gradually to a close-packing structures with hybrid features of HCP and FCC structures in the ordered regime (FIG. 28B). Regarding the m-xylene, initially, it exhibited a cylindrical shape form factor (≤1 mg/mL), but a spherical form factor (q⁻⁴) appeared as solution became more concentrated in diluted regime (>1 mg/mL) (FIG. 28C). This abrupt transition from cylinder to sphere in the dilute regime occurred near the solubility limit of PLA brushes in m-xylene (FIG. 26B), primarily due to the aggregation of PLA brushes, forming small particle-like aggregates. Moreover, in the ordered regime, scattering peaks predominantly denoted the FCC close-packing structure peaks. As for mesitylene, it exhibited spherical form factor from low concentrations onward, and it barely changes in diluted regime (FIG. 28D). This stemmed from the high selectivity of mesitylene, which fostered the formation of stable micelles. This aligns with previous findings regarding the high micelle stability and low critical micelle concentration of BBCP. In the ordered regime, the structural factor in scattering curve demonstrated that BBCP ordered to FCC close-packing structure. Further details about peak indexing in ordered regime (300 mg/mL) can be found in FIG. 37.

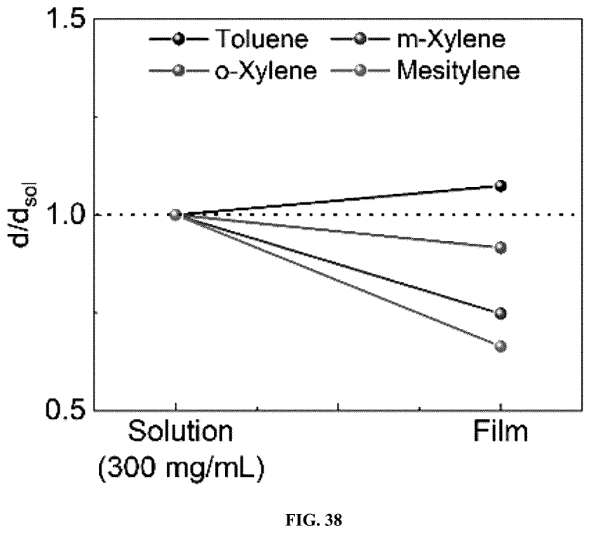

Comparing the estimated domain sizes derived from the primary q-value of solution SAXS with those from film SAXS provides insights into the evaporation-driven assembly pathway after ordered structure formation. For toluene samples, the estimated lamellar domain spacing was 187 nm for the concentrated solution (300 mg/mL) and 201 nm for film samples, indicating lamellar expansion. This expansion mainly arises from backbone stretching as the packing density increases, as previously studied. Conversely, for o-xylene, the d_{NN} were 186 nm for solution samples and 170 nm for film samples, indicating a decreasing trend. For m-xylene, the d_{NN} were 217 nm for solution samples and 162 nm for film samples; similarly, for mesitylene, the d_{NN} were 184 nm for solution samples and 122 nm for film samples, showing a substantial decrease in d_{NN}. Upon calculating the ratio of domain size changes (FIG. 38), it became evident that with increased selectivity, the domain size tends to decrease as the solvent evaporates. This phenomenon can be comprehended by considering the interplay between the volume of solvents and backbone extension. As the solvent evaporates, these factors compete and determine the domain size. In non-selective solvents, prior research indicates that the latter contributions outweigh the former, leading to domain expansion. In contrast, for selective solvents where PLA is already aggregated, limited room for PLA extension with increasing concentrations results in the former factor contributing more, causing a reduction in d_{NN}. The overall assembly pathway in different solvents is summarized in FIG. 28E.

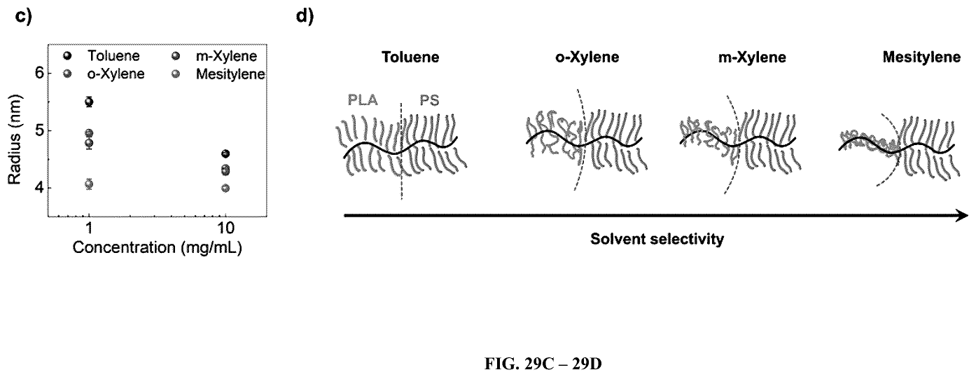

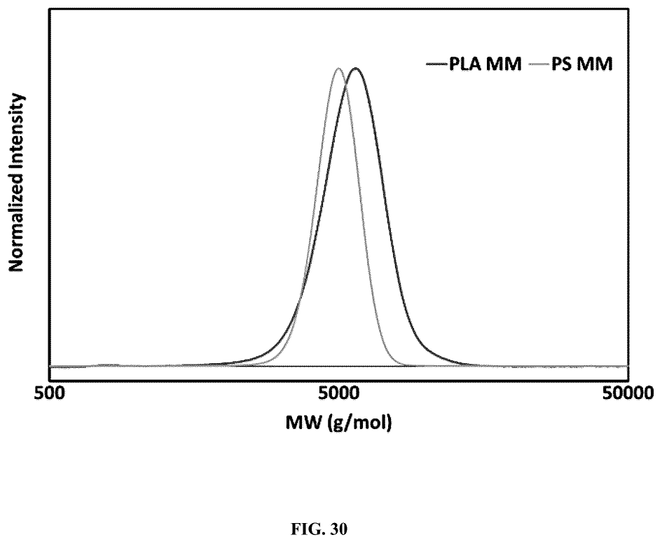

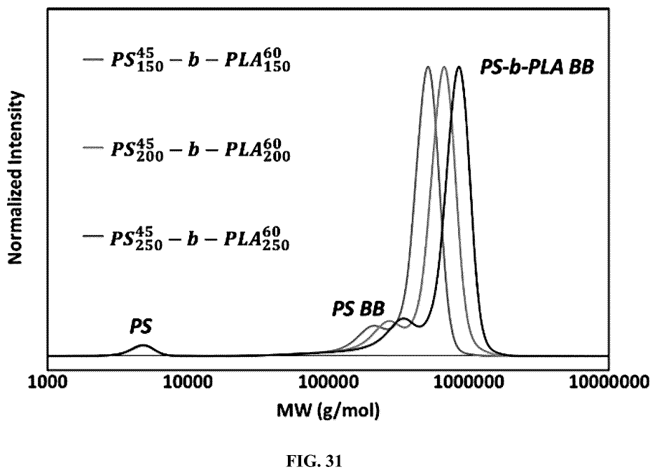

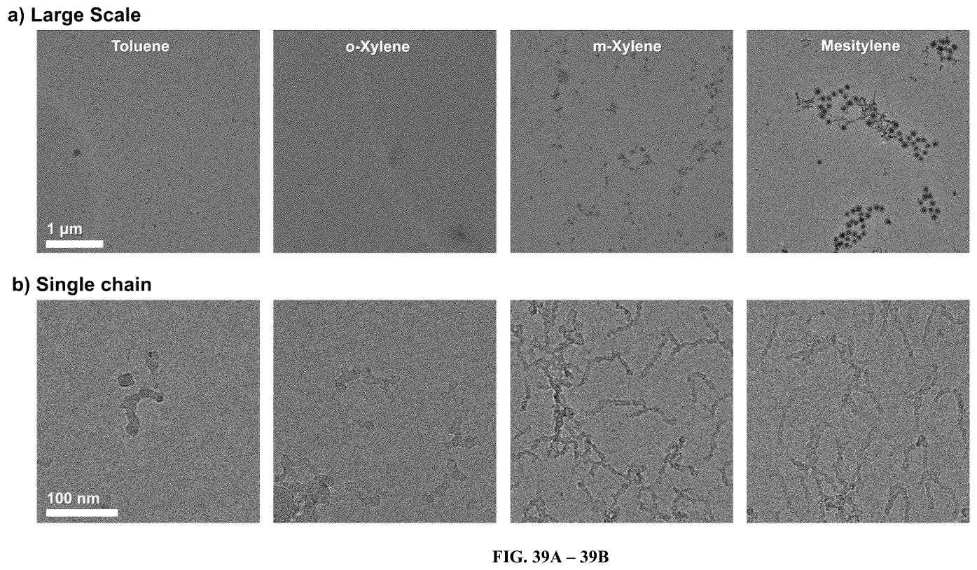

To gain a more detailed understanding of BBCP molecule behavior, especially in the diluted regime, and explored the fundamental mechanism of diverse assembly pathway, cryo-TEM was employed to capture images of molecules at a concentration of 10 mg/mL (FIGS. 29A, and 39). In the case of toluene and o-xylene, individual chains without any discernible aggregation was observed. Conversely, in m-xylene, some aggregations were observed with a core diameter of 43.2 nm, as predicted in SAXS, accompanied by single chains that did not participate in aggregation. In mesitylene, micelles with a core diameter of 66.2 nm and a 33.3 nm thick shell, alongside individual chains were observed. Notably, the micelle size in the mesitylene solution is almost identical to that of sphere in SEM images (FIG. 27A), further verifying the assembly pathway suggested in FIG. 28.

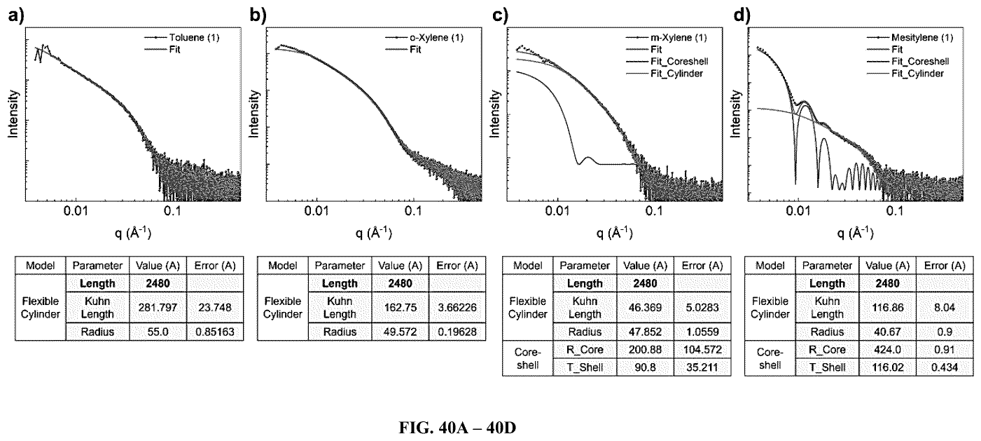

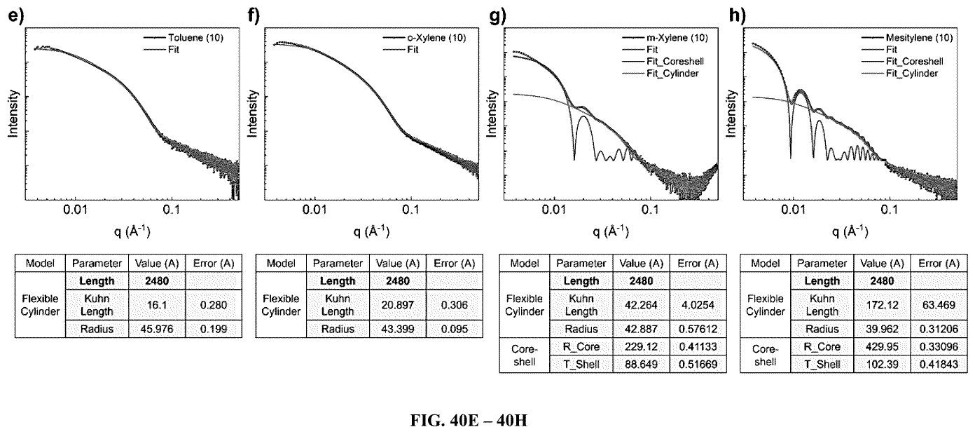

Leveraging the observations from cryo-TEM measurements, fitting models were selected for the scattering profiles in a diluted regime to conduct a more quantitative analysis of BBCP in its solution state (FIG. 29B, 38). The flexible cylinder model was utilized for toluene and o-xylene, given the presence of solely wormlike chains. For m-xylene and mesitylene, where a combination of wormlike chains and core (PLA)-shell (PS) aggregates or micelles was evident, a hybrid model involving both flexible cylinder and core-shell models was employed. In each fitting for flexible cylinder model, the length scale was fixed using a theoretically calculated contour length obtained by multiplying the number of backbones by the length of the norbonyl backbone (˜2480 nm). As the estimated length scale significantly exceeded the detectable range in SAXS (low-q limit), and the presence of core-shell contributions made it challenging to analyze below the q-range of 0.01 Å⁻¹ (specifically for m-xylene and mesitylene), the precise determination of the Kuhn length parameter became challenging. Therefore, the study focused on the estimated radius value, which is clearly discernible within the 0.01-0.1 Å⁻¹ range (identified as the Guinier knee). Full details about fitting results are available in FIG. 40.

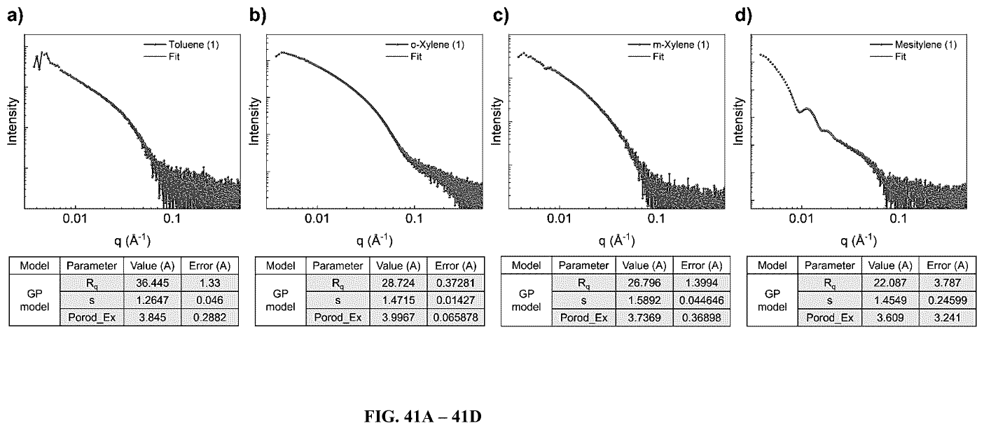

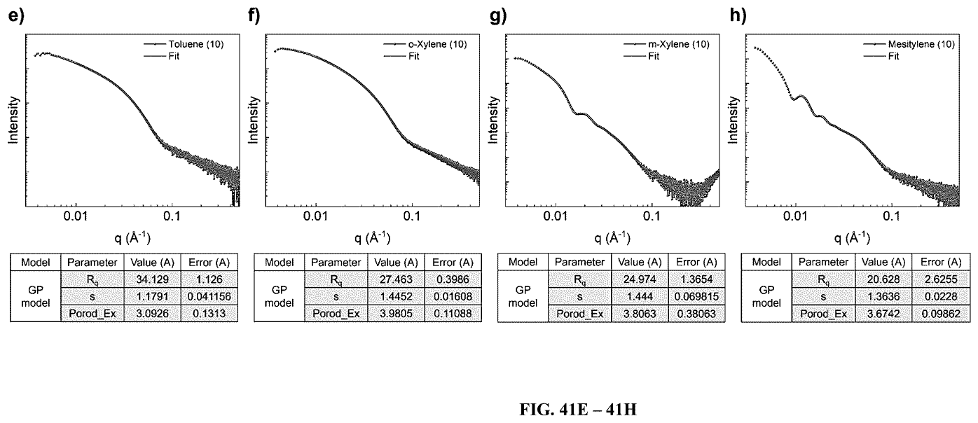

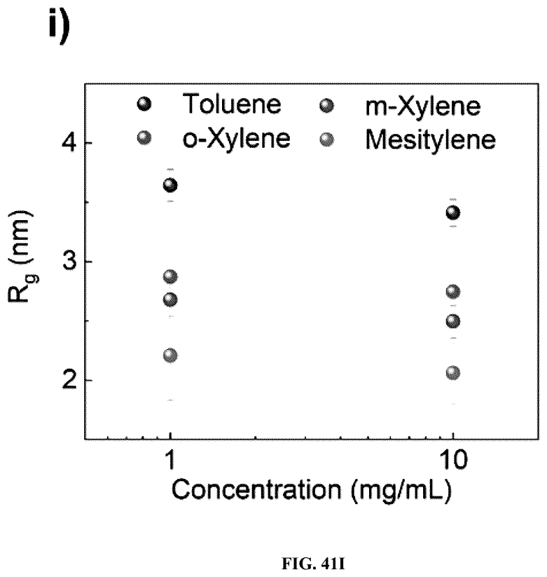

At 1 mg/mL, the calculated radius was 5.50, 4.96, 4.79, and 4.07 nm for toluene, o-xylene, m-xylene, and mesitylene, respectively. At 10 mg/mL, the radius was calculated as 4.60, 4.34, 4.29, and 4.00 nm for each solvent (FIG. 29C). Scattering curves at 0.1 mg/mL were excluded for fitting due to a weak signal. The calculated radius of single molecules showed a decreasing trend as selectivity increased, and it also decreased as concentration went higher. These fitting results were cross-verified using Guinier-Porod model fitting, which analyzed the Guinier knee region (0.1-0.01 Å-range), showing similar trends in radius of gyration (R_{g}) (FIG. 41).

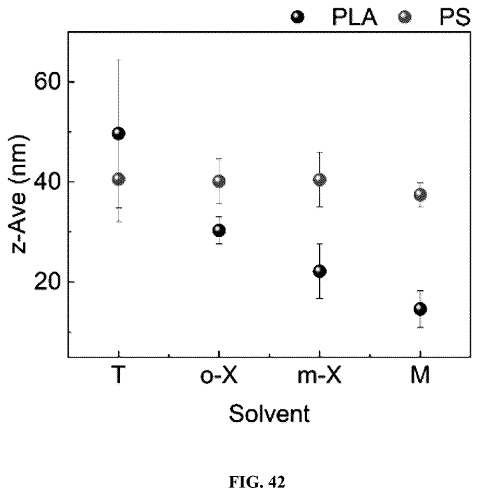

The trend was interpreted following the solvent selectivity as a consequence of the coiling behavior of PLA in relatively poor solvents (FIG. 29D). For instance, in toluene, a good solvent for both blocks, both chains would likely be relatively extended. Conversely, in mesitylene, a highly selective solvent that favors PS but is a poor solvent for PLA, the PLA chain tends to coil while the PS brush maintains its conformation, leading to a reduction in the radius scale. This hypothesis gains further support from the DLS experiments, where the measured z-average size of PLA single chains decreased as selectivity increased, while the size of PS single chains remained relatively constant (FIG. 42). It was concluded that solvent selectivity impacts the volume fraction of single chains by inducing the coiling of PLA side chains, leading to interface curvature. In turn, this leads to different assembly pathways, resulting in distinct structure and optical properties.

### Example 18. Material and Methods

### Material Synthesis and Characterization

All reactions were performed in an argon-filled glovebox (O₂<0.5 ppm, H₂O<0.5 ppm) at room temperature using oven-dried glassware. THF was dried using a commercial solvent purification system. rac-Lactide (Aldrich), sec-butyllithium solution (sec-BuLi, 1.3 mol/L in cyclohexane/hexane (92/8), ACROS Organics), ethylene oxide solution (2.5-3.3 mol/L in THF, Aldrich) was used as received. 1,8-diazabicyclo [5.4.0]undec-7-ene (DBU) (Aldrich) was distilled over CaH₂ and storage under argon at −20° C. Styrene was passed through a basic alumina plug and stored under argon at −20° C. [(H₂IMes)(3-Brpy)₂(Cl)₂Ru=CHPh], G3 was synthesized according to literature⁵⁵. Exo-5-Norbornene-2-carboxylic acid, endo-/exo-5-Norbornene-2-methanol (M30H) and exo-5-Norbornene-2-carbonyl chloride was synthesized according to literature⁵⁶⁻⁵⁷. Nuclear Magnetic Resonance (NMR) spectra were recorded on a Carver B500 Bruker Avance III HD NMR Spectrometer. Spectra are reported in ppm and referenced to the residual solvent signal: CDCl₃ (¹H 7.26 ppm, ¹³C 77.16 ppm). Gel Permeation Chromatography (GPC) was performed using a Tosoh ECOSEC HLC-8320GPC at 40° C. fitted with a guard column (6.0 mm ID×4.0 cm) and two analytical columns (TSKgel GMH_{HR}-H,7.8 mm ID×30 cm×5 m). A flow rate of 1 mL-min⁻¹ was used for both the analytical columns and the reference flow.

THF (HPLC grade) was used as the eluent, and polystyrene standards (15 points ranging from 500 MW to 8.42 million MW) were used as the general calibration. UV detector was recorded at 266 nm.

### Synthesis of PS-b-PLA BBCP

Well-defined poly(styrene)-b-poly(lactic acid) (PS-b-PLA) diblock bottlebrushes were synthesized via a previously developed route. The methods employed in this study consisted of synthesizing PS macromonomers using an anionic polymerization of styrene initiated by sec-BuLi, as well as PLA macromonomers through an organocatalyzed DBU ring-opening polymerization of lactide. The intended symmetric diblock bottlebrushes were synthesized using sequential-addition ring-opening metathesis polymerization (ROMP).

TABLE 4
Characterization data for PS-PLA deblock bottlebrush
(PS: 4.5 kg/mol; PLA: 4.3 kg/mol).

| | | | | wt %^{c} | | | Block |
|---|---|---|---|---|---|---|---|
| | Mₙ^{a} | | Macromonomer | Diblock | Block | PS | length |
| N_{bb} | (kg/mol) | M_{w}/Mₙ^{a} | conversion^{b} | BB | 1 | Brush | PS:PLA |
| 150:150 | 385 | 1.2 | >98% | 91 | 9 | <1% | 150:181 |
| 200:200 | 513 | 1.2 | >98% | 90 | 10 | <1% | 200:247 |
| 250:250 | 635 | 1.2 | >98% | 90 | 10 | <1% | 250:313 |

^{a}Calculated with respect to PS standards; ^{b}Determined from GPC (includes both PS and PLA).
^{c}Based on deconvolution of UV-GPC trace as discussed in previous literature⁵⁷

### Preparation of BBCP Drop-Cast Sample

Samples for optical and structural characteristic analysis were prepared using the drop-casting method. Initially, stock solutions of BBCP were prepared by direct dissolution in solvents at a concentration of 150 mg/mL, and stirred for a minimum of 48 hours at 40° C. before being allowed to settle for several hours at room temperature prior to drop-casting. Glass substrates were rinsed in toluene, acetone, and isopropanol before being dried using a nitrogen gun. Using a pipette, a 10-microliter drop of the solution was placed onto the substrate and allowed to air dry at room temperature. Upon complete solvent evaporation, the samples underwent annealing for 4 hours at 60° C.

### Characterization of the Optical and Structural Properties of BBCP

Optical microscope images were captured using a top-mounted optical microscope at low magnification (1.6×) under diffuse (ring) light. UV-Vis diffuse reflection spectra were acquired using a Varian Cary 5G spectrophotometer equipped with an integrating sphere attachment at the Illinois Material Research Laboratory (MRL). Dynamic light scattering was conducted using the Malvern Zetasizer to determine the harmonic intensity average particle diameter (Z-average size) in MRL Illinois. SEM imaging was conducted using a Hitachi S4800 instrument at the Illinois MRL. The sample was prepared on cleaned silicon substrates. To explore the sample's vertical orientation, prints on the silicon substrate were precisely cut perpendicular to the by inducing controlled crack propagation (initiated with a diamond glass scriber). Subsequently, the sample was affixed to a 90-degree angled SEM pin stub, and micrographs were acquired using a low accelerating voltage (3-5 keV) with a beam current ranging from approximately 10 to 20 nano-amperes. The acquired images underwent image-processing using the ImageJ software package to calculate the domain spacing. PiFM imaging was performed using a Molecular Vista PiFM-Raman microscope at the Illinois MRL, and the samples for PiFM imaging were prepared on a silicon substrate using the same method employed for optical characterization. Herein, the used infrared signal of each bottlebrush molecule was obtained using an FT-IR Analyzer (Alpha, Bruker). The cryo-TEM experiment was carried out in MRL Illinois. Samples were frozen on 200 mesh holey carbon copper grids (SPI Supplies, 3620C-MB) using an FEI MarkIV Vitrobot. For each grid, 3 μL of sample was applied to the grid at 22° C. and 90-95% ambient temperature and humidity, respectively. Grids were blotted once for 3 seconds with a blot force of 0-2 and plunged rapidly into liquid ethane for freezing. Once frozen, grids were clipped into autogrids and imaged on a ThermoFisher Glacios CryoTEM at 200 kV using EPU and Velox software.

### Small-Angle X-Ray Scattering (SAXS)

Films and solutions examined through transmission small-angle X-ray scattering were analyzed at Argonne National Laboratory (Lemont, IL) on beamline 12-ID-B of the Advanced Photon Source, utilizing a beam energy of 13.3 keV and a Pilatus 2M 2D detector. Film samples were prepared by drop-casting the sample, as described previously, with solvent-washed polyimide sheets (Kapton—American Durafilm) used as the substrate. Solution samples were prepared using the same methods described previously. The prepared solutions were sequentially loaded and irradiated from the lowest to the highest concentration, starting with pure solvent. This was achieved using a single 1 mm quartz capillary (Charles Supper Company)/Teflon tubing flow cell for each polymer. In cases where the solution exhibited high viscosity due to high concentration, the solution was loaded into the capillary by applying gentle centrifugal force using a centrifuge. Curve fitting was carried out using the SasView software package.

### REFERENCES

A number of publications are cited below in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
(1) Saranathan, V.; Narayanan, S.; Sandy, A.; Dufresne, E. R.; Prum, R. O. Evolution of Single Gyroid Photonic Crystals in Bird Feathers. 2021, 118 (23), 2101357118. https://doi.org/https://doi.org/10.1073/pnas.2101357118.
(2) Saranathan, V.; Osuji, C. O.; Mochrie, S. G. J.; Noh, H.; Narayanan, S.; Sandy, A.; Dufresne, E. R.; Prum, R. O. Structure, Function, and Self-Assembly of Single Network Gyroid (I4132) Photonic Crystals in Butterfly Wing Scales. 2010. https://doi.org/https://doi.org/10.1073/pnas.0909616107.
(3) Gur, D.; Palmer, B. A.; Leshem, B.; Oron, D.; Fratzl, P.; Weiner, S.; Addadi, L. The Mechanism of Color Change in the Neon Tetra Fish: A Light-Induced Tunable Photonic Crystal Array. Angewandte Chemie 2015, 127 (42), 12603-12607. https://doi.org/10.1002/ange.201502268.
(4) Seago, A. E.; Brady, P.; Vigneron, J. P.; Schultz, T. D. Gold Bugs and beyond: A Review of Iridescence and Structural Colour Mechanisms in Beetles (Coleoptera). J R Soc Interface 2009, 6 (SUPPL. 2). https://doi.org/10.1098/rsif.2008.0354.focus.
(5) Teyssier, J.; Saenko, S. v.; van der Marel, D.; Milinkovitch, M. C. Photonic Crystals Cause Active Colour Change in Chameleons. Nat Commun 2015, 6. https://doi.org/10.1038/ncomms7368.
(6) Gurses, A.; G0neq, K.; $ahin, E. Removal of Dyes and Pigments from Industrial Effluents. In Green Chemistry and Water Remediation: Research and Applications; Elsevier, 2020; pp 135-187. https://doi.org/10.1016/B978-0-12-817742-6.00005-0.
(7) Shang, L.; Zhang, W.; Xu, K.; Zhao, Y. Bio-Inspired Intelligent Structural Color Materials. Mater Horiz 2019, 6 (5), 945-958. https://doi.org/10.1039/c9mh00101h.
(8) Zhang, Z.; Chen, Z.; Shang, L.; Zhao, Y. Structural Color Materials from Natural Polymers. Adv Mater Technol 2021, 6 (11). https://doi.org/10.1002/admt.202100296.
(9) Zhao, Y.; Xie, Z.; Gu, H.; Zhu, C.; Gu, Z. Bio-Inspired Variable Structural Color Materials. Chem Soc Rev 2012, 41(8), 3297-3317. https://doi.org/10.1039/c2cs15267c.
(10) Wang, Z.; Chan, C. L. C.; Parker, R. M.; Vignolini, S. The Limited Palette for Photonic Block-Copolymer Materials: A Historical Problem or a Practical Limitation?Angewandte Chemie—International Edition 2022, 61 (22). https://doi.org/10.1002/anie.202117275.
(11) Wang, Z.; Chan, C. L. C.; Zhao, T. H.; Parker, R. M.; Vignolini, S. Recent Advances in Block Copolymer Self-Assembly for the Fabrication of Photonic Films and Pigments. Adv Opt Mater 2021, 9 (21). https://doi.org/10.1002/adom.202100519.
(12) Liu, N.; Guo, H.; Fu, L.; Kaiser, S.; Schweizer, H.; Giessen, H. Three-Dimensional Photonic Metamaterials at Optical Frequencies. Nat Mater 2008, 7 (1), 31-37. https://doi.org/10.1038/nmat2072.
(13) Nam, S. H.; Park, J.; Jeon, S. Rapid and Large-Scale Fabrication of Full Color Woodpile Photonic Crystals via Interference from a Conformal Multilevel Phase Mask. Adv Funct Mater 2019, 29 (44). https://doi.org/10.1002/adfm.201904971.
(14) Zhuohao Zhang; Chong Wang; Qiao Wang; Yuanjin Zhao; Luoran Shang. Cholesteric Cellulose Liquid Crystal Ink for Three-Dimensional Structural Coloration. Proceedings of the National Academy of Sciences 2022, 119 (23), 2204113119. https://doi.org/10.1073/pnas.2204113119.
(15) George, K.; Esmaeili, M.; Wang, J. I.; Taheri-Qazvini, N.; Abbaspourrad, A. I.; Sadati, M. 3D Printing of Responsive Chiral Photonic Nanostructures. Proceedings of the National Academy of Sciences 2023, 120 (12), e2220032120. https://doi.org/10.1073/pnas.2220032120.
(16) Chan, C. L. C.; Lei, I. M.; van de Kerkhof, G. T.; Parker, R. M.; Richards, K. D.; Evans, R. C.; Huang, Y. Y. S.; Vignolini, S. 3D Printing of Liquid Crystalline Hydroxypropyl Cellulose—toward Tunable and Sustainable Volumetric Photonic Structures. Adv Funct Mater 2022, 32 (15). https://doi.org/10.1002/adfm.202108566.
(17) Demirars, A. F.; Poloni, E.; Chiesa, M.; Bargardi, F. L.; Binelli, M. R.; Woigk, W.; de Castro, L. D. C.; Kleger, N.; Coulter, F. B.; Sicher, A.; Galinski, H.; Scheffold, F.; Studart, A. R. Three-Dimensional Printing of Photonic Colloidal Glasses into Objects with Isotropic Structural Color. Nat Commun 2022, 13 (1). https://doi.org/10.1038/s41467-022-32060-2.
(18) Liao, J.; Ye, C.; Guo, J.; Garciamendez-Mijares, C. E.; Agrawal, P.; Kuang, X.; Japo, J. O.; Wang, Z.; Mu, X.; Li, W.; Ching, T.; Mille, L. S.; Zhu, C.; Zhang, X.; Gu, Z.; Zhang, Y. S. 3D-Printable Colloidal Photonic Crystals. Materials Today 2022, 56, 29-41. https://doi.org/10.1016/j.mattod.2022.02.014.
(19) Zhang, Y.; Zhang, L.; Zhang, C.; Wang, J.; Liu, J.; Ye, C.; Dong, Z.; Wu, L.; Song, Y. Continuous Resin Refilling and Hydrogen Bond Synergistically Assisted 3D Structural Color Printing. Nat Commun 2022, 13 (1). https://doi.org/10.1038/s41467-022-34866-6.
(20) Patil, A.; Heil, C. M.; Vanthournout, B.; Bleuel, M.; Singla, S.; Hu, Z.; Gianneschi, N. C.; Shawkey, M. D.; Sinha, S. K.; Jayaraman, A.; Dhinojwala, A. Structural Color Production in Melanin-Based Disordered Colloidal Nanoparticle Assemblies in Spherical Confinement. Adv Opt Mater 2022, 10 (5). https://doi.org/10.1002/adom.202102162.
(21) Patil, A.; Heil, C. M.; Vanthournout, B.; Singla, S.; Hu, Z.; Ilavsky, J.; Gianneschi, N. C.; Shawkey, M. D.; Sinha, S. K.; Jayaraman, A.; Dhinojwala, A. Modeling Structural Colors from Disordered One-Component Colloidal Nanoparticle-Based Supraballs Using Combined Experimental and Simulation Techniques. ACS Mater Lett 2022, 4 (9), 1848-1854. https://doi.org/10.1021/acsmaterialslett.2c00524.
(22) Heil, C. M.; Patil, A.; Vanthournout, B.; Singla, S.; Bleuel, M.; Song, J.-J.; Hu, Z.; Gianneschi, N. C.; Shawkey, M. D.; Sinha, S. K.; Jayaraman, A.; Dhinojwala, A. Mechanism of Structural Colors in Binary Mixtures of Nanoparticle-Based Supraballs. Sci Adv 2023, 9, eadf2859. https://doi.org/10.1126/sciadv.adf2859.
(23) Boyle, B. M.; French, T. A.; Pearson, R. M.; McCarthy, B. G.; Miyake, G. M. Structural Color for Additive Manufacturing: 3D-Printed Photonic Crystals from Block Copolymers. ACS Nano 2017, 11 (3), 3052-3058. https://doi.org/10.1021/acsnano.7b00032.
(24) Park, T. H.; Yu, S.; Cho, S. H.; Kang, H. S.; Kim, Y.; Kim, M. J.; Eoh, H.; Park, C.; Jeong, B.; Lee, S. W.; Ryu, D. Y.; Huh, J.; Park, C. Block Copolymer Structural Color Strain Sensor. NPG Asia Mater 2018, 10 (4), 328-339. https://doi.org/10.1038/s41427-018-0036-3.
(25) Lim, H. S.; Lee, J. H.; Walish, J. J.; Thomas, E. L. Dynamic Swelling of Tunable Full-Color Block Copolymer Photonic Gels via Counterion Exchange. ACS Nano 2012, 6 (10), 8933-8939. https://doi.org/10.1021/nn302949n.
(26) Kang, H. S.; Lee, J.; Cho, S. M.; Park, T. H.; Kim, M. J.; Park, C.; Lee, S. W.; Kim, K. L.; Ryu, D. Y.; Huh, J.; Thomas, E. L.; Park, C. Printable and Rewritable Full Block Copolymer Structural Color. Advanced Materials 2017, 29 (29). https://doi.org/10.1002/adma.201700084.
(27) Mai, Y.; Eisenberg, A. Self-Assembly of Block Copolymers. Chem Soc Rev 2012, 41 (18), 5969-5985. https://doi.org/10.1039/c2cs35115c.
(28) Bates, F. S.; Fredrickson, G. H. Block Copolymer Thermodynamics: Theory and Experiment. Annu. Rev. Phys. Chem 1990, 41, 525-557. https://doi.org//10.1146/annurev.pc.41.100190.002521.
(29) Zhang, C.; Vigil, D. L.; Sun, D.; Bates, M. W.; Loman, T.; Murphy, E. A.; Barbon, S. M.; Song, J. A.; Yu, B.; Fredrickson, G. H.; Whittaker, A. K.; Hawker, C. J.; Bates, C. M. Emergence of Hexagonally Close-Packed Spheres in Linear Block Copolymer Melts. J Am Chem Soc 2021, 143 (35), 14106-14114. https://doi.org/10.1021/jacs.lc03647.
(30) Barbon, S. M.; Song, J. A.; Chen, D.; Zhang, C.; Lequieu, J.; Delaney, K. T.; Anastasaki, A.; Rolland, M.; Fredrickson, G. H.; Bates, M. W.; Hawker, C. J.; Bates, C. M. Architecture Effects in Complex Spherical Assemblies of (AB)n-Type Block Copolymers. ACS Macro Lett 2020, 9 (12), 1745-1752. https://doi.org/10.1021/acsmacrolett.0c00704.
(31) Lee, S.; Bluemle, M. J.; Bates. Frank S. Discovery of a Frank-KaspersPhase InSphere-Forming Block Copolymer Melts. Science (1979) 2010, 330 (6002), 349-353. https://doi.org/10.1126/science.1195552.
(32) Xiang, L.; Li, Q.; Li, C.; Yang, Q.; Xu, F.; Mai, Y. Block Copolymer Self-Assembly Directed Synthesis of Porous Materials with Ordered Bicontinuous Structures and Their Potential Applications. Advanced Materials. John Wiley and Sons Inc Feb. 2, 2023. https://doi.org/10.1002/adma.202207684.
(33) Choo, Y.; Majewski, P. W.; Fukuto, M.; Osuji, C. O.; Yager, K. G. Pathway-Engineering for Highly-Aligned Block Copolymer Arrays. Nanoscale 2018, 10 (1), 416-427. https://doi.org/10.1039/c7nr06069f.
(34) Lee, C.; Ndaya, D.; Bosire, R.; Gabinet, U. R.; Sun, J.; Gopalan, P.; Kasi, R. M.; Osuji, C. O. Effects of Labile Mesogens on the Morphology of Liquid Crystalline Block Copolymers in Thin Films. Macromolecules 2021, 54 (7), 3223-3231. https://doi.org/10.1021/acs.macromol.1c00100.
(35) Nian, S.; Fan, Z.; Freychet, G.; Zhernenkov, M.; Redemann, S.; Cai, L. H. Self-Assembly of Flexible Linear-Semiflexible Bottlebrush-Flexible Linear Triblock Copolymers. Macromolecules 2021, 54 (20), 9361-9371. https://doi.org/10.1021/acs.macromol.1c01911.
(36) Guo, Z.; Zhang, G.; Qiu, F.; Zhang, H.; Yang, Y.; Shi, A. C. Discovering Ordered Phases of Block Copolymers: New Results from a Generic Fourier-Space Approach. Phys Rev Lett 2008, 101 (2). https://doi.org/10.1103/PhysRevLett.101.028301.
(37) Zhulina, E. B.; Sheiko, S. S.; Dobrynin, A. V.; Borisov, O. V. Microphase Segregation in the Melts of Bottlebrush Block Copolymers. Macromolecules 2020, 53 (7), 2582-2593. https://doi.org/10.1021/acs.macromol.9b02485.
(38) Liang, R.; Xue, Y.; Fu, X.; Le, A. N.; Song, Q.; Qiang, Y.; Xie, Q.; Dong, R.; Sun, Z.; Osuji, C. O.; Johnson, J. A.; Li, W.; Zhong, M. Hierarchically Engineered Nanostructures from Compositionally Anisotropic Molecular Building Blocks. Nat Mater 2022, 21 (12), 1434-1440. https://doi.org/10.1038/s41563-022-01393-0.
(39) Chen, M.; Chen, Y.; Zhu, Y.; Jiang, Y.; Andelman, D.; Man, X. Chain Flexibility Effects on the Self-Assembly of Diblock Copolymer in Thin Films. Macromolecules 2023, 56 (4), 1704-1712. https://doi.org/10.1021/acs.macromol.2c02292.
(40) Lee, C. U.; Khalifehzadeh, R.; Ratner, B.; Boydston, A. J. Facile Synthesis of Fluorine-Substituted Polylactides and Their Amphiphilic Block Copolymers. Macromolecules 2018, 51 (4), 1280-1289. https://doi.org/10.1021/acs.macromol.7b02531.
(41) Davidson, E. C.; Rosales, A. M.; Patterson, A. L.; Russ, B.; Yu, B.; Zuckermann, R. N.; Segalman, R. A. Impact of Helical Chain Shape in Sequence-Defined Polymers on Polypeptoid Block Copolymer Self-Assembly. Macromolecules 2018, 51 (5), 2089-2098. https://doi.org/10.1021/acs.macromol.8b00055.
(42) Song, D. P.; Jacucci, G.; Dundar, F.; Naik, A.; Fei, H. F.; Vignolini, S.; Watkins, J. J. Photonic Resins: Designing Optical Appearance via Block Copolymer Self-Assembly. Macromolecules 2018, 51 (6), 2395-2400. https://doi.org/10.1021/acs.macromol.7b02288.
(43) Liberman-Martin, A. L.; Chu, C. K.; Grubbs, R. H. Application of Bottlebrush Block Copolymers as Photonic Crystals. Macromol Rapid Commun 2017, 38 (13). https://doi.org/10.1002/marc.201700058.
(44) Park, T. H.; Yu, S.; Cho, S. H.; Kang, H. S.; Kim, Y.; Kim, M. J.; Eoh, H.; Park, C.; Jeong, B.; Lee, S. W.; Ryu, D. Y.; Huh, J.; Park, C. Block Copolymer Structural Color Strain Sensor. NPG Asia Mater 2018, 10 (4), 328-339. https://doi.org/10.1038/s41427-018-0036-3.
(45) Kang, H. S.; Han, S. W.; Park, C.; Lee, S. W.; Eoh, H.; Baek, J.; Shin, D.-G.; Park, T. H.; Huh, J.; Lee, H.; Kim, D.-E.; Ryu, D. Y.; Thomas, E. L.; Koh, W.-G.; Park, C. 3D Touchless Multiorder Reflection Structural Color Sensing Display. Sci. Adv 2020, 6, 5769-5791. https://doi.org/10.1126/sciadv.abb5769.
(46) Kang, Y.; Walish, J. J.; Gorishnyy, T.; Thomas, E. L. Broad-Wavelength-Range Chemically Tunable Block-Copolymer Photonic Gels. Nat Mater 2007, 6 (12), 957-960. https://doi.org/10.1038/nmat2032.
(47) Pan, T.; Dutta, S.; Kamble, Y.; Patel, B. B.; Wade, M. A.; Rogers, S. A.; Diao, Y.; Guironnet, D.; Sing, C. E. Materials Design of Highly Branched Bottlebrush Polymers at the Intersection of Modeling, Synthesis, Processing, and Characterization. Chemistry of Materials 2022, 34 (5), 1990-2024. https://doi.org/10.1021/acs.chemmater.1c04030.
(48) Miyake, G. M.; Piunova, V. A.; Weitekamp, R. A.; Grubbs, R. H. Precisely Tunable Photonic Crystals from Rapidly Self-Assembling Brush Block Copolymer Blends. Angewandte Chemie—International Edition 2012, 51 (45), 11246-11248. https://doi.org/10.1002/anie.201205743.
(49) Sveinbjarnsson, B. R.; Weitekamp, R. A.; Miyake, G. M.; Xia, Y.; Atwater, H. A.; Grubbs, R. H.; Watson, T. J. Rapid Self-Assembly of Brush Block Copolymers to Photonic Crystals. Proceedings of the National Academy of Sciences 2012, 109 (36), 14332-14336. https://doi.org/10.1073/pnas.1213055109.
(50) Chae, C. G.; Yu, Y. G.; Seo, H. Bin; Kim, M. J.; Grubbs, R. H.; Lee, J. S. Experimental Formulation of Photonic Crystal Properties for Hierarchically Self-Assembled POSS-Bottlebrush Block Copolymers. Macromolecules 2018, 51 (9), 3458-3466. https://doi.org/10.1021/acs.macromol.8b00298.
(51) Yu, Y. G.; Chae, C. G.; Kim, M. J.; Seo, H. Bin; Grubbs, R. H.; Lee, J. S. Precise Synthesis of Bottlebrush Block Copolymers from ω-End-Norbornyl Polystyrene and Poly(4-Tert-Butoxystyrene) via Living Anionic Polymerization and Ring-Opening Metathesis Polymerization. Macromolecules 2018, 51 (2), 447-455. https://doi.org/10.1021/acs.macromol.7b02447.
(52) Miyake, G. M.; Weitekamp, R. A.; Piunova, V. A.; Grubbs, R. H. Synthesis of Isocyanate-Based Brush Block Copolymers and Their Rapid Self-Assembly to Infrared-Reflecting Photonic Crystals. J Am Chem Soc 2012, 134 (34), 14249-14254. https://doi.org/10.1021/ja306430k.
(53) Patel, B. B.; Walsh, D. J.; Patel, K.; Kim, D. H.; Kwok, J. J.; Guironnet, D.; Diao, Y. Rapid, Interface-Driven Domain Orientation in Bottlebrush Diblock Copolymer Films during Thermal Annealing. Soft Matter 2022, 18 (8), 1666-1677. https://doi.org/10.1039/dlsm01634b.
(54) Mei, H.; Laws, T. S.; Mahalik, J. P.; Li, J.; Mah, A. H.; Terlier, T.; Bonnesen, P.; Uhrig, D.; Kumar, R.; Stein, G. E.; Verduzco, R. Entropy and Enthalpy Mediated Segregation of Bottlebrush Copolymers to Interfaces. Macromolecules 2019, 52 (22), 8910-8922. https://doi.org/10.1021/acs.macromol.9b01801.
(55) Liang, H.; Cao, Z.; Wang, Z.; Sheiko, S. S.; Dobrynin, A. V. Combs and Bottlebrushes in a Melt. Macromolecules 2017, 50 (8), 3430-3437. https://doi.org/10.1021/acs.macromol.7b00364.
(56) Zhao, T. H.; Jacucci, G.; Chen, X.; Song, D. P.; Vignolini, S.; Parker, R. M. Angular-Independent Photonic Pigments via the Controlled Micellization of Amphiphilic Bottlebrush Block Copolymers. Advanced Materials 2020, 32 (47). https://doi.org/10.1002/adma.202002681.
(57) Song, D. P.; Zhao, T. H.; Guidetti, G.; Vignolini, S.; Parker, R. M. Hierarchical Photonic Pigments via the Confined Self-Assembly of Bottlebrush Block Copolymers. ACS Nano 2019, 13 (2), 1764-1771. https://doi.org/10.1021/acsnano.8b07845.
(58) Chen, X.; Song, D. P.; Li, Y. Precisely Tunable Photonic Pigments via Interfacial Self-Assembly of Bottlebrush Block Copolymer Binary Blends. Macromolecules 2022, 55 (17), 7438-7445. https://doi.org/10.1021/acs.macromol.2c01063.
(59) Wade, M. A.; Walsh, D.; Lee, J. C. W.; Kelley, E.; Weigandt, K.; Guironnet, D.; Rogers, S. A. Color, Structure, and Rheology of a Diblock Bottlebrush Copolymer Solution. Soft Matter 2020, 16 (21), 4919-4931. https://doi.org/10.1039/d0sm00397b.
(60) Li, X.; Wang, B.; Liu, Q. J.; Zhao, R.; Song, D. P.; Li, Y. Supersoft Elastic Bottlebrush Microspheres with Stimuli-Responsive Color-Changing Properties in Brine. Langmuir 2021, 37 (22), 6744-6753. https://doi.org/10.1021/acs.langmuir.1c00751.
(61) Patel, B. B.; Walsh, D. J.; Kim, D. H.; Kwok, J.; Lee, B.; Guironnet, D.; Diao, Y. Tunable Structural Color of Bottlebrush Block Copolymers through Direct-Write 3D Printing from Solution. Sci. Adv 2020, 6, 7202-7212. https://doi.org/10.1126/sciadv.aaz7202.
(62) Patel, B. B.; Chang, Y.; Park, S. K.; Wang, S.; Rosheck, J.; Patel, K.; Walsh, D.; Guironnet, D.; Diao, Y. PolyChemPrint: A Hardware and Software Framework for Benchtop Additive Manufacturing of Functional Polymeric Materials. Journal of Polymer Science 2021, 59 (21), 2468-2478. https://doi.org/10.1002/pol.20210086.
(63) Patel, B. B.; Pan, T.; Chang, Y.; Walsh, D. J.; Kwok, J. J.; Park, K. S.; Patel, K.; Guironnet, D.; Sing, C. E.; Diao, Y. Concentration-Driven Self-Assembly of PS-b-PLA Bottlebrush Diblock Copolymers in Solution. ACS Polymers Au 2022, 2 (4), 232-244. https://doi.org/10.1021/acspolymersau.1c00057.
(64) Dutta, S.; Sing, C. E. Two Stretching Regimes in the Elasticity of Bottlebrush Polymers. Macromolecules 2020, 53 (16), 6946-6955. https://doi.org/10.1021/acs.macromol.0c01184.
(65) Pan, T.; Dutta, S.; Sing, C. E. Interaction Potential for Coarse-Grained Models of Bottlebrush Polymers. Journal of Chemical Physics 2022, 156 (1). https://doi.org/10.1063/5.0076507.
(66) Dutta, S.; Pan, T.; Sing, C. E. Bridging Simulation Length Scales of Bottlebrush Polymers Using a Wormlike Cylinder Model. Macromolecules 2019, 52 (13), 4858-4874. https://doi.org/10.1021/acs.macromol.9b00363.
(67) Pan, T.; Patel, B. B.; Walsh, D. J.; Dutta, S.; Guironnet, D.; Diao, Y.; Sing, C. E. Implicit Side-Chain Model and Experimental Characterization of Bottlebrush Block Copolymer Solution Assembly. Macromolecules 2021, 54 (8), 3620-3633. https://doi.org/10.1021/acs.macromol.1c00336.
(68) Blasco, E.; Sims, M. B.; Goldmann, A. S.; Sumerlin, B. S.; Barner-Kowollik, C. 50th Anniversary Perspective: Polymer Functionalization. Macromolecules 2017, 50 (14), 5215-5252. https://doi.org/10.1021/acs.macromol.7b00465.
(69) Goldmann, A. S.; Glassner, M.; Inglis, A. J.; Barner-Kowollik, C. Post-Functionalization of Polymers via Orthogonal Ligation Chemistry. Macromolecular Rapid Communications. May 27, 2013, pp 810-849. https://doi.org/10.1002/marc.201300017.
(70) Zhou, D.; Zhu, L. W.; Wu, B. H.; Xu, Z. K.; Wan, L. S. End-Functionalized Polymers by Controlled/Living Radical Polymerizations: Synthesis and Applications. Polymer Chemistry. Royal Society of Chemistry Jan. 21, 2022, pp 300-358. https://doi.org/10.1039/d1py01252e.
(71) Lunn, D. J.; Discekici, E. H.; Read de Alaniz, J.; Gutekunst, W. R.; Hawker, C. J. Established and Emerging Strategies for Polymer Chain-End Modification. J Polym Sci A Polym Chem 2017, 55 (18), 2903-2914. https://doi.org/10.1002/pola.28575.
(72) Tellers, J.; Canossa, S.; Pinalli, R.; Soliman, M.; Vachon, J.; Dalcanale, E. Dynamic Cross-Linking of Polyethylene via Sextuple Hydrogen Bonding Array. Macromolecules 2018, 51 (19), 7680-7691. https://doi.org/10.1021/acs.macromol.8b01715.
(73) Howe, D. H.; McDaniel, R. M.; Magenau, A. J. D. From Click Chemistry to Cross-Coupling: Designer Polymers from One Efficient Reaction. Macromolecules 2017, 50 (20), 8010-8018. https://doi.org/10.1021/acs.macromol.7b02041.
(74) Chae, C. G.; Yu, Y. G.; Seo, H. Bin; Kim, M. J.; Wen, Z.; Lee, J. S. End-Capping Reaction of Living Anionic Poly(Benzyl Methacrylate) with a Pentafluorophenyl Ester for a Norbornenyl-w-End Macromonomer with a Long Flexible Spacer: Advantage in the Well-Controlled Synthesis of Ultrahigh-Molecular-Weight Bottlebrush Polymers. Macromolecules 2019, 52 (13), 4828-4838. https://doi.org/10.1021/acs.macromol.9b00559.
(75) Chen, C.; Wang, C. G.; Guan, W.; Goto, A. A Photo-Selective Chain-End Modification of Polyacrylate-Iodide and Its Application in Patterned Polymer Brush Synthesis. Polym Chem 2019,10 (43), 5913-5919. https://doi.org/10.1039/c9py01431d.
(76) Bailey, S. J.; Discekici, E. H.; Discekici, E. H.; Barbon, S. M.; Nguyen, S. N.; Hawker, C. J.; Hawker, C. J.; Hawker, C. J.; De Alaniz, J. R.; De Alaniz, J. R. Norbornadiene Chain-End Functional Polymers as Stable, Readily Available Precursors to Cyclopentadiene Derivatives. Macromolecules 2020, 53 (12), 4917-4924. https://doi.org/10.1021/acs.macromol.0c00967.
(77) Fuchise, K.; Sato, K.; Igarashi, M. Precise Synthesis of Linear Polysiloxanes End-Functionalized with Alkynylsilyl Groups by Organocatalytic Ring-Opening Polymerization of Cyclotrisiloxanes. Macromolecules 2021, 54 (12), 5765-5773. https://doi.org/10.1021/acs.macromol.1c00495.
(78) Agar, S.; Baysak, E.; Hizal, G.; Tunca, U.; Durmaz, H. An Emerging Post-Polymerization Modification Technique: The Promise of Thiol-Para-Fluoro Click Reaction. Journal of Polymer Science, Part A: Polymer Chemistry. John Wiley and Sons Inc. Jun. 15, 2018, pp 1181-1198. https://doi.org/10.1002/pola.29004.
(79) Köhler, J.; Keul, H.; MOller, M. Post-Polymerization Functionalization of Linear Polyglycidol with Diethyl Vinylphosphonate. Chemical Communications 2011, 47 (28), 8148-8150. https://doi.org/10.1039/c1cc12484f.
(80) Walsh, D. J.; Hyatt, M. G.; Miller, S. A.; Guironnet, D. Recent Trends in Catalytic Polymerizations. ACS Catal 2019, 9 (12), 11153-11188. https://doi.org/10.1021/acscatal.9b03226.
(81) Walsh, D. J.; Wade, M. A.; Rogers, S. A.; Guironnet, D. Challenges of Size-Exclusion Chromatography for the Analysis of Bottlebrush Polymers. Macromolecules 2020, 53 (19), 8610-8620. https://doi.org/10.1021/acs.macromol.0c01357.
(82) Mei, H.; Mah, A. H.; Hu, Z.; Li, Y.; Terlier, T.; Stein, G. E.; Verduzco, R. Rapid Processing of Bottlebrush Coatings through UV-Induced Cross-Linking. ACS Macro Lett 2020, 9 (8), 1135-1142. https://doi.org/10.1021/acsmacrolett.0c00384.
(83) Biedermann, F.; Appel, E. A.; Del Barrio, J.; Gruendling, T.; Barner-Kowollik, C.; Scherman, O. A. Postpolymerization Modification of Hydroxyl-Functionalized Polymers with Isocyanates. Macromolecules 2011, 44 (12), 4828-4835. https://doi.org/10.1021/ma2008018.
(84) PolyChemPrint3 Software. https://github.com/BijalBPatel/PolyChemPrint3 (accessed 2023-07-11).
(85) Edrington, A. C.; Urbas, A. M.; Derege, P.; Chen, C. X.; Swager, T. M.; Hadjichristidis, N.; Xenidou, M.; Fetters, L. J.; Joannopoulos, J. D.; Fink, Y.; Thomas, E. L. Polymer-Based Photonic Crystals**. Advanced Materials 2001, 13 (6). https://doi.org/10.1002/1521-4095(200103)13:6<421::AID-ADMA421>3.0.CO;2-%23.
(86) Chiang, Y. W.; Chou, C. Y.; Wu, C. S.; Lin, E. L.; Yoon, J.; Thomas, E. L. Large-Area Block Copolymer Photonic Gel Films with Solvent-Evaporation-Induced Red- and Blue-Shift Reflective Bands. Macromolecules 2015, 48 (12), 4004-4011. https://doi.org/10.1021/acs.macromol.5b00744.
(87) Helfand, E.; Tagami, Y. Theory of the Interface between Immiscible Polymers. II. J Chem Phys 1972, 56 (7), 3592-3601. https://doi.org/10.1063/1.1677735.
(88) Paradiso, S. P.; Delaney, K. T.; Garcia-Cervera, C. J.; Ceniceros, H. D.; Fredrickson, G. H. Block Copolymer Self Assembly during Rapid Solvent Evaporation: Insights into Cylinder Growth and Stability. ACS Macro Lett 2014, 3 (1), 16-20. https://doi.org/10.1021/mz400572r.
(89) Patterson, A. L.; Danielsen, S. P. O.; Yu, B.; Davidson, E. C.; Fredrickson, G. H.; Segalman, R. A. Sequence Effects on Block Copolymer Self-Assembly through Tuning Chain Conformation and Segregation Strength Utilizing Sequence-Defined Polypeptoids. Macromolecules 2019, 52 (3), 1277-1286. https://doi.org/10.1021/acs.macromol.8b02298.
(90) Ludwik Leibler. Theory of Microphase Separation in Block Copolymers. Macromolecules 1980, 13 (6), 1602-1617.
(91) Matsushita, Y.; Mori, K.; Saguchi, R.; Nakao, Y.; Noda, I.; Nagasawa14, M. Molecular Weight Dependence of Lamellar Domain Spacing of Diblock Copolymers in Bulk. Macromolecules 1990, 23, 4313-4316.
(92) Jiang, Y.; Zhang, W. Y.; Chen, J. Z. Y. Dependence of the Disorder-Lamellar Stability Boundary of a Melt of Asymmetric Wormlike AB Diblock Copolymers on the Chain Rigidity. Phys Rev E Stat Nonlin Soft Matter Phys 2011, 84 (4). https://doi.org/10.1103/PhysRevE.84.041803.
(93) Zhang, J.; Posselt, D.; Smilgies, D. M.; Perlich, J.; Kyriakos, K.; Jaksch, S.; Papadakis, C. M. Lamellar Diblock Copolymer Thin Films during Solvent Vapor Annealing Studied by Gisaxs: Different Behavior of Parallel and Perpendicular Lamellae. Macromolecules 2014, 47 (16), 5711-5718. https://doi.org/10.1021/ma500633b.
(94) Shibayama, M.; Hashimoto, T.; Hasegawa, H.; Kawai, hiromichi. Ordered Structure in Block Polymer Solutions. 3. Concentration of Microdomains in Nonselective Solvents. Macromolecules 1983, 16 (9), 1427-1433.
(95) Mohammadi, E.; Joshi, S. Y.; Deshmukh, S. A. A Review of Computational Studies of Bottlebrush Polymers. Comput Mater Sci 2021, 199. https://doi.org/10.1016/j.commatsci.2021.110720.
(96) Fischer, K.; Schmidt, M. Solvent-Induced Length Variation of Cylindrical Brushes. Macromol Rapid Commun 2001, 22 (10), 787-791. https://doi.org/10.1002/1521-3927(20010701)22:10<787::AID-MARC787>3.0.CO;2-Y.
(97) Rocha, M. S.; Storm, I. M.; Bazoni, R. F.; Ramos, E. B.; Hernandez-Garcia, A.; Cohen Stuart, M. A.; Leermakers, F.; De Vries, R. Force and Scale Dependence of the Elasticity of Self-Assembled DNA Bottle Brushes. Macromolecules 2018, 51 (1), 204-212. https://doi.org/10.1021/acs.macromol.7b01795.
(98) Birshtein, T. M.; Borisov, O. V; Zhulina, Y. B.; Khokhlov, A. R.; Yurasova, T. A. Conformations of Comb-like Macromolecules*. Polymer Science U.S.S.R 1987, 29 (6), 1293-1300.
(99) Nakamura, Y.; Norisuye, T. Backbone Stiffness of Comb-Branched Polymers. Polym J 2001, 33 (11), 874-878. https://doi.org/10.1295/polymj.33.874.
(100) Storm, I. M.; Kornreich, M.; Voets, I. K.; Beck, R.; De Vries, R.; Cohen Stuart, M. A.; Leermakers, F. A. M. Loss of Bottlebrush Stiffness Due to Free Polymers. Soft Matter 2016, 12 (38), 8004-8014. https://doi.org/10.1039/c6sm01227b.
(101) Paturej, J.; Kreer, T. Hierarchical Excluded Volume Screening in Solutions of Bottlebrush Polymers. Soft Matter 2017, 13 (45), 8534-8541. https://doi.org/10.1039/c7sm01968h.
(102) Sunday, D. F.; Chremos, A.; Martin, T. B.; Chang, A. B.; Burns, A. B.; Grubbs, R. H. Concentration Dependence of the Size and Symmetry of a Bottlebrush Polymer in a Good Solvent. Macromolecules 2020, 53 (16), 7132-7140. https://doi.org/10.1021/acs.macromol.0c01181.
(103) Rubinstein, M.; Colby, R. H. Polymer Physics; Oxford University Press: NY, 2003.
(104) Pierre-giles De Gennes. Scaling Concepts in Polymer Physics; Cornell University Press: NY, 1979.
(105) Zhulina, E. B.; Sheiko, S. S.; Borisov, O. V. Solution and Melts of Barbwire Bottlebrushes: Hierarchical Structure and Scale-Dependent Elasticity. Macromolecules 2019, 52 (4), 1671-1684. https://doi.org/10.1021/acs.macromol.8b02358.
(106) Yang, G.; Kim, K.; Wang, W.; Chen, B.; Mattoussi, H.; Hallinan, D. T. Scaling Laws for Polymer Chains Grafted onto Nanoparticles. Macromol Chem Phys 2018, 219 (8). https://doi.org/10.1002/macp.201700417.
(107) Daoud, M.; Cotton, J. P. Star Shaped Polymers: A Model for the Conformation and Its Concentration Dependence. Journal de physique Paris 1982, 43 (3), 531-538. https://doi.org/10.1051/jphys:01982004303053100.
(108) Kang, J. J.; Sachse, C.; Ko, C. H.; Schroer, M. A.; Vela, S. Da; Molodenskiy, D.; Kohlbrecher, J.; Bushuev, N. V.; Gumerov, R. A.; Potemkin, I. I.; Jordan, R.; Papadakis, C. M. Rigid-to-Flexible Transition in a Molecular Brush in a Good Solvent at a Semidilute Concentration. Langmuir 2022, 38 (17), 5226-5236. https://doi.org/10.1021/acs.langmuir.1c02589.
(109) Love, J. A.; Morgan, J. P.; Trnka, T. M.; Grubbs, R. H. A Practical and Highly Active Ruthenium-Based Catalyst That Effects the Cross Metathesis of Acrylonitrile. Angewandte Chemie International Edition 2002, 41 (21), 4035-4037. https://doi.org/10.1002/1521-3773(20021104)41:21<4035::aid-anie4035>3.0.co;2-i.
(110) Radzinski, S. C.; Foster, J. C.; Chapleski, R. C.; Troya, D.; Matson, J. B. Bottlebrush Polymer Synthesis by Ring-Opening Metathesis Polymerization: The Significance of the Anchor Group. J Am Chem Soc 2016, 138 (22), 6998-7004. https://doi.org/10.1021/jacs.5b13317.
(111) Wade, M. A.; Walsh, D.; Lee, J. C. W.; Kelley, E.; Weigandt, K.; Guironnet, D.; Rogers, S. A. Color, Structure, and Rheology of a Diblock Bottlebrush Copolymer Solution. Soft Matter 2020, 16 (21), 4919-4931. https://doi.org/10.1039/d0sm00397b.
(112) Walsh, D. J.; Guironnet, D. Macromolecules with Programmable Shape, Size, and Chemistry. Proc Natl Acad Sci USA 2019, 116 (5), 1538-1542. https://doi.org/10.1073/pnas.1817745116.
(113) PolyChemPrint3 Software. https://github.com/BijalBPatel/PolyChemPrint3 (accessed 2023-07-11).
(114) Patel, B. B.; Walsh, D. J.; Kim, D. H.; Kwok, J.; Lee, B.; Guironnet, D.; Diao, Y. Tunable Structural Color of Bottlebrush Block Copolymers through Direct-Write 3D Printing from Solution. Sci. Adv 2020, 6, 7202-7212. https://doi.org/10.1126/sciadv.aaz7202.
(115) Flory, P. J.; Rehner, J. Statistical Mechanics of Cross-Linked Polymer Networks II. Swelling. J Chem Phys 1943, 11 (11), 521-526. https://doi.org/10.1063/1.1723792.
(116) Tseng, H.-S; Lloyd, D. R.; Ward, T. C. Interaction Parameters of Polystyrene-polyisoprene-toluene Systems at 45° c. from Gel Permeation Chromatography. J Polym Sci B Polym Phys 1987, 25 (2), 325-337. https://doi.org/10.1002/polb.1987.090250206.
(117) Dalsin, S. J.; Rions-Maehren, T. G.; Beam, M. D.; Bates, F. S.; Hillmyer, M. A.; Matsen, M. W. Bottlebrush Block Polymers: Quantitative Theory and Experiments. ACS Nano 2015, 9 (12), 12233-12245. https://doi.org/10.1021/acsnano.5b05473.
(118) Patel, B. B.; Walsh, D. J.; Patel, K.; Kim, D. H.; Kwok, J. J.; Guironnet, D.; Diao, Y. Rapid, Interface-Driven Domain Orientation in Bottlebrush Diblock Copolymer Films during Thermal Annealing. Soft Matter 2022, 18 (8), 1666-1677. https://doi.org/10.1039/dlsm01634b.
(119) Dutta, S.; Pan, T.; Sing, C. E. Bridging Simulation Length Scales of Bottlebrush Polymers Using a Wormlike Cylinder Model. Macromolecules 2019, 52 (13), 4858-4874. https://doi.org/10.1021/acs.macromol.9b00363.
(120) Pan, T.; Patel, B. B.; Walsh, D. J.; Dutta, S.; Guironnet, D.; Diao, Y.; Sing, C. E. Implicit Side-Chain Model and Experimental Characterization of Bottlebrush Block Copolymer Solution Assembly. Macromolecules 2021, 54 (8), 3620-3633. https://doi.org/10.1021/acs.macromol.1c00336.
(121) Paturej, J.; Kreer, T. Hierarchical Excluded Volume Screening in Solutions of Bottlebrush Polymers. Soft Matter 2017, 13 (45), 8534-8541. https://doi.org/10.1039/c7sm01968h.
(122) Kang, J. J.; Sachse, C.; Ko, C. H.; Schroer, M. A.; Vela, S. Da; Molodenskiy, D.; Kohlbrecher, J.; Bushuev, N. V.; Gumerov, R. A.; Potemkin, I. I.; Jordan, R.; Papadakis, C. M. Rigid-to-Flexible Transition in a Molecular Brush in a Good Solvent at a Semidilute Concentration. Langmuir 2022, 38 (17), 5226-5236. https://doi.org/10.1021/acs.langmuir.1c02589.
(123) Daoud, M.; Cotton, J. P. STAR SHAPED POLYMERS: A MODEL FOR THE CONFORMATION AND ITS CONCENTRATION DEPENDENCE. Journal de physique Paris 1982, 43 (3), 531-538. https://doi.org/10.1051/jphys:01982004303053100.
(124) Sunday, D. F.; Chremos, A.; Martin, T. B.; Chang, A. B.; Burns, A. B.; Grubbs, R. H. Concentration Dependence of the Size and Symmetry of a Bottlebrush Polymer in a Good Solvent. Macromolecules 2020, 53 (16), 7132-7140. https://doi.org/10.1021/acs.macromol.0c01181.
(125) Borisov. O. V.; Birshtein. T. M.; Zhulina. Ye. B. The Temperature-Concentration Diagram of State for Solutions of Comb-like Macromolecules. Polymer Science 1986, 29 (7), 1552-1559. https://doi.org/10.1016/0032-3950(87)90416-3.
(126) Plimpton Steve. Fast Parallel Algorithms for Short-Range Molecular Dynamics. J Comput Phys 1995, 117, 1-19.
(127) Mours. M; Winter. H. H. Time-Resolved Rheometry. Rheol Acta 1994, 33, 385-397. https://doi.org/10.1007/BF00366581.
(128) Winter. H. H. The Critical Gel. In Structure and Dynamics of Polymer and Colloidal Systems; Redouane Borsali and Robert Pecora, Ed.; Springer, 2002; Vol. 568, pp 439-470. https://doi.org/10.1007/978-94-010-0442-8_14.
(129) Jeon, S.; Lee, S. Y.; Kim, S. K.; Kim, W.; Park, T.; Bang, J.; Ahn, J.; Woo, H. K.; Chae, J. Y.; Paik, T.; Seong, T. Y.; Oh, S. J. All-Solution Processed Multicolor Patterning Technique of Perovskite Nanocrystal for Color Pixel Array and Flexible Optoelectronic Devices. Adv Opt Mater 2020, 8 (17). https://doi.org/10.1002/adom.202000501.
(130) Son, S.; Jeon, S.; Chae, D.; Lee, S. Y.; Liu, Y.; Lim, H.; Oh, S. J.; Lee, H. Colored Emitters with Silica-Embedded Perovskite Nanocrystals for Efficient Daytime Radiative Cooling. Nano Energy 2021, 79. https://doi.org/10.1016/j.nanoen.2020.105461.

We claim:

1. A crosslinkable ink composition comprising:
a. a material;
b. a solvent;
c. a photo initiator; and
d. a linker molecule
wherein said material is photo crosslinkable and is capable of forming domain spacings of at least about 50 nm under irradiation in light conditions in the presence of a solvent, a photo initiator, and a linker molecule.

2. The composition of claim 1, wherein said a photo initiator is a UV initiator, and wherein said material is UV crosslinkable and is capable of forming domain spacings of at least about 50 nm under UV irradiance in the presence of a solvent, said UV initiator, and said linker molecule.

3. The composition of claim 1, wherein said domain spacings are in the range of about 50 nm to about 500 nm, or about 70 nm to about 250 nm, or about 100 nm to about 250 nm, or about 100 nm to about 400 nm.

4. The composition of claim 1, wherein said material is a bottlebrush block copolymer.

5. The composition of claim 1, wherein said material is a bottlebrush block copolymer that can self-assemble in the presence of a solvent, a UV initiator, and a linker molecule under UV irradiance.

6. The composition of claim 1, wherein said material is a polystyrene-b-polylactic acid bottlebrush block copolymer.

7. The composition of claim 1, wherein said polystyrene-b-polylactic acid bottlebrush block copolymer comprises one or more moieties that exhibit photo crosslinking behavior under UV irradiation conditions.

8. The composition of claim 1, wherein said solvent and said material (wt %) are present in a ratio in the range of about 2:1 to about 20:1.

9. The composition of claim 1, wherein said material is a bottlebrush block copolymer, said solvent is an aprotic solvent, said linker is pentaerythritol tetrakis (3,5-di-tert-butyl-4-hydroxyhydrocinnamate) crosslinker and said photo initiator is 2,2-dimethoxy-2-phenyl acetophenone photo-initiator.

10. A method adding crosslinkable ink composition to a surface, said method comprising contacting said composition of claim 1 with a planar surface or a curved surface in the presence of UV light having irradiance in the range of 0 to 3 μW/cm², or 2 mW/cm² to 200 mW/cm², or 0 to 411 μW/cm², 0 to 450 μW/cm².

11. The method of claim 10, wherein said contacting comprises coating said surface at a printing speed in the range of about 5 mm/min to about 1000 mm/min, or about 5 mm/min to about 500 mm/min, or about 100 mm/min to about 200 mm/min.

12. The method of claim 10, wherein said contacting comprises coating said surface at a temperature in the range of about 0° C. to about 100° C., or about 0° C. to about 90° C., about 60° C.

13. A method of preparing UV crosslinkable bottlebrush block copolymers, said method comprising
a. adding one or more crosslinkable moieties to one or more sidechains of said polymer;
b. crosslinking said polymer via a UV light-initiated thiolene reaction.

14. The method of claim 13, wherein polymer is a polystyrene-b-polylactic acid bottlebrush block copolymer.

15. The method of claim 13, wherein one or more allyl moieties is added to one or more PLA side chains of said polymer.

16. An article, said article comprising one or more layers of said ink of claim 1, wherein said article is a 2D or 2.5D article.
